(19) United States
(12) Patent Application Publication
(10) Pub. No.: US 2020/0242129 A1
(43) Pub. Date: Jul. 30, 2020

(54) SYSTEM AND METHOD TO IMPROVE DATA SYNCHRONIZATION AND INTEGRATION OF HETEROGENEOUS DATABASES DISTRIBUTED ACROSS ENTERPRISE AND CLOUD USING BI-DIRECTIONAL TRANSACTIONAL BUS OF ASYNCHRONOUS CHANGE DATA SYSTEM

(71) Applicant: salesforce.com, inc., San Francisco, CA (US)

(72) Inventors: Chavdar Botev, Redwood City, CA (US); Rajeev Bharadhwaj, Saratoga, CA (US); Burton Hipp, San Jose, CA (US)

(21) Appl. No.: 16/844,247

(22) Filed: Apr. 9, 2020

Related U.S. Application Data
(63) Continuation of application No. 16/199,269, filed on Nov. 26, 2018.
(60) Provisional application No. 62/593,874, filed on Dec. 1, 2017.

(51) Int. Cl. G06F 16/27; G06F 16/23; G06F 16/25

(52) U.S. Cl. CPC G06F 16/273; G06F 16/289; G06F 16/256; G06F 16/2379

(57) ABSTRACT

Object materialization and replication policies are described. A system identifies data objects in tables in a source database by applying a data object replication policy to a superset of the data objects in the tables in the source database. The system inputs the data objects from the tables in the source database, and outputs the data objects to tables in a target database. A materializer constructs an application object based on applying an application object materialization policy associated with the tables in the source database to the data objects in the tables in the target database. The system receives an application object request from an application associated with the target database, and outputs the application object.

### CLAIM OF PRIORITY

This non-provisional patent application is a conversion application of and claims priority to the U.S. Provisional Patent Application No. 62/593,874 titled SYSTEM AND METHOD TO IMPROVE DATA SYNCHRONIZATION AND INTEGRATION OF DATA ACROSS ENTERPRISE AND CLOUD USING ASYNCHRONOUS CHANGE DATA SYSTEM filed on Dec. 1, 2017.

### FIELD OF TECHNOLOGY

The present disclosure relates generally to internet architecture, and more particularly, to a method and/or a system to improve data synchronization and integration of heterogeneous databases distributed across enterprise and/or cloud using bi-directional transactional bus of asynchronous change data system.

### BACKGROUND

In internet architecture, a database system may require a platform for reliable data synchronization and integration across a wide range of distributed client web browsers inside a modern data-driven enterprise. Apache® may be the most used web server available that receives requests and sends out responses across internet to the requesting party of the modern data-driven enterprise. The modern data-driven enterprise may need to manage data from new applications, new business opportunities and internet-of-things, etc.

The modem data-driven enterprise may require support for high level of availability and reliability of database system to provide solutions for a number of mission critical use cases. A bus, like Kafka®, which captures changes at a table level, may be used for building real-time data pipelines and streaming applications that are horizontally scalable to run the production in the modern data-driven enterprise. Kafka® based streaming may be inconsistent for transactional data. The table-per-topic design of Kafka® may not honor transactions. Kafka® may be exactly-once semantics only within a topic.

The analytics run during Kafka® based streaming may be incorrect or incomplete. Every message may need to be de-normalized which may result in massive duplication of data. Kafka®'s log as the source of truth may be inefficient for view materialization use cases wherein change across various timelines have to be aggregated. Further, Kafka® based stream may create huge memory hog and there may be no easy way to restart processing on a failed processor.

The ever changing environment of modern data-driven enterprise may further need scalability, performance, consistency and reliable data synchronization to manage its wide range of complex problems in a geographically distributed system. The traditional system may lack the ability to scale its data stream and desired availability to meet the needs of the modern data-driven enterprise.

### SUMMARY

Disclosed are a method and/or a system to improve data synchronization and integration of heterogeneous databases distributed across enterprise and/or cloud using bi-directional transactional bus of asynchronous change data system.

In one aspect, a method of snapshot materialization and application consistency includes running a change capture system to capture all changes by first collecting a change capture data before an initial load is started. The method includes running an initial bulk load of all data in a source system while change capture is progressing and applying all change transactions to a particular transaction id when the initial load is completed. The method further includes removing a reappearance of a record using keys that handle de-duplication of entries and deeming a snapshot of a target system as consistent if the state of the whole system is identical to a source database at a certain transaction id. The change capture data concerns modifications including an insert, a delete, and/or an update in the source system in an order of its occurrence. A logical clock value determines the order in which the changes have occurred. The changes are a transactional and/or a non-transactional. The transaction boundaries are preserved as part of the change capture data.

A historic consistent snapshot with past data is preserved for a historic data analysis, an auditing, and/or a backup. The key is a primary key and/or a composite key. The source system is a OLTP RDBMS, a NoSQL database, an API system, and/or a message bus. The source system runs on a bare metal hardware, a VM, a private, and/or a public cloud.

The target system is a OLTP RDBMS, a OLAP Data Warehouse, a Data Lake. and/or a NoSQL database. The target system runs on a bare metal hardware, a VM, a private, and/or a public cloud. The target system utilizes a row storage, a columnar storage, an in-place update storage, and/or an append-only storage. The target system supports a transactional update. The target system is an identical and/or a different type than the source system.

A hierarchical declarative replication policy is applied to the change capture data and/or initial load data to filter, mask and/or modify the source data to be used among others for synchronizing a subset of the source data, remove, and/or mask sensitive and/or personal data. The hierarchical declarative replication policy is applied to the change capture data and/or initial load data to transform the source data format and/or types to match the target system. The target database is a RDBMS in-place update and/or HDFS append-only database. Further, a replicated table in the target database is presented as an object materialized view, database view, and/or a database materialized view.

The method of the target system may not support the transactional update.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limited in the figures of the accompanying drawing, in which like references indicate similar elements and in which:

FIG. 1 is a synchronized data integration view illustrating a real-time integration and synchronization between heterogeneous databases of a data-driven enterprise using bi-directional transaction bus of asynchronous change data system (ACDS), according to one embodiment.

FIG. 2 is a distributed geographical region view illustrating the distributed publisher/subscriber transaction bus of the asynchronous change data system (ACDS) as a platform for real-time integration and replication of the transactional data, according to one embodiment.

FIG. 3 is a system architecture view of the distributed publisher/subscriber transaction bus of the asynchronous change data system (ACDS) illustrating a criteria-based cloning of the source database, according to one embodiment.

FIG. 4 is a zoom-in view of the transactional replication bus illustrating the anatomy of data flow and policies of distributed publisher/subscriber transaction bus of the asynchronous change data system (ACDS), according to one embodiment.

FIG. 5 illustrates a comprehensive set of use cases of transactional replication bus of the asynchronous change data system (ACDS), according to one embodiment.

FIG. 6 illustrates the problem statement view of continuous data integration with asynchronous change data system (ACDS) object materialization, according to one embodiment.

FIG. 7 illustrates the object normalization and object materialization view of an application object of the asynchronous change data system (ACDS), according to one embodiment.

FIG. 8 is a conceptual view illustrating an example embodiment showing continuous data integration and object materialization of asynchronous change data system (ACDS) for a PetStore use case, according to one embodiment.

FIG. 9 illustrates a demo deployment setup view of continuous data integration with asynchronous change data system (ACDS) object materialization using the transactional replication bus, according to one embodiment.

FIG. 10 a conceptual view illustrating different flavors of object materialization of the transactional replication bus of ACDS and its use cases, according to one embodiment.

FIG. 11 is a continuous data integration view illustrating a real-time integration in the transactional replication bus of ACDS, according to one embodiment.

FIG. 12A illustrates a materialization policy view described using the Human Optimized Configuration Object Notation (HOCON) syntax, according to one embodiment.

FIG. 12B is a continuation of FIG. 12A and illustrates the materialization policy view of FIG. 12A, according to one embodiment.

FIG. 12C is a a child aggregation view illustrating a continuation of FIG. 12A and FIG. 12B describing the child aggregation of object materialization configurations, according to one embodiment.

FIG. 13A-13B illustrates the internal implementation view of ACDS object materialization architecture of the consumer application, according to one embodiment.

FIG. 13C is an applier stage view illustrating the applier stage of ACDS object materialization architecture (e.g., using object materialization) of the consumer application, according to one embodiment.

FIG. 13D is a change detector view illustrating the change detector stage of ACDS object materialization architecture of the consumer application, according to one embodiment.

FIG. 13E is an object materializer view illustrating the object materializer stage of ACDS object materialization architecture of the consumer application, according to one embodiment.

FIG. 13F is an object cache view illustrating the object cache stage of ACDS object materialization architecture of the consumer application, according to one embodiment.

FIG. 13G is an object fetcher view illustrating the object fetcher stage of ACDS object materialization architecture of the consumer application, according to one embodiment.

FIG. 14 is a parallelization view illustrating the parallelization through multi-version concurrency control (MVCC), according to one embodiment.

FIG. 15 is a continuous data integration view describing the summary of ACDS continuous data integration of the transactional replication bus of ACDS, according to one embodiment.

FIG. 16 is a genesis view illustrating the genesis of asynchronous change data system (ACDS), according to one embodiment.

FIG. 17 is an architecture view illustrating the architecture of data distribution network (DDN) of asynchronous change data system (ACDS), according to one embodiment.

FIG. 18A is a layering view illustrating the layering of data distribution network (DDN) of the transactional replication bus, according to one embodiment.

FIG. 18B is a data distribution network view describing the summary of the data distribution network (DDN) of the transactional replication bus, according to one embodiment.

FIG. 18C is an asynchronous change data system view describing the summary of the asynchronous change data system (ACDS) of the replication bus, according to one embodiment.

FIG. 19A is an ACDS databus view illustrating the ACDS Databus which may be a primary Databus extended with additional database integration with policies configured based on a model specifying what may get processed on the bus, according to one embodiment.

FIG. 19B is a source fetcher API view illustrating the source fetcher API which may leverage the ACDS Databus APL according to one embodiment.

FIG. 19C is a data stream API view illustrating the data stream API of the ACDS, according to one embodiment.

FIG. 19D is an ACDS events view illustrating the ACDS events of the data stream API, according to one embodiment.

FIG. 19E is a consumer API view illustrating the consumer API of Databus, according to one embodiment.

FIG. 20A is a core component view illustrating the core component of the Databus of the replication bus, according to one embodiment.

FIG. 20B is an exploded view of relay illustrating the exploded view of relay of the asynchronous change data system (ACDS) architecture, according to one embodiment.

FIG. 20C is an internal function view describing the internal function of the relay of the asynchronous change data system (ACDS) architecture, according to one embodiment.

FIG. 20D is an exploded view of catch-up illustrating the exploded view of catch-up of the asynchronous change data system (ACDS) architecture, according to one embodiment.

FIG. 20E is a cloning function view describing the cloning function of the catch-up server of the asynchronous change data system (ACDS), according to one embodiment.

FIG. 21 is a timeline view illustrating the timeline view of ACDS component. The SCN timeline may be a commit timeline, according to one embodiment.

FIG. 22 illustrates the cloning based on criteria. The cloning based on criteria may be an ACDS extension, according to one embodiment.

FIG. 23 is a criteria based clone architecture view illustrating the criteria based clone architecture of the asynchronous change data system (ACDS), according to one embodiment.

FIG. 24 is a consumer catch-up process view describing the consumer catch-up process of the consumer application, according to one embodiment.

FIG. 25 is an overview of guaranteed delivery property describing the overview of guaranteed delivery property of the transactional replication bus, according to one embodiment.

FIG. 26 is a consumer state management view describing the consumer state management of the asynchronous change data system (ACDS), according to one embodiment.

FIG. 27 is a scalability property view describing the overview of scalability property of the transactional replication bus, according to one embodiment.

FIG. 28 is a flexible topology architecture view illustrating the flexibility of the ACDS architecture, according to one embodiment.

FIG. 29 is an optimize scalability view illustrating the policy processing with predicate pushdown, according to one embodiment.

FIG. 30 is a data stream partitioning view illustrating how the partitioning of data stream is done, according to one embodiment.

FIG. 31 is a consumption scaling options view describing the consumption scaling options of ACDS, according to one embodiment.

FIG. 32 is an overview of the policies describing the overview of the policies of the asynchronous change data system (ACDS), according to one embodiment.

FIG. 33 is a policy create view describing the steps involved to create policies for every use case, according to one embodiment.

FIG. 34 is a replication policies view describing the replication policies of the asynchronous change data system (ACDS), according to one embodiment.

FIG. 35A is a policy hierarchy view describing the policy hierarchy of the asynchronous change data system (ACDS), according to one embodiment.

FIG. 35B-35D is a conceptual view describing the examples of policies of the asynchronous change data system (ACDS), according to one embodiment.

FIG. 36A is a conflict resolution algorithm view describing the last-writer-wins (LWW) conflict resolution algorithm, according to one embodiment.

FIG. 36B is a table view describing the maintenance of metadata of the last writers wins, according to one embodiment.

FIG. 37 is a chaining function view illustrating the example embodiment of chaining function of the asynchronous change data system (ACDS).

FIG. 38 is a data synchronization path view illustrating the ACDS real-time data synchronization path, according to one embodiment.

FIG. 39 is a block diagram illustrating the performance methodology to measure the performance of ACDS, according to one embodiment.

FIG. 40 is a block diagram illustrating the measuring of stage 1 performance across a number of different configurations, according to one embodiment.

FIG. 41 is a block diagram illustrating the measuring of stage 2 performance, according to one embodiment.

FIG. 42 is a block diagram illustrating the End-to-End MySQL binlog, according to one embodiment.

FIG. 43 is a setup view illustrating the End-to-end setup, according to one embodiment.

FIG. 44 is a block diagram illustrating Oracle GG to Hbasc, according to one embodiment.

FIG. 45 is an automatic consumer load-balancing view illustrating the automatic consumer load-balancing, according to one embodiment.

FIG. 46 is a consumer micro-batching view illustrating the consumer micro-batching, according to one embodiment.

FIG. 47 is a high-level ACDS architecture view illustrating the high-level ACDS Architecture, according to one embodiment.

FIG. 48 is a cloud deployment view illustrating a typical cloud deployment model, according to one embodiment.

FIG. 49 is a timeline view illustrating the timeline consistency of ACDS, according to one embodiment.

FIG. 50 is a cache hierarchy view illustrating the serving in ACDS as cache hierarchy, according to one embodiment.

FIG. 51 is a typical clustering view illustrating the relay clustering types, according to one embodiment.

FIG. 52 is a relay chaining view illustrating the relay chaining, according to one embodiment.

FIG. 53 is a relay tiering view illustrating relay tiering, according to one embodiment.

FIG. 54 is a cross AZ relay chaining view illustrating the Cross AZ Relay Chaining, according to one embodiment.

FIG. 55 is a failure scenarios view illustrating the sample Failure Scenarios, according to one embodiment.

FIG. 56 snapshot materialization view illustrating the hive+snapshot materialization, according to one embodiment.

FIG. 57 is an application consistency view illustrating the application consistency guaranteed by a source clock, according to one embodiment.

FIG. 58 illustrates a flow diagram illustrating snapshot materialization and application consistency, according to one embodiment.

Other features of the present embodiments will be apparent from the accompanying drawings and from the detailed description that follows, according to one embodiment.

### DETAILED DESCRIPTION

Disclosed is a method and/or a system to improve data synchronization and integration of heterogeneous databases distributed across enterprise and/or cloud using a bi-directional transactional bus of asynchronous change data system.

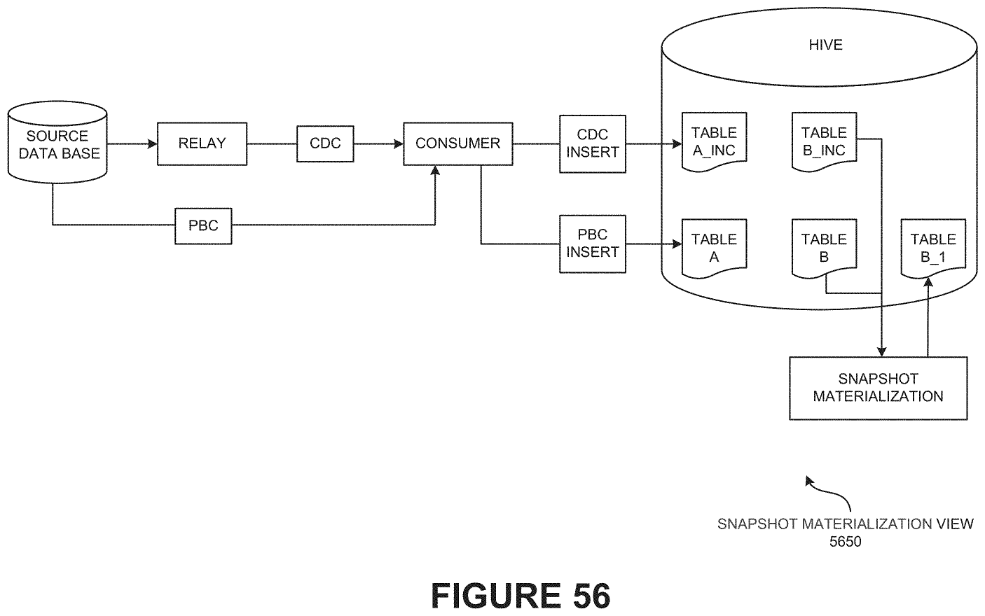

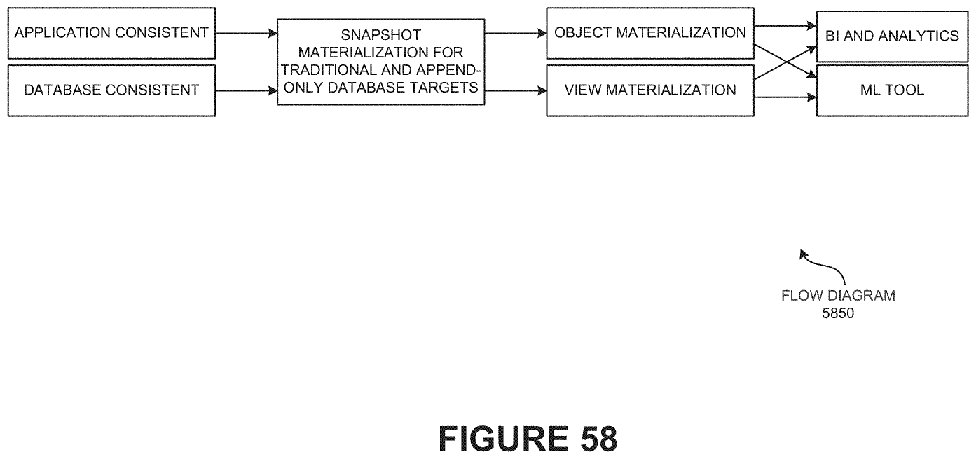

In one embodiment, a method of snapshot materialization and application consistency (e.g., as shown in FIGS. 56 and 58) includes running a change capture system to capture all changes by first collecting a change capture data before an initial load is started. The method includes running an initial bulk load of all data in a source system while change capture is progressing and applying all change transactions to a particular transaction id when the initial load is completed. The method further includes removing a reappearance of a record using keys that handle de-duplication of entries and deeming a snapshot of a target system as consistent if the state of the whole system is identical to a source database at a certain transaction id. The change capture data concerns modifications including an insert, a delete, and/or an update in the source system in an order of its occurrence. A logical clock value determines the order in which the changes have occurred. The changes are a transactional and/or a non-transactional. The transaction boundaries are preserved as part of the change capture data.

A historic consistent snapshot with past data is preserved for a historic data analysis, an auditing, and/or a backup. The key is a primary key and/or a composite key. The source system is a OLTP RDBMS, a NoSQL database, an API system, and/or a message bus. The source system runs on a bare metal hardware, a VM, a private, and/or a public cloud.

The target system is a OLTP RDBMS, a OLAP Data Warehouse, a Data Lake. and/or a NoSQL database. The target system runs on a bare metal hardware, a VM, a private, and/or a public cloud. The target system utilizes a row storage, a columnar storage, an in-place update storage, and/or an append-only storage. The target system supports a transactional update. The target system is an identical and/or a different type than the source system.

A hierarchical declarative replication policy is applied to the change capture data and/or initial load data to filter, mask and/or modify the source data to be used among others for synchronizing a subset of the source data, remove, and/or mask sensitive and/or personal data. The hierarchical declarative replication policy is applied to the change capture data and/or initial load data to transform the source data format and/or types to match the target system. The target database is a RDBMS in-place update and/or HDFS append-only database. Further, a replicated table in the target database is presented as an object materialized view, database view, and/or a database materialized view.

The method of the target system may not support the transactional update.

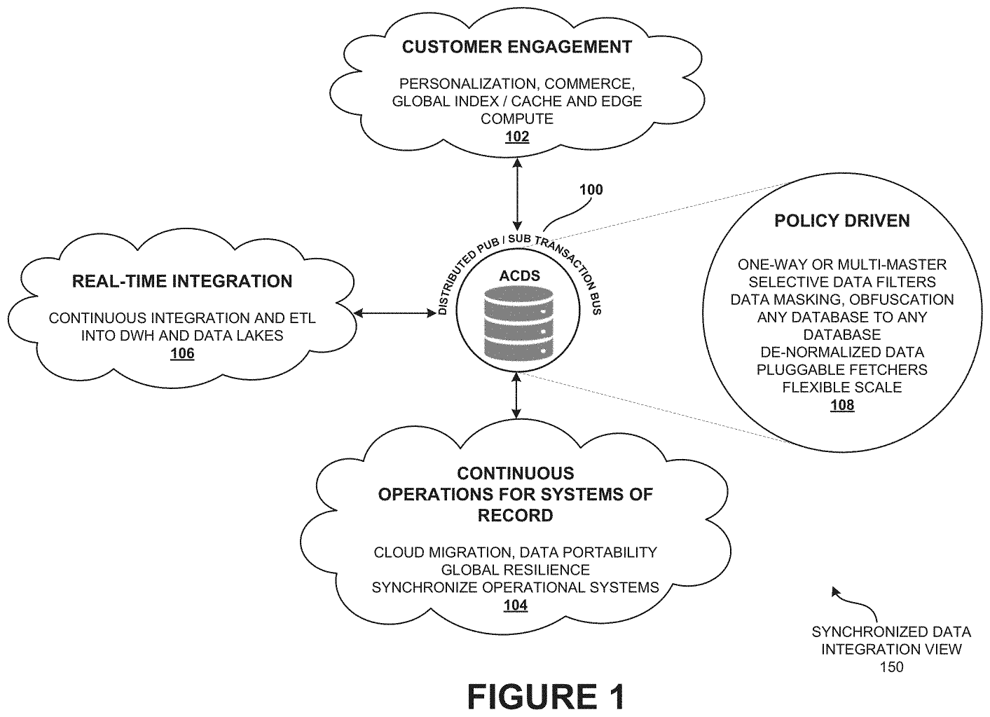

FIG. 1 is a synchronized data integration view 150 illustrating a real-time integration and synchronization between heterogeneous databases of a data-driven enterprise using bi-directional transaction bus of asynchronous change data system (ACDS), according to one embodiment.

A modern data-driven enterprise may have cloud-enabled transaction bus to manage its data flow. The modern data-driven enterprise may have a source database which may typically be updated by an existing application. The modern data-driven enterprise may need to integrate the available data in the source database into other databases distributed across the network to be used from other part applications of the network. The modern data-driven enterprise may need to integrate and synchronize in consistence with master database (e.g., distributed publisher/subscriber transaction bus 100) and the replicated database. Further, the enterprise may need to maintain the transactional consistency of its transaction bus real-time, according to one embodiment.

A distributed publisher/subscriber transaction bus 100 of the asynchronous change data system (ACDS) may be a transport of changed data across the network by transferring and capturing the sequence of changes that have happened on the source data. The distributed publisher/subscriber transaction bus 100 of the asynchronous change data system (ACDS) may be connected to a number of heterogeneous databases (e.g., customer engagement 102) spanning across a distributed geographical region (e.g., distributed geographical region 250). The distributed publisher/subscriber transaction bus 100 of the asynchronous change data system may allow real-time integration 106 of data stream when accessed by a user application (e.g., customer engagement 102). The data transmission between the number of heterogeneous databases (e.g., customer engagement 102) of the asynchronous change data system (ACDS) may be policy driven 108 and configured by the asynchronous change data system (ACDS), according to one embodiment.

The distributed publisher/subscriber transaction bus 100 may allow scalability of the source data. The user application of the asynchronous change data system (ACDS) may want to be able to access not only the current state but also like to see how the data has changed over time. The asynchronous change data system (ACDS) may allow all the user applications of the system to find the current state and changed data on the source database (e.g., using distributed published/subscriber transaction bus 100). The distributed publisher/subscriber transaction bus 100 of the asynchronous change data system (ACDS) may actually have an abstraction which allows those user applications to access the changed data in a generically scalable way, according to one embodiment.

The customer engagement 102 of the asynchronous change data system (ACDS) may allow a user application to communicate with the distributed publisher/subscriber transaction bus 100 of the asynchronous change data system (ACDS). The customer engagement 102 of the asynchronous change data system (ACDS) may include personalization of data, commerce, global index/cache and edge compute of the user application accessing the asynchronous change data system (ACDS). The policy driven 108 configurations may include one-way data transmission, multi-master selective data filter, data masking, obfuscation of any database to any database, de-normalized data, pluggable fetchers, and flexible scaling of the data by distributed publisher/subscriber transaction bus 100 of the asynchronous change data system (ACDS).

The real-time integration 106 may allow continuous integration and extracting, transforming and loading of data and pulling data out of the distributed published/subscriber transaction bus 100 and placing it into a data warehouse. The real-time integration 106 of the distributed publisher/subscriber transaction bus 100 may have data lakes to hold a vast amount of raw data in its native format.

The continuous operations for systems of record 104 of the distributed publisher/subscriber transaction bus 100 of the asynchronous change data system (ACDS) may allow cloud migration, data portability, global resilience, and synchronize operational systems across the distributed geographical region.

An organization may have multiple collections of data inside the organization and/or network. The distributed publisher/subscriber transaction bus 100 of the asynchronous change data system (ACDS) may tie the data inside the organization and/or network for a variety of use cases. The main use cases of asynchronous change data system (ACDS) may include customer engagement 102, continuous operations for systems of record 104, and real-time data integration 106, according to one embodiment.

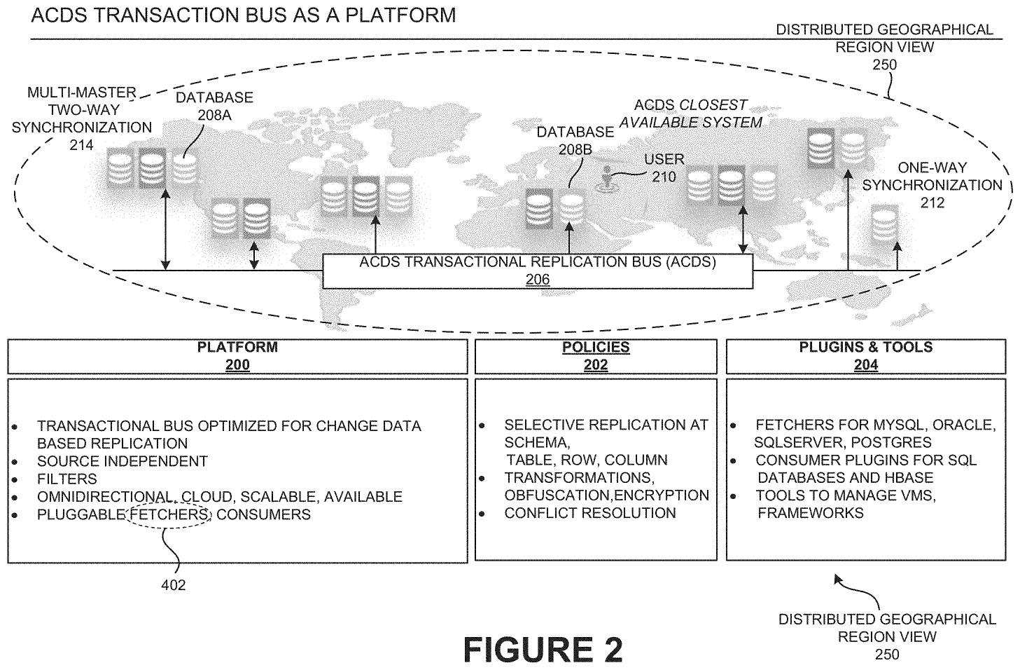

FIG. 2 is a distributed geographical region view 250 illustrating the distributed publisher/subscriber transaction bus 100 of the asynchronous change data system (ACDS) as a platform 200 for real-time integration and replication of the transactional data, according to one embodiment.

The distributed published/subscriber transaction bus 100 may be a platform 200 to connect different databases which could be a source database 300 and/or a destination database 302 in the distributed geographical region.

The policies 202 may be a set of instruction to communicate the data from distributed publisher/subscriber transaction bus 100 to user application. The policies 202 may include transformation, obfuscation, and/or encryption of the data. The policies 202 of the distributed publisher/subscriber transaction bus 100 may further include selective replication at schema, table, row, column and/or conflict resolution. The policies 202 may include master-detail links and re-generation of the master detail tree when either master of detail changes for supporting object materialization or denormalization (502).

The plugins and tools 204 of the distributed publisher/subscriber transaction bus 100 may be a software add-on that is installed onto the distributed publisher/subscriber transaction bus 100, enabling it to perform additional features. For example, the plugins and tools 204 of the distributed publisher/subscriber transaction bus 100 may allow users to install plug-ins into the browser to give browser features not found in the default installation. The plugins and tools 204 may include fetchers 402 for MySQL. Oracle. SQLServer, PostgreSQL, consumer plugins for SQL databases and Hbase, and other tools to manage VMs and frameworks, according to one embodiment.

The transactional replication bus 206 of the asynchronous change data system (ACDS) may be the subsequent data changes and schema modifications made at the distributed publisher/subscriber transaction bus 100 delivered to the user 210 as they occur (in near real time), according to one embodiment.

The database 208 may be a collection of information organized and distributed around the world to provide efficient retrieval of data through internet. The transactional replication bus 206 of the asynchronous change data system (ACDS) may connect these different database sources. The source database 300 may be any kind of database, such as an SQL database. The destination database 302 may be any kind of database and/or may be a file system, e.g., Hadoop HDFS. The source data may be coming from a different system with a different consistency and/or properties and the destination database 302 may have different consistency and/or properties. The transactional replication bus 206 of the asynchronous change data system (ACDS) may try to preserve those properties to the best kind of consistency, according to one embodiment.

The source database 300 and the destination database 302 may be different database types. It may be a relational database. It may not have a sequel and the destination database 302 may be different as well and the transactional replication bus 206 of the asynchronous change data system (ACDS) may try to keep the consistency. The distributed publisher/subscriber transaction bus 100 of the asynchronous change data system (ACDS) may integrate the two source databases 300 and the destination databases 302 so that they can communicate with each other, update each other and synchronize their consistency using a Bi-directional transaction bus (e.g., transaction replication bus 206), according to one embodiment.

The one-way synchronization 212 may allow change data (e.g. database records and/or documents) and metadata (e.g., database schema and/or table structure) to be copied only from the transactional replication bus 206 (e.g., source, a primary location) to the database 208 (e.g., target, a secondary location) in one direction, but no files may be copied back to the transactional replication bus 206 (e.g., source, primary location). Replication and backup (e.g., mirroring) may be one-way synchronization method and vice versa, according to one embodiment.

In two-way synchronization 214, may copy change data and metadata in both directions, keeping the two locations, transactional replication bus 206 and database 208 (e.g., source, primary location and target, secondary location) in synchronization with each other. Synchronization and consolidation may be two-way synchronization 214 methods and vice versa, according to one embodiment.

An enterprise having global presence may have thousands of databases distributed across different geographical spaces. There may be problem managing these databases to synchronize the data across different copies of those databases in many locations. The asynchronous change data system (ACDS) may have a single synchronization bus using transactional replication bus 206 of the system where the source master database, e.g., transactional replication bus 206, publishes those changes to that bus (e.g., distributed publisher/subscriber transaction bus 100) and then on the destination databases (e.g., database 208). The system may allow creating subscribers that can keep those target databases (e.g., database 208) updated constantly but the source database (e.g., distributed publisher/subscriber transaction bus 100) may not know where the data is going to.

The fetcher 402 may be an abstraction inside the transactional replication bus 206. The fetcher 402 may be a change-data-capture system that gets changes by mining redo logs, replication logs or by querying for changes based on timestamp columns in tables. It may fetch qualified data and/or records from the database tables (e.g., in the database 208). The fetcher 402 may return the results to the corresponding table rows according to default and/or customized filtering criteria in the platform 200. The transactional replication bus 206 may be source independent, that is, the format in which the data gets transferred over the transactional replication bus 206, may not depend on where the data is coming from (e.g., geographical location), and the fetcher 402 may be the only component which knows how to communicate to the specific type of database and then convert into source independent formats.

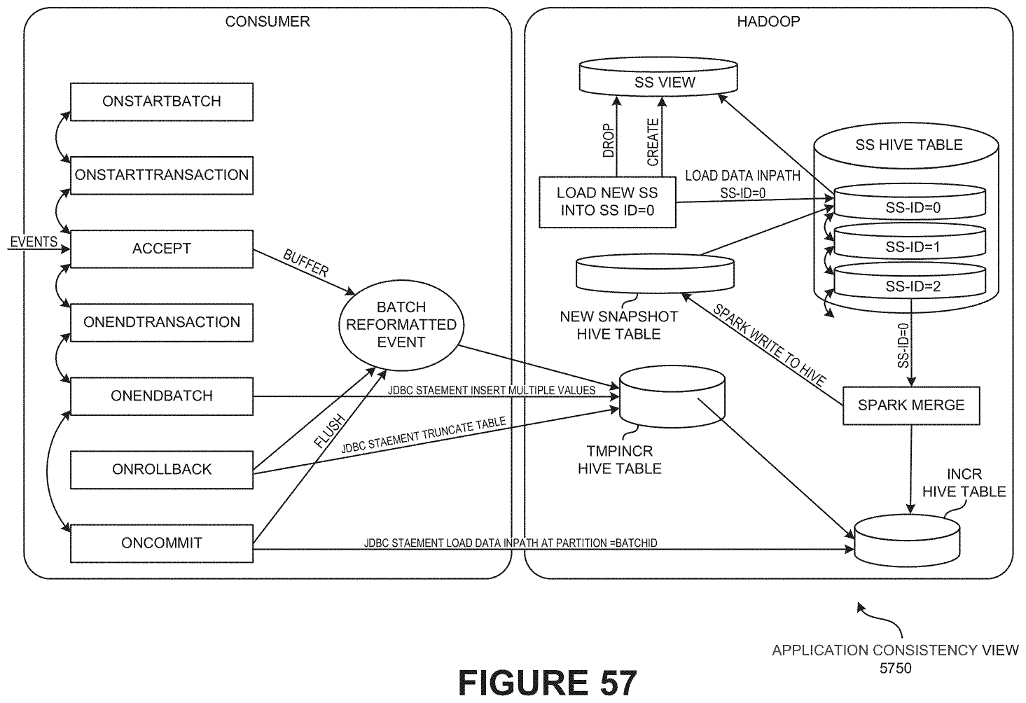

A pluggable consumer application 308 may be a client library 308A, which connects to the data source and is provided by the replication bus (e.g., transactional replication bus 206), and a consumer plugin 308B, which is a kind of data destination. This implies that one may create its own consumer application 308 that has to implement certain interfaces to integrate with the bus. The pluggable consumer may subscribe to the data going through the bus and may process the data. A typical example of the replication consumer may be one which just writes the data to, say, another relational database and/or may have a HADOOP consumer which gets the data from the bus writes to HDFS files or HBase/Hive tables (e.g., as shown in FIG. 57).

The platform may define how a pluggable fetcher may be created, how the APIs may be linked, how it may be integrated, but the platform itself may not give a specific fetcher.

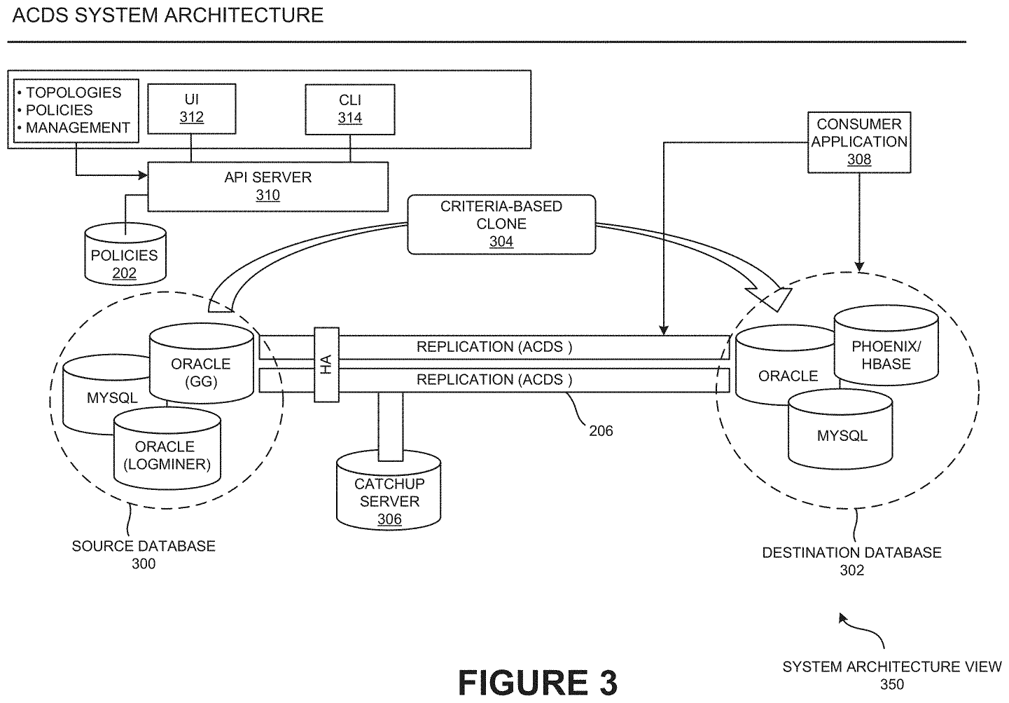

FIG. 3 is a system architecture view 350 of the distributed publisher/subscriber transaction bus 100 of the asynchronous change data system (ACDS) illustrating criteria-based cloning 304 of the source database 300, according to one embodiment.

A source database 300 may be the database that stores initial snapshot of data, tracks and replicates the ongoing changes in the data. The destination database 302 may be the database that communicates with the source database 300 through the distributed publisher/subscriber transaction bus 100 and writes to the source database 300 based on the replication policy (e.g., policies 202) of the distributed publisher/subscriber transaction bus 100, according to one embodiment.

A consumer may be an application that reaches the distributed publisher/subscriber transaction bus 100 and writes to the destination database 302 and/or source database 300. To create a completely new copy of the database, one may get initial snapshot and/or data at the source database 300 at one point of time, move the data to the destination database 302 and from that point keep tracking what has changed after the initial snapshot.

The criteria-based clone 304 may be a service of the distributed publisher/subscriber transaction bus 100 that helps to do the initial move of the source database with massively parallel scale. The criteria-based clone 304 may help to move the initial data which is to be integrated with the application policy 202. The criteria-based clone 304 may allow to only move the data which satisfies the replication policies 202 of the transactional replication bus 206. The criteria-based clone 304 allows doing transformations in the files. Further, the replication policies of the transactional replication bus 206 may allow protecting some private data on the destination database 302. Selective data of the source database 300 may be cached and encrypted in a catch-up server 306 of the transactional replication bus 206, according to one embodiment.

The catch-up server 306 may be a part of transactional replication bus 206 which provides real-time stream of data for what has changed to the database. The consumer application 308 of the destination database 302 may not be able to keep up with that stream sometimes. The catch-up server 306 enables the consumer application 308 to keep up with the real-time stream of data. The retention time of the data in the catch-up server 306 is policy driven, according to one embodiment.

For example, the consumer application 308 may be stopped for some period of time, it might be unavailable, or it may have crashed. When the consumer application 308 comes back, one of the things that transactional replication bus 206 provides is reliable transformation. This way, the consumer application 308 may not miss any data that happens while it was not available and the catch-up server 306 may be a long term storage for this changed data. The consumer application 308 may automatically go to the catch-up server 306 to catch up to read the data that it has missed and then will automatically gain on the missed data, according to one embodiment.

The consumer application 308 may be a relational database replication consumer which basically writes the data to a relational database. The Hadoop consumer which writes the data to Hadoop may be a consumer application 308, according to one embodiment.

An API server 310 may be an orchestration layer. The API server 310 may keep track of orchestration layers. The API server 310 may keep track of which are the places that need to replicate the data, what are the replication policies (e.g., policies 202), what data needs to be replicated, and what are the configurations of different parts of the system. Further, the API server 310 may keep track of the access control of who can access which data in the network. The API server 310 may be a part of orchestration layer.

The UI 312 may be the user interface through which the users (e.g., consumer application 308) interact with the API server 310. The UI 312 may be a web based user interface. The command line interface CLI 314 may include what is being managed by the API server 310. The command line interface CLI 314 may include topologies, policies and management of the asynchronous change data system (ACDS). Topology may be an overview showing from where the data flows, what are the sources of data, what are the destinations, etc. The policies 202 may specify what kind of data flow is there in the transactional replication bus 206. Management may include adding users and new instances, etc.

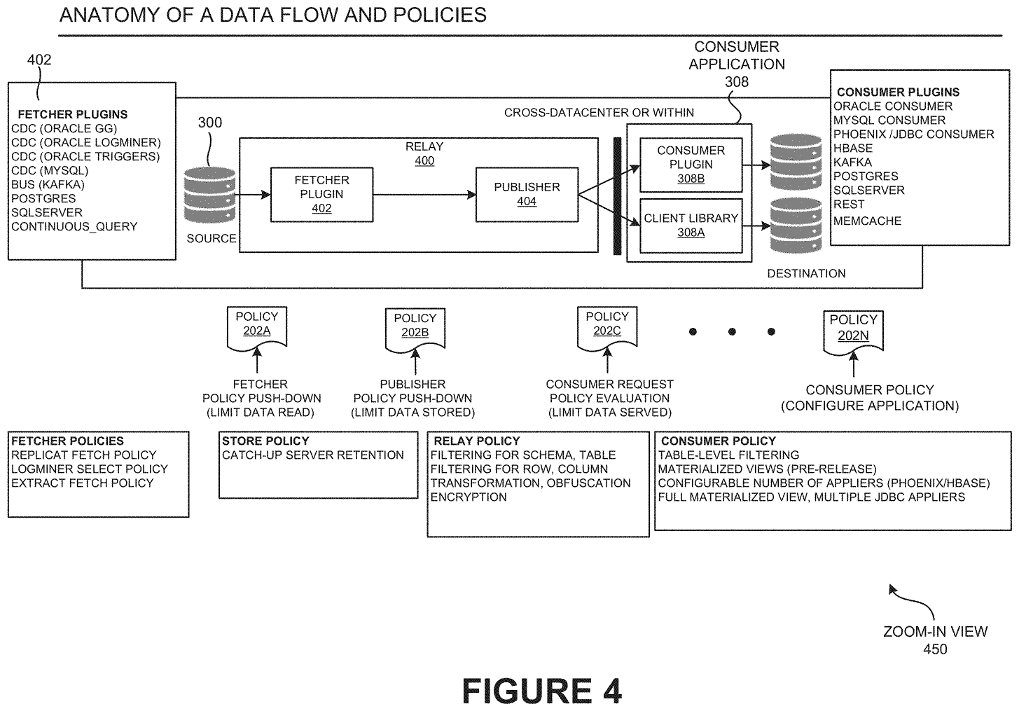

FIG. 4 is a zoom-in view 450 of the transactional replication bus 206 illustrating the anatomy of data flow and policies 202 of distributed publisher/subscriber transaction bus 100 of the asynchronous change data system (ACDS). The transactional replication bus 206 may include a relay 400. The relay 400 may be an intermediary between the source database 300 and the consumer applications 308. The relay 400 may connect to a source database and may be extended with the fetcher plugin (e.g., fetcher 402). The fetcher 402 may be a component which knows how to read the change from a specific database and convert it to a source-independent format, and when it's done, the data gets published in the relay 400. Further, the consumer application 308 may subscribe to and notify the relay 400 that it requires the change data for certain tables, for example the “ACCOUNTS” and “EMAIL_STATUS” tables from the “USERS” schema in the source database 300. The relay 400 may update, the consumer application 308 based on the consumer subscription (e.g., using policies 202), according to one embodiment.

The consumer application 308 may have two parts, a client library 308A and a consumer plugin 308B. The client library 308A may know how to access the bus and read the data from the bus and transmit the changed data to the consumer plugin 308B which does the specific processing. The client library 308A may only read the data. The consumer plugin 308B may be enabled for specific processing that needs to be done. The consumer plugin 308B may be the one that implements the specific logic for interacting with the relational database, according to one embodiment.

The policies 202 may control data flows in the transactional replication bus 206. The consumer application 308B may define the policies 202 and mark for places in the transactional replication bus 206 and may achieve different objectives depending upon where the policies 206 are applied, according to one embodiment.

The consumer application 308 may change a particular clause of the policies 206 to the source which may be more efficient to evaluate. Because, for example, if one consumer application 308 has a policy which says it will replicate only the data for the user accounts table, then the policy may be applied at the source. Since the policy is applied at the source, none of the subsequent user (e.g. consumer application 308) may know which user (e.g. consumer application 308) has defined it. This is where the filtering (e.g., using policies 202) may be done to know the origin from the database. None of the other components may be able to know that such policies exist. Once it is there, the fetcher 402 may read all the data and may do the clear tag filtering (e.g., using policies 202). The policies 202 to be assigned may be dependent on the source database 300, and it may be able to implement those policies 202A-N. Some protocols may allow specifying if one wants to get the changed data to translate on for accounts table, but some protocols may not, and then it may be done post processing. As the ACDS architecture is flexible, it may be done to get the best efficiency. This particular fact is very important because this controls and is known as a consumer's policy 202A-N, according to one embodiment.

The policies 206 A-N may include fetcher policy push-down to allow limit data read, publisher policy push-down to limit data source, consumer request policy evaluation for limit data served and consumer policy to configure application, etc.

By supplying consumer policy (e.g., 206 A-N), one may control what data gets replicated to a specific consumer (e.g. consumer application 308), according to one embodiment.

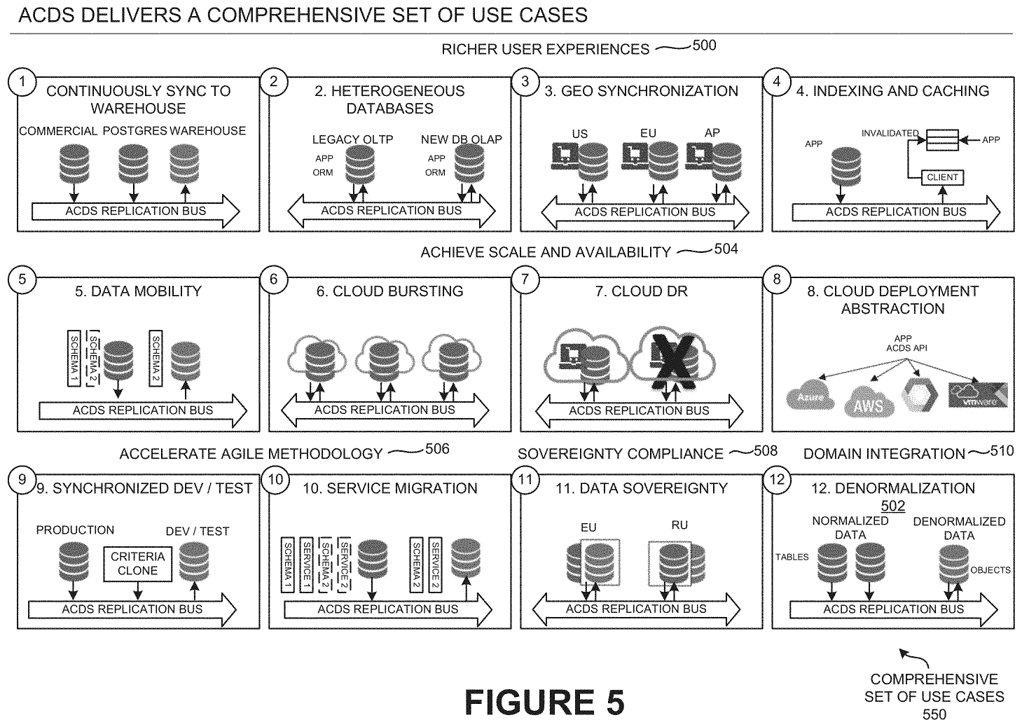

FIG. 5 illustrates a comprehensive set of use cases 550 of transactional replication bus 206 of the asynchronous change data system (ACDS). Particularly, FIG. 5 illustrates a richer user experiences 500 use case, a use case to achieve scale and availability 504, an accelerate agile methodology 506 use case, a sovereignty compliance 508 use case, and a domain integration 510 use case of the transactional replication bus 206 of the asynchronous change data system (ACDS), according to one embodiment.

The ORM may be the object relational mapping of the heterogeneous database. For example, there may be a kind of mismatch of, how application represents data and how data is stored in the database. The typical example may be a relational database. The data in a relational database may be put in the different tables. For example, an invoice may include the seller, the purchaser and the line items of what has been purchased. But this, in a typical application (e.g., consumer application 308) may include this as a single object, but when that gets stored in the database, that actually will probably be stored in at least three to four different tables. The transactional replication bus 206 may have a table for the purchaser, the seller and different individual table for line of items etc., because that makes it more efficient to serve rating in the relational database. The richer user experience 500 may give better performances and richer experiences, according to one embodiment.

The denormalization 502 may be the process of trying to improve the read performance of a database, at the expense of losing some write performance, by adding redundant copies of data and/or by grouping the data. The idea is, each one of the data source may represent the different domains of data. As an example, Salesforce® CRM may represent sales related data that may be a marketing automation tool that represent the marketing domain.

The domain may represent different data in different forms. The normalization 706 may be the process of organizing the columns (e.g., attributes) and tables (e.g., relations) of a relational database to reduce data redundancy and improve data integrity. When denormalized (e.g., using denormalization 502), the data may not be in first or second or third normal form in their basis and the data may be consumed between the data sources. These may be deep integration use cases, according to one embodiment.

Object materialization 708 may include reading a collection of tables from the relational database to normalize the invoice object. Reading the collection of tables from relational database may be the normalization 706. Denormalizing the data may include reconstructing the source object (e.g., product object 902), according to one embodiment.

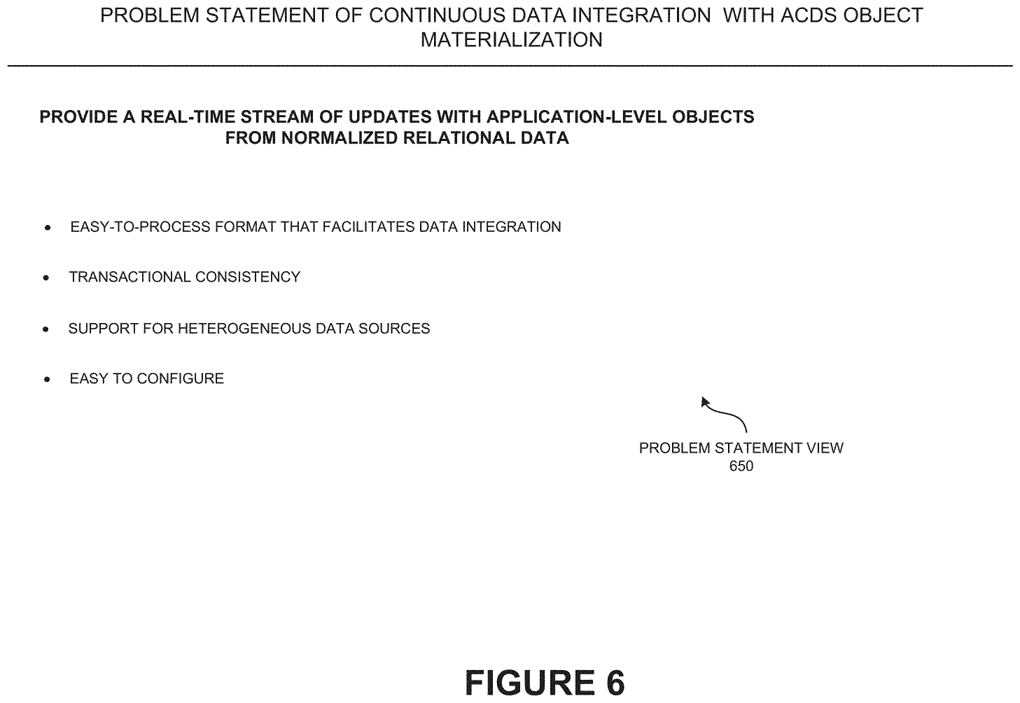

FIG. 6 illustrates the problem statement view 650 of continuous data integration with asynchronous change data system (ACDS) object materialization 708. The asynchronous change data system (ACDS) may provide a real-time stream of updates with application-level objects from normalized relational data. The continuous data integration with asynchronous change data system (ACDS) object materialization 708 may provide an easy-to-process format to facilitate data integration, transactional consistency, support for heterogeneous data sources, and may be easy to configure, according to one embodiment.

For example, when there is a change of a system from the relational database, the consumer application 308 may get a stream of updated changes in the table. But to make sense of those tables, the consumer application 308 may need to know how those different tables are related. The continuous data integration 1100 of asynchronous change data system (ACDS) may allow the enterprises to describe the data model and the consumer application 308 may reconstruct the data model.

A typical use case is that, for example, a new company may be acquired and the new company may store the customer data in certain set of tables and most of the applications may not have an idea that how they store. The continuous data integration 1100 may allow the asynchronous change data system (ACDS) to construct this layer which does the materialization (e.g., object materialization 708) of the customer data in all these different tables and provide the whole application to the company. The company may now be able to integrate data from other systems in the company and their position with other aspects, according to one embodiment.

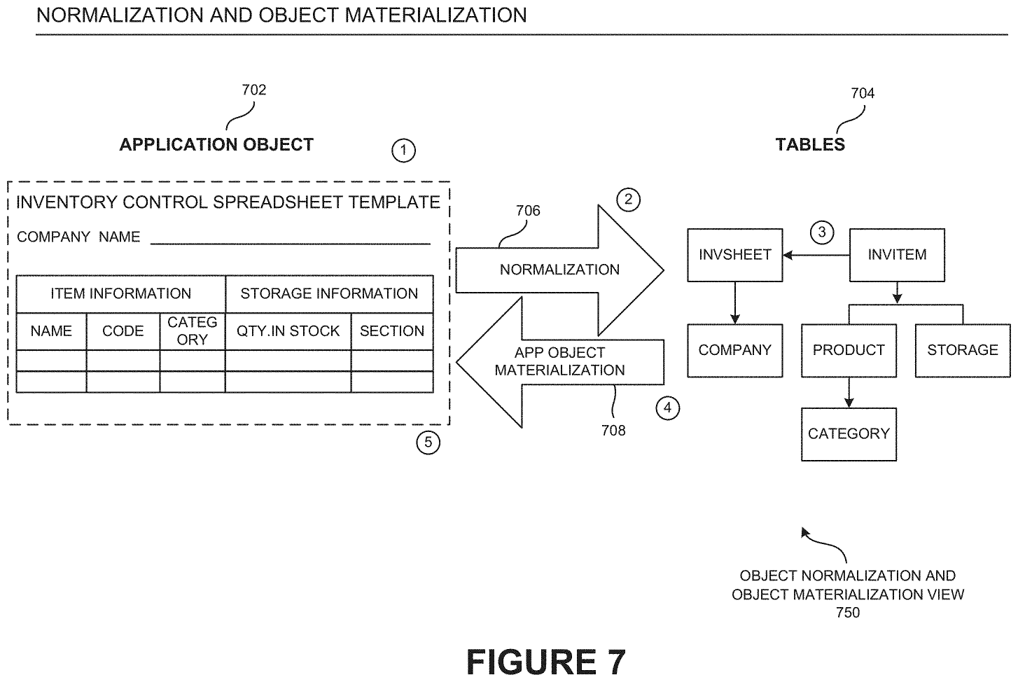

FIG. 7 illustrates the object normalization and object materialization view 750 of an application object of the asynchronous change data system (ACDS), according to one embodiment.

The application object 702 may be a file in a particular format (e.g., a spreadsheet etc.) that is used to store the information and access variables from any page in the consumer application 308. In relational database design, the process of organizing data may minimize redundancy. Object normalization 706 may involve dividing a database into two or more tables and defining relationships between the tables 704. A materialized view may be an application object 702 that contains the results of a query. Application object materialization 708 may be a local copy of data located remotely, or may be a subset of the rows and/or columns of a table 704 and/or join result, or may be a summary using an aggregate function in the transactional replication bus 206 of asynchronous change data system (ACDS), according to one embodiment.

FIG. 7 explains normalization 706 and object materialization 708 in the asynchronous change data system (ACDS). The original application object 702 of inventory spreadsheet, when normalized in relational database, may be a collection of tables 704 of inventory spreadsheet of application object 702, according to one embodiment.

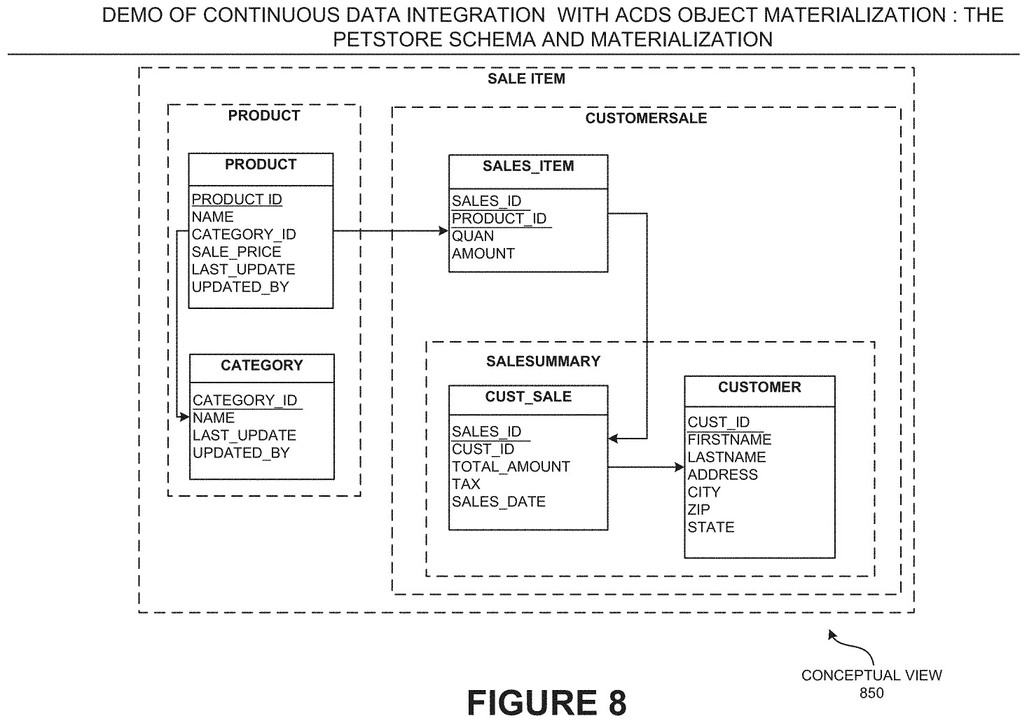

FIG. 8 is a conceptual view 850 illustrating an example embodiment showing continuous data integration 1100 and object materialization 708 of asynchronous change data system (ACDS) for PetStore use case, according to one embodiment.

The PetStore use case may be a set of service for the schema. This may be a reasonably famous petstore kind of application. The PetStore schema may describe what are total sales items and different objects. A set may have a product object 902 starting in two tables, a product and category, etc. So the product may have a category. The sale summary object may connect the data in customer sales table to the customer. The set may have another object with full information of the specific sale items that is bought and the specific item that have been sold. The object normalization 706 and object materialization 708 of the application object 702 of the asynchronous change data system (ACDS) may link on top of the underlying tables in the PetStore schema to reconstruct these object, as an example of different application objects, according to one embodiment.

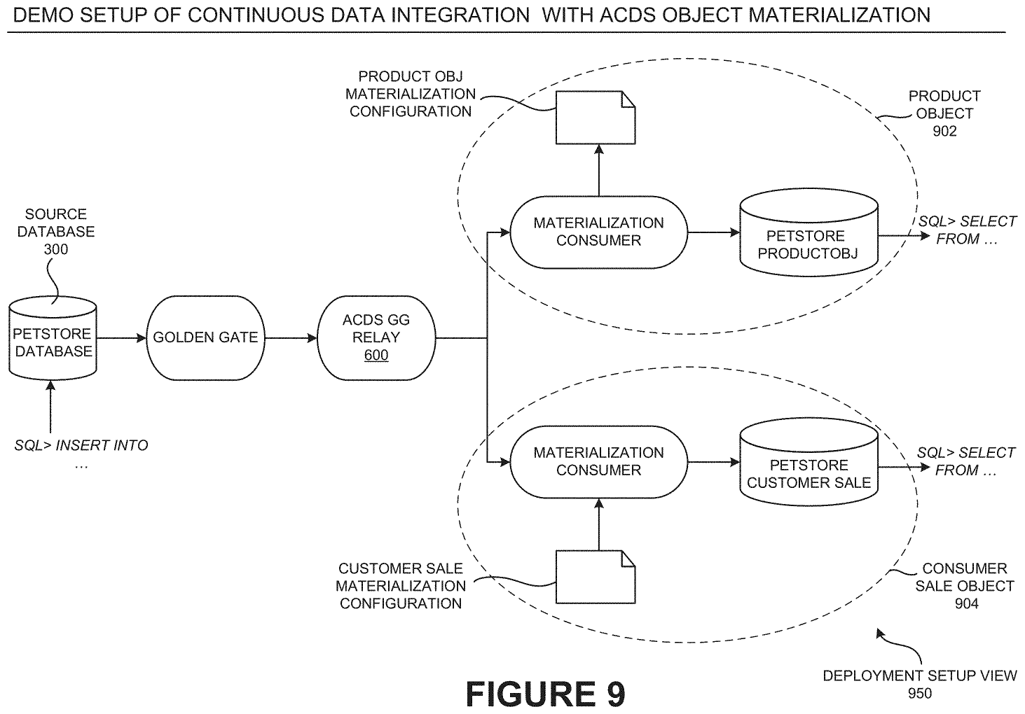

FIG. 9 illustrates a demo deployment setup view 950 of continuous data integration 1100 with asynchronous change data system (ACDS) object materialization 706 using the transactional replication bus 206, according to one embodiment.

FIG. 9 illustrates the PetStore database working as source database 300. The GoldenGate® may mine the data changes from the PetStore database. The asynchronous change data system (ACDS) relay 400 connected to the GoldenGate® may have two consumer applications 308. One consumer application 308 may be configured to materialize the product object 902. The second a consumer application 308 may be configured to materialize the consumer sale object 904, according to one embodiment.

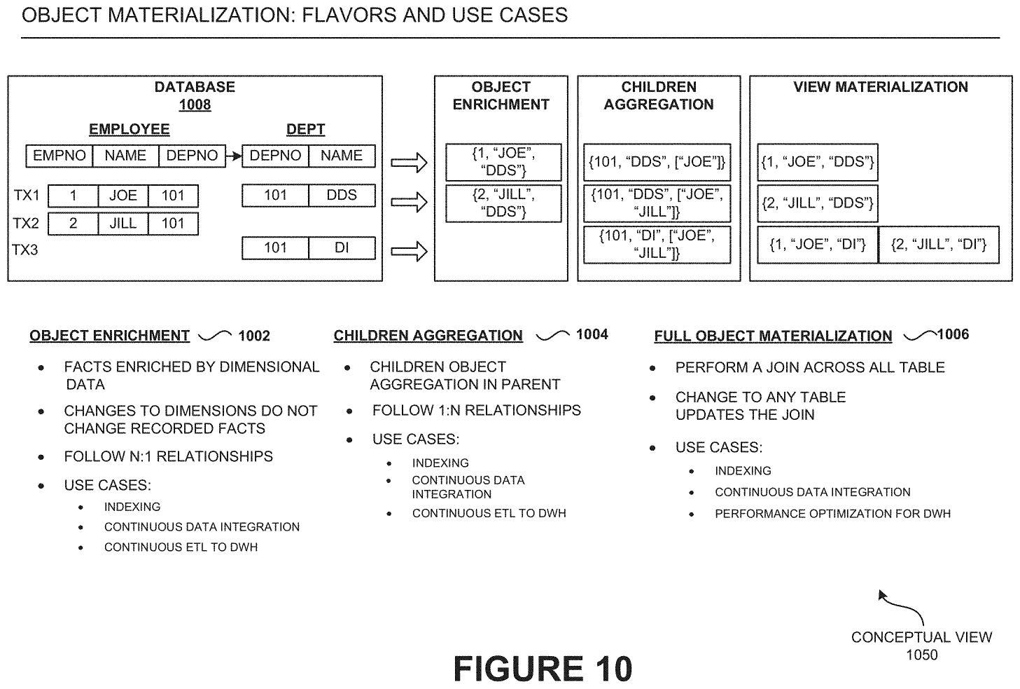

FIG. 10 is a conceptual view 1050 illustrating different flavors of object materialization 708 of the transactional replication bus 206 of ACDS and its use cases.

The object materialization 708 may have three flavors: object enrichment 1002, children aggregation 1004 and full object materialization 1006.

The object enrichment 1002 may include the facts enriched by dimensional data and the changes to dimensions to not change recorded facts. The object enrichment 1002 may follow N:1 relationships. The use cases of object enrichment 1002 may include indexing, continuous data integration and continuous ETL (i.e., extract, transform and load) to DWH (e.g., data warehouse).

The children aggregation 1004 may include children object aggregation in parent, and may follow 1:N relationships. The use cases of children aggregation 1004 may include indexing, continuous data integration 1100, and continuous ETL to DWH.

The full object materialization 1006 may perform joining across all tables and may update and/or join the tables. The use cases of full object materialization 1006 may include indexing, continuous data integration, and performance optimization for DWH.

FIG. 10 further explains a typical example for database 1008 showing two tables, i.e., the employee table and the department table. The first flavor of object materialization 702 may be the object enrichment 1002. The database 1008 may include the employee object which indicates the employees and his respective department. In the object enrichment 1002 use case, an object may be constructed only if a row in the employee table changes. Consider a new employee Joe, joins as a part of the department 101 i.e., the DDS department. At that point “Joe works in the DDS department” may be created in the object. But when the name of the department changes from DDS to DI in the transaction 3, the record for the Joe may not be seen as the name of the Joe's department may be DI and not DDS.

These use cases may typically be used for the data warehouses. The fact in the dimension kind of model where it has facts and the fact may be recorded as they happen, it may be annotated for different dimensions, but the facts may never change.

A user object may be created by going from department to employee. Every time if a new employee joins, the updated department information may be received. Initially, the DDS department has one employee, Joe. Further, when a new employee Jill joins, and when the name of the department changes, it is reflected in the children aggregation 1004 with department 101 as DI and has two employees. This may be the third use case. The dematerialization may be an extension of the object enrichment 1002. When there is object enrichment 1002, if the name of the department changes, the user object may never change.

But in dematerialization, at any time, for any related change, the table may change. All the tables may be related. All the objects that depend on table and/or are related to that table, changes. Hence, it may be the kind of most strong use case.

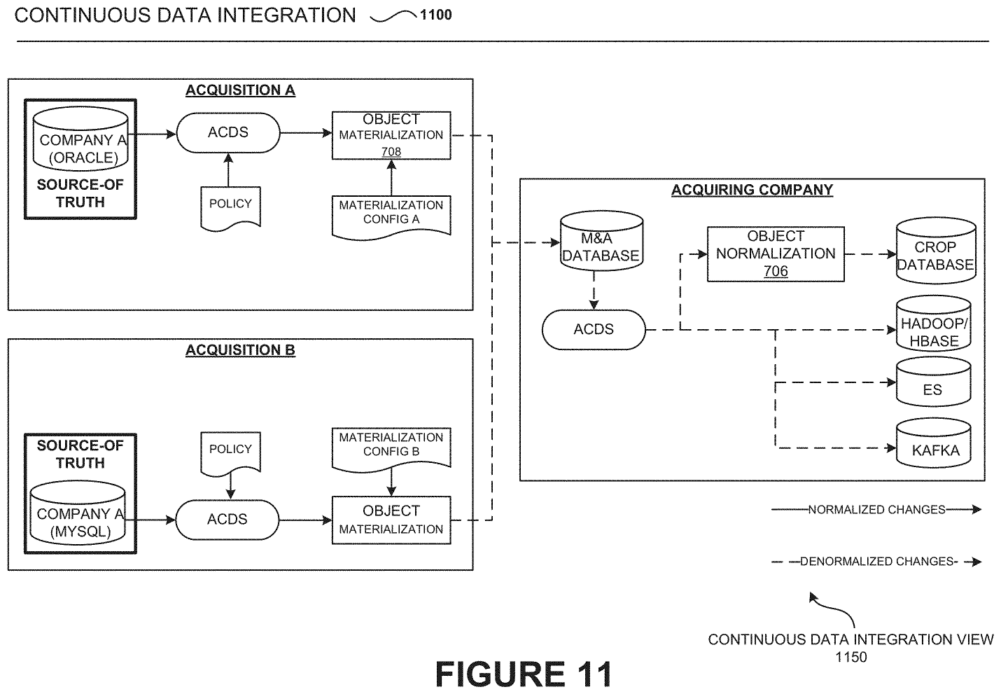

FIG. 11 is a continuous data integration view 1150 illustrating a real-time integration 106 in the transactional replication bus 206 of ACDS. The continuous data integration 1100 may simplify the integration of acquired companies' database. In continuous data integration 1100, the data model conversion for simplifying the integration of acquired companies' database may be based on higher-level application object (e.g., application object 702). Simplification of the integration of acquired companies' database may support the heterogeneous data sources (e.g., source database 300). The continuous data integration 1100 may provide real time change stream. The continuous data integration 1100 (e.g., real-time integration 106) may maintain transactional consistency for replication of OLTP (Online transaction processing) to avoid the bogus data.

FIG. 11 shows the application of object materialization 708 in a company ‘A’. The company ‘A’ may have many acquisitions and use of dematerialization to collect the data coming from acquiring company M&A database where the object is licensed, according to one embodiment.

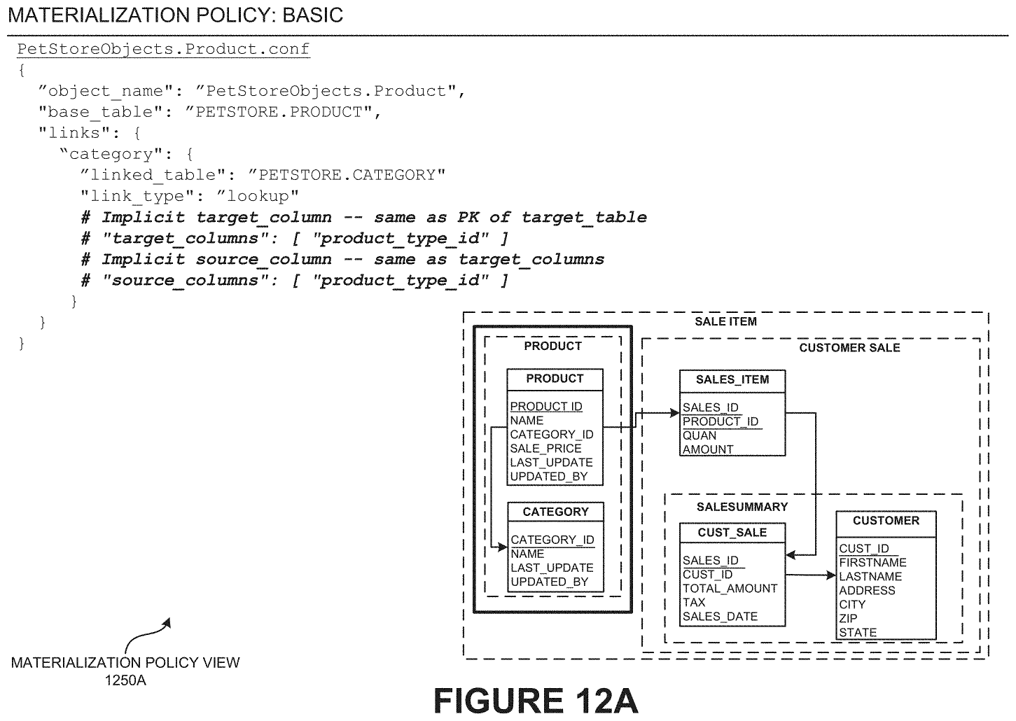

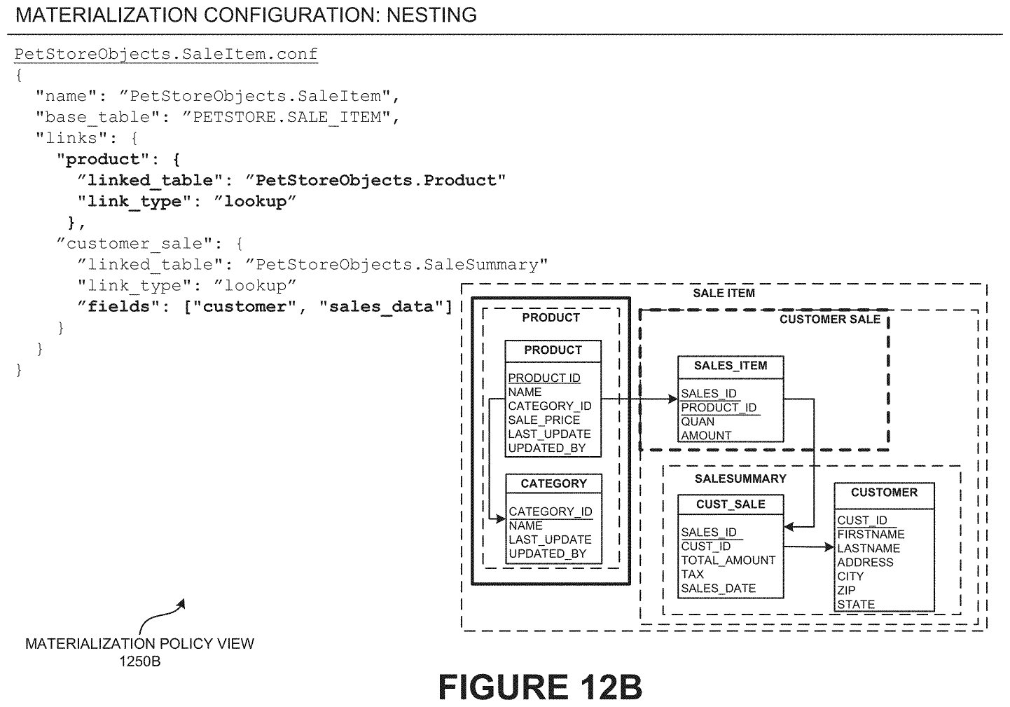

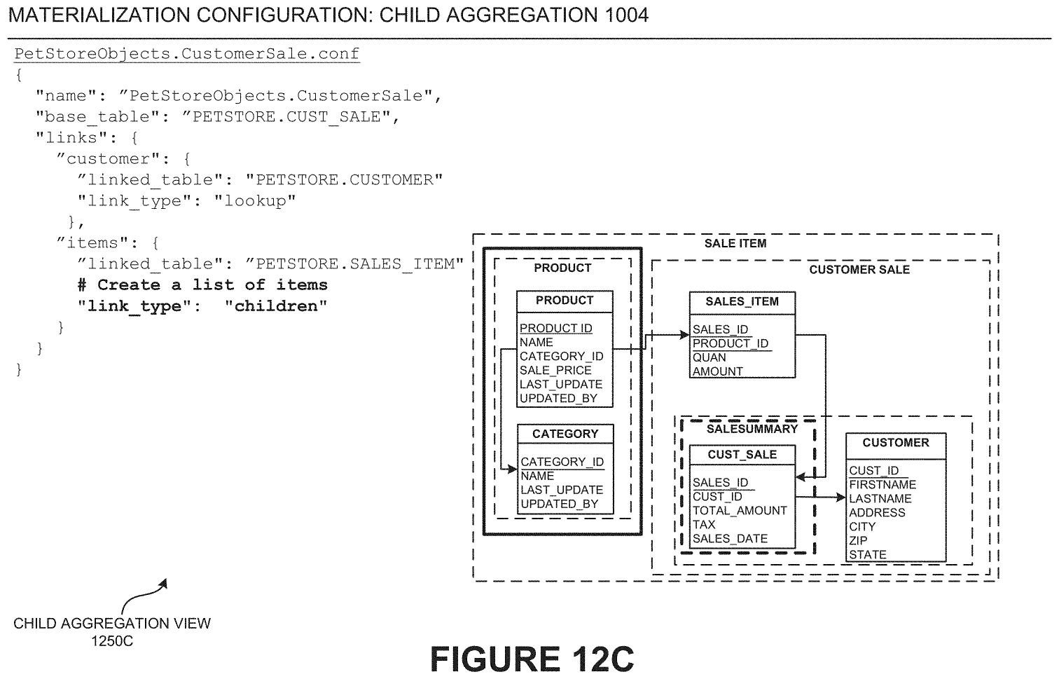

FIG. 12A illustrates a materialization policy view 1250A. The policy may be described using the Human Optimized Configuration Object Notation (HOCON) syntax. The policy may use the configuration to describe what the product object 902 is. The HOCON syntax format may be used to construct a product. The policy may start exploring the relationship between the tables and then describe all the linked tables. The links in the category table may make it very simple and may try to extract as much information as possible after the underlying database and try to infer the links. This may be a different kind of policy where the policy has the links.

FIG. 12B is a continuation of FIG. 12A and illustrates the materialization policy view 1250B. The policy may have links not only for tables but may also make policy for other objects (e.g., product object 902). For example, the sale items may have a link to a product. It may integrate the whole information from the product table of the product object. The product object 902 as already described may have two more tables. The policy may make it much easier to configure those kinds of materialization policies 202, according to one embodiment.

FIG. 12C is a child aggregation view 1250C illustrating a continuation of FIG. 12A and FIG. 12B describing the child aggregation 1004 of object materialization 708 configurations. The policy may have parent child relationship between tables and it may include all the information of the children in the object that contains in the parent table. The example here may be the sale, customer sale and the sale items, where the customer sale is the parent sale, shows the individual sale item of the children. The object materialization 708 may provide a bigger picture as an example of consumer application 308, which leaves to a stream of changed tables and that may strike those objects, according to one embodiment.

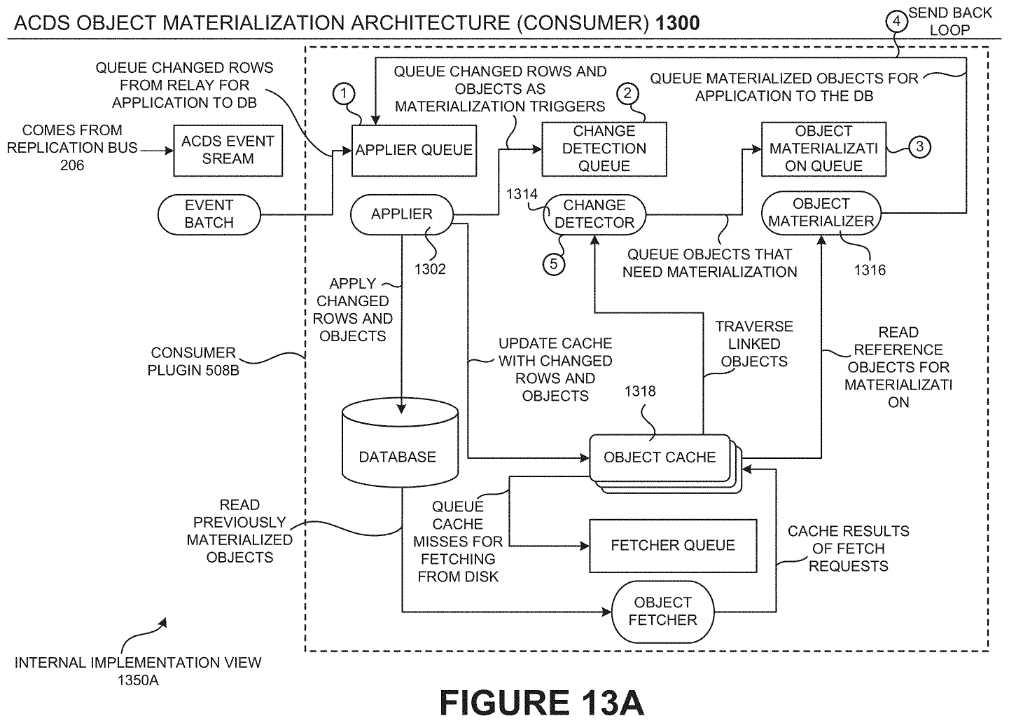

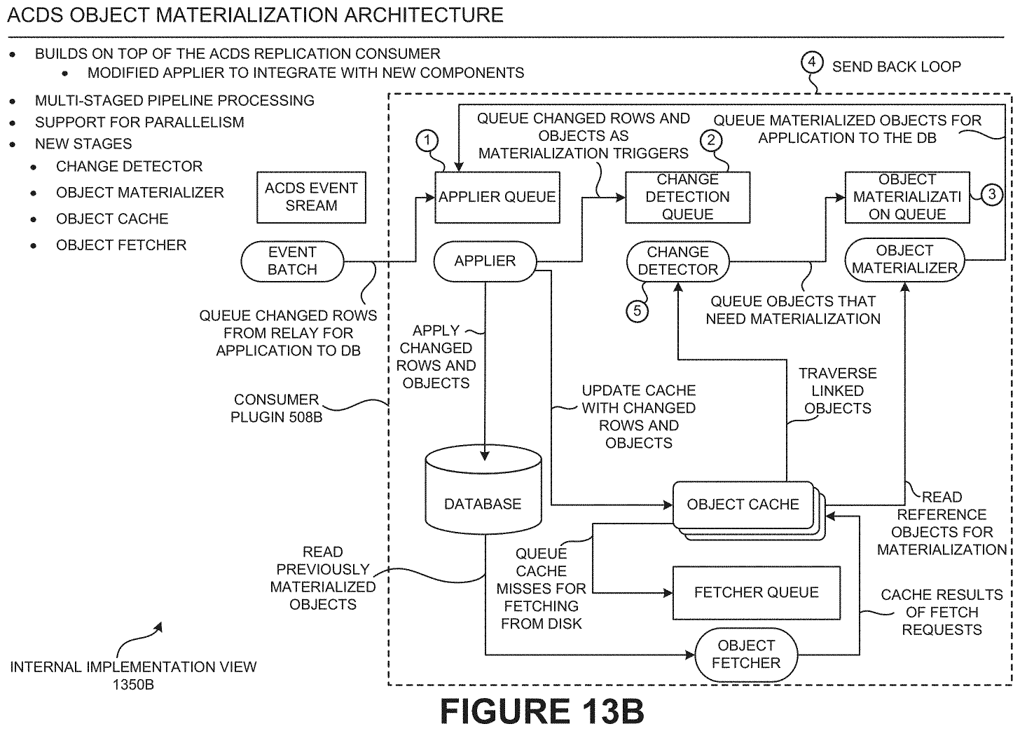

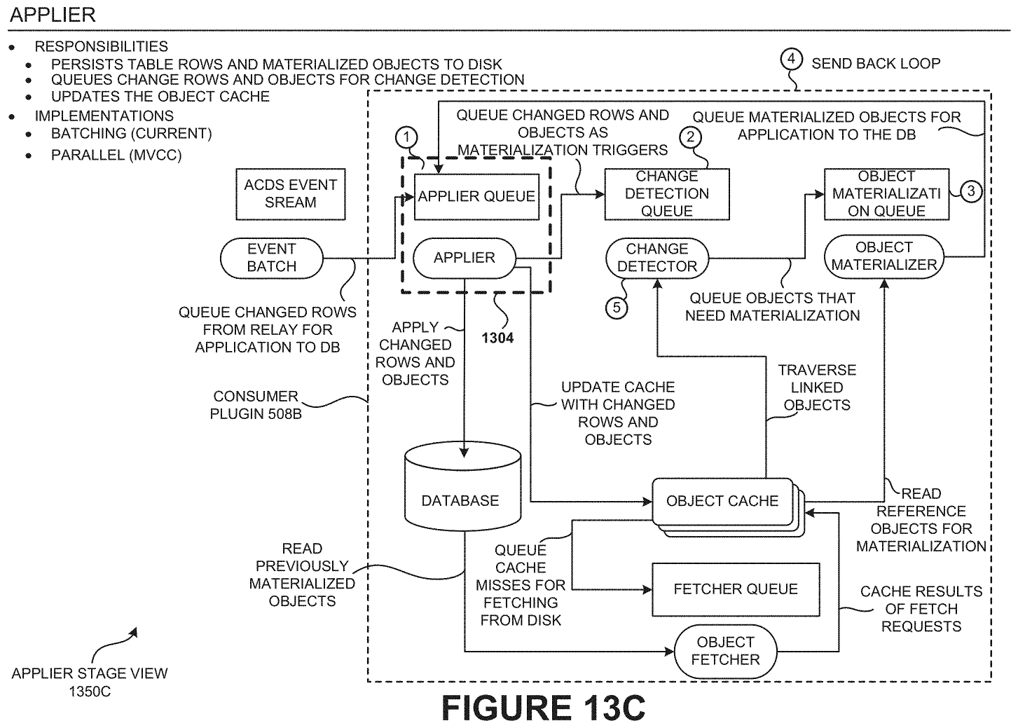

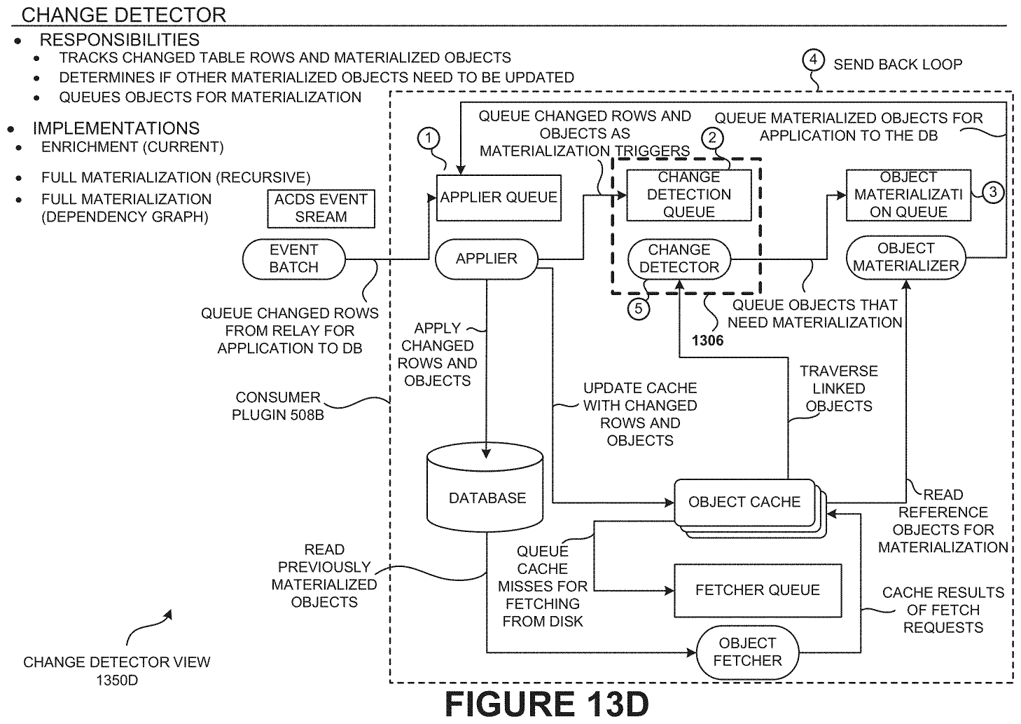

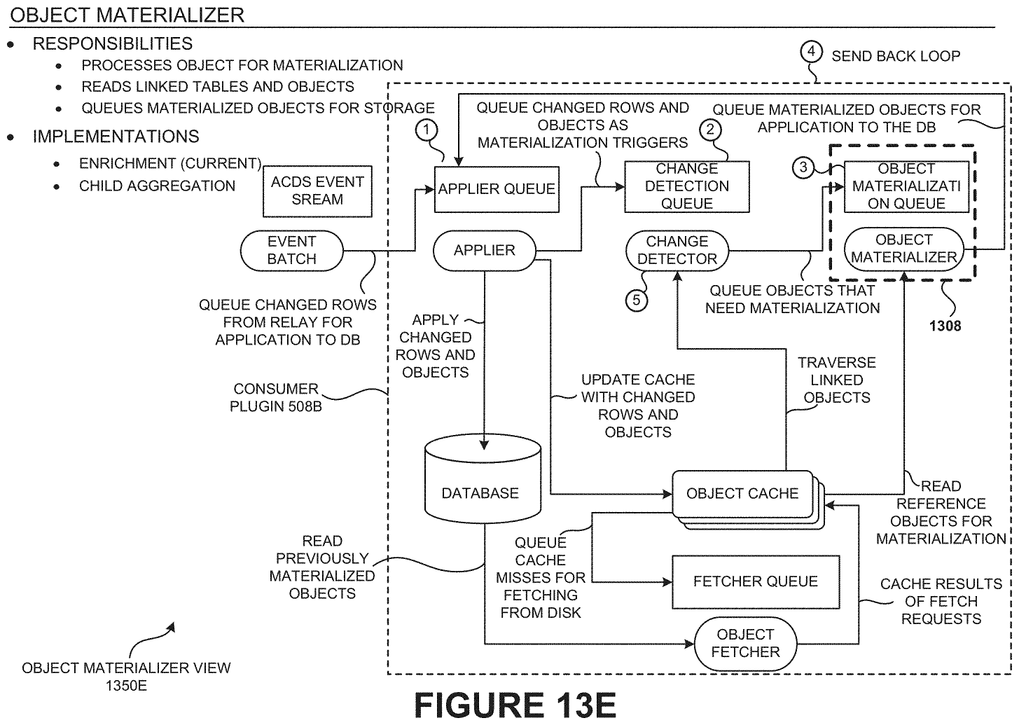

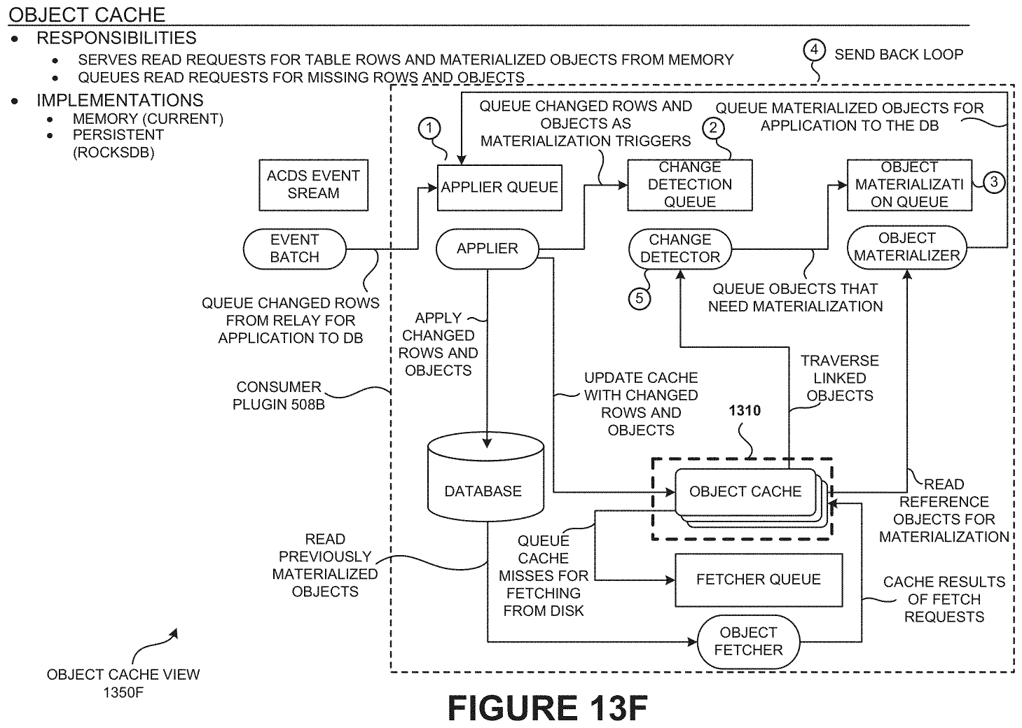

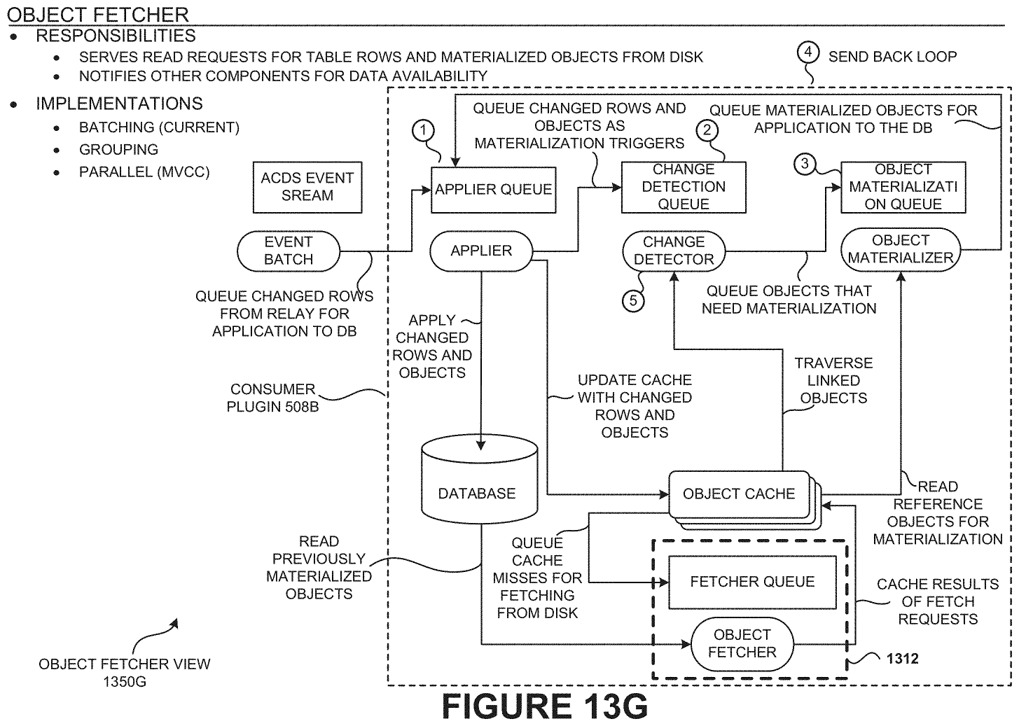

FIG. 13A-13B illustrates the internal implementation view 1350A of ACDS object materialization architecture 1300 of the consumer application 308. The ACDS object materialization architecture 1300 in the consumer application 308 may be built on the top of the ACDS transactional replication bus 206. The ACDS object materialization architecture 1300 in the consumer application 308 may allow the modified applier 1302 to integrate with new component. The ACDS object materialization architecture 1300 in the consumer application 308 may involve multi-staged pipeline processing. The ACDS object materialization architecture 1300 may support for parallelism in the consumer application 308. The bigger scale may be achieved by using multistage pipeline processing. The multistage pipeline processing of ACDS object materialization architecture may include applier stage 1304 (shown in circle ‘1’), change detector stage 1306 (shown in circle ‘2’), object materializer stage 1308 (shown in circle ‘3’), object cache stage 1310 (shown in circle ‘4’), and object fetcher stage 1312 (shown in circle ‘5’), according to one embodiment.

The internal implementation view 1350A of ACDS object materialization architecture 1300 of the consumer application 308 shows the event batch which may contain the event stream coming from ACDS transactional replication bus 206. The applier stage 1304 may write the data from source database 300 to target database (e.g., destination database 302) verbatim to cache it for later reuse. The change detector 1314 may detect the object from the table data to rematerialize the required objects. The object materializer 1316 (e.g., using object materialization 708) may construct the object by reading the data from rows of the table. The materialized object may be send back to the source database 300 through the applier 1302. The object cache 1318 may be a central component that keeps track of recently changed data. The object fetcher 402 may allow reading data from the target database, according to one embodiment.

FIG. 13C is an applier stage view 1350C illustrating the applier stage 1304 of ACDS object materialization architecture 1300 (e.g., using object materialization 708) of the consumer application 308. The applier stage may be the first stage in the internal implementation of ACDS object materialization architecture 1300 of the consumer application 308. The applier 1302 may persist the table rows and materialized objects to disk. The applier 1302 may change the rows and objects for the change detection. The applier 1302 may update the object cache 1318. The applier 1302 may implement batching and parallelization through MVCC (multi version concurrency control). The batching process in the applier stage 1304 may batch the multiple updates and write them in a single group, according to one embodiment.

FIG. 13D is a change detector view 1350D illustrating the change detector stage of ACDS object materialization architecture of the consumer application 308. The change detector stage 1306 may be the second stage in the internal implementation of ACDS object materialization architecture 1300. The change detector 1314 may track the changed table rows and materialized object. The change detector 1314 may determine if other materialized object needs to be update. Further, the change detector 1314 may queue the object for materialization. The implementations of change detector 1314 may include enrichment 1002 and full materialization 1006, according to one embodiment.

FIG. 13E is an object materializer view 1350E illustrating the object materializer stage 1308 of ACDS object materialization architecture 1300 of the consumer application 308. The object materializer stage 1308 may be the third stage in the internal implementation of ACDS object materialization architecture 1300. The object materializer 1316 may process the object (e.g., product object 902) for materialization (e.g., using object materialization 708). The object materializer 1316 may read linked table and objects. Further, the object materializer 1316 may queue materialized objects for storage. The implementations of object materializer 1316 may include enrichment 1002 and child aggregation 1006, according to one embodiment.

FIG. 13F is an object cache view 1350F illustrating the object cache stage 1310 of ACDS object materialization architecture 1300 of the consumer application 308. The object cache 1318 may be a central component that keeps track of recently changed data. The object cache stage 1310 may be the fourth stage in the internal implementation of ACDS object materialization architecture 1300. The object cache 1318 may serve the read request for table and rows and materialized objects from memory. The object cache 1318 may queue the read requests for missing rows and objects. The implementations of object cache 1318 may include memory and persistent, according to one embodiment.

FIG. 13G an object fetcher view 1350G illustrating the object fetcher stage 1312 of ACDS object materialization architecture 1300 of the consumer application 308. The object fetcher stage 1312 may be the fifth stage in the internal implementation of ACDS object materialization architecture 1300. The object fetcher 402 may serve the read request for table rows and materialized object from disk. Also, the object fetcher 402 may notify other components for data availability. The implementations of object fetcher 402 may include batching, grouping, and parallelization through MVCC, according to one embodiment.

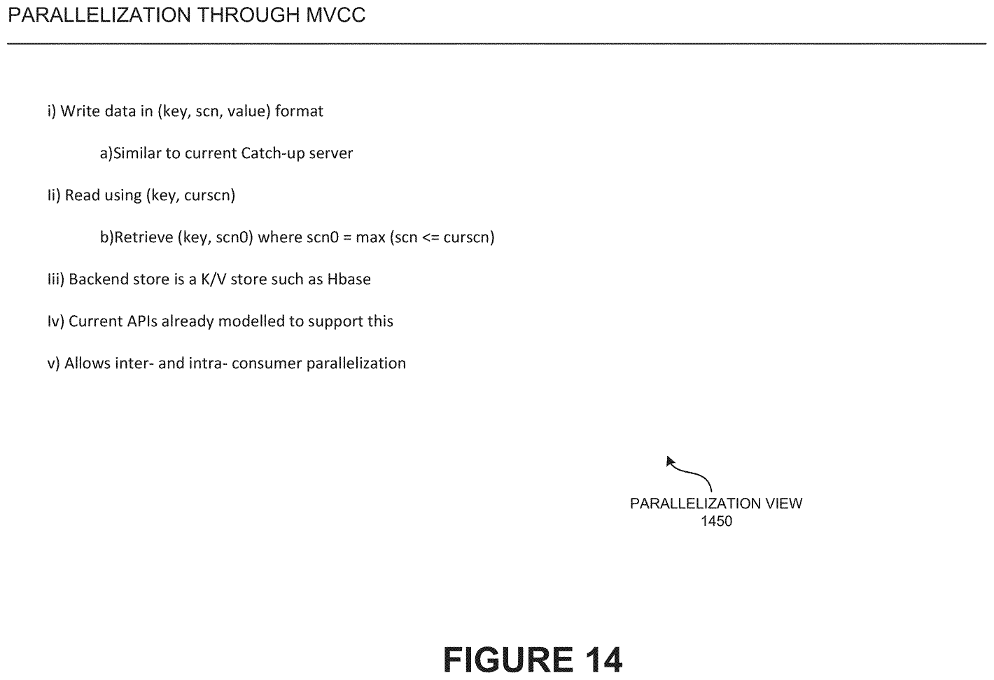

FIG. 14 a parallelization view 1450 illustrating the parallelization through multi-version concurrency control (MVCC). The basic idea of parallelization through multi-version concurrency control is that when user application (e.g., consumer application 308) has the data, it just does not write the data but also write the version and when user application is reading. The user application (e.g., consumer application 308) may read exactly what version of data it may want to read. So that the user application may read and write in parallel and may not have to synchronize both the data and the writers. The parallelization may allow the user application e.g., consumer application 308) to use the consistency of data, according to one embodiment.

Object materialization 708 may allow using data consistency because user application (e.g., consumer application 308) is able to not just send a data but also a version of data.

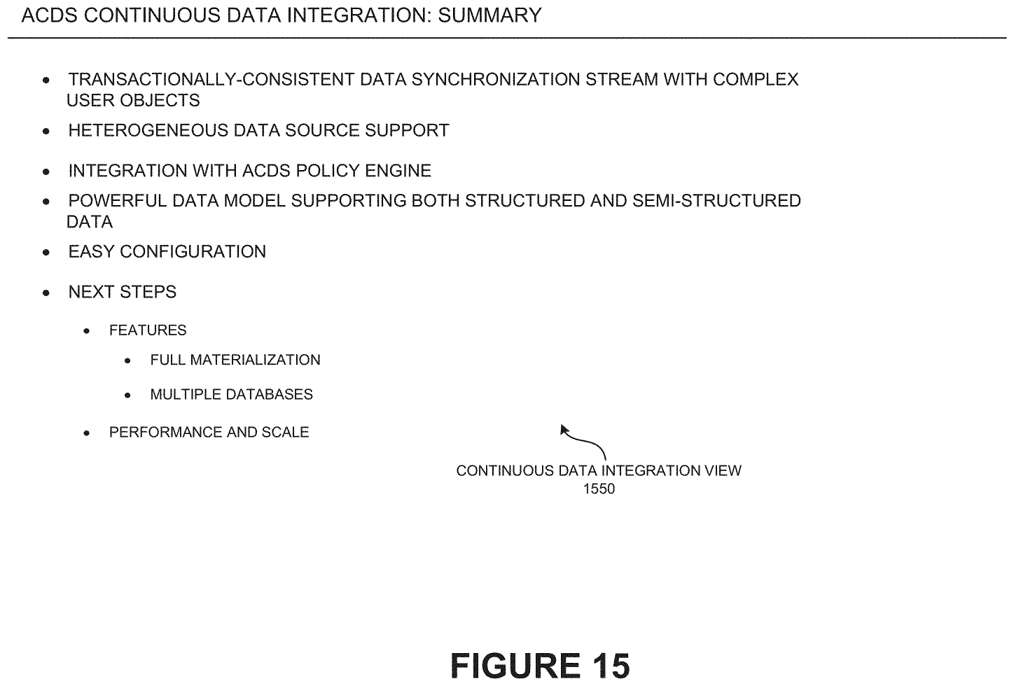

FIG. 15 is a continuous data integration view 1550 describing the summary of ACDS continuous data integration 1100 of the transactional replication bus 206 of ACDS. The ACDS continuous data integration 1100 may be easy to configure. The ACDS continuous data integration 1100 may allow the transactionally-consistent data synchronization stream with complex user objects (e.g., product object 902). The ACDS continuous data integration 1100 may provide heterogeneous data source support. The ACDS continuous data integration 1100 may integrate with ACDS policy engine. Further, the ACDS continuous data integration 1100 may have a powerful data model to support both structured and semi-structured data. In addition, the ACDS continuous data integration 1100 may incorporate features such as full materialization 1006 and multiple databases and may provide better performance and scaling, according to one embodiment.

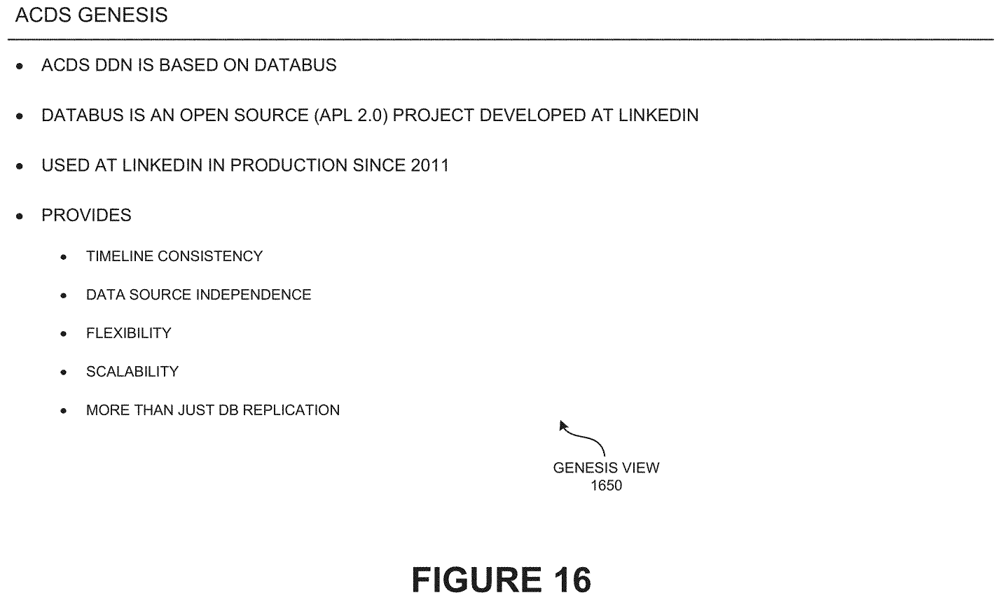

FIG. 16 is a genesis view 1650 illustrating the genesis of asynchronous change data system (ACDS). The data distribution network (DDN) of asynchronous change data system (ACDS) may be based on open-source (APL 2.0) databus. The data distribution network of asynchronous change data system (ACDS) may provide timeline consistency, data source independence, flexibility, scalability, and further adds to database replication in an open source environment, according to one embodiment.

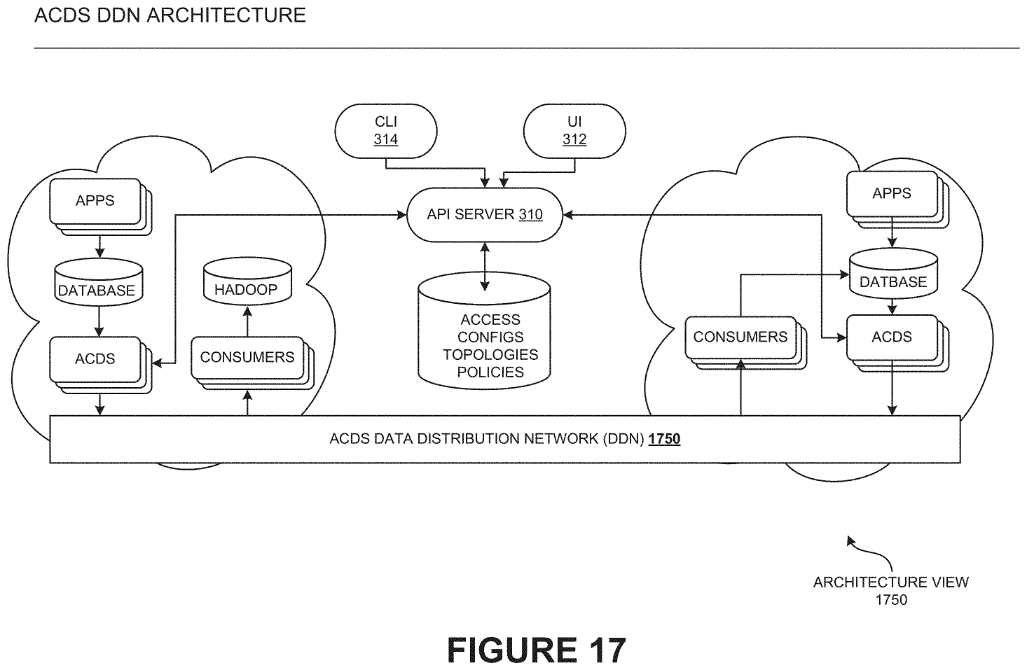

FIG. 17 is an architecture view 1750 illustrating the architecture of data distribution network (DDN) of asynchronous change data system (ACDS). The asynchronous change data system (ACDS) may have consumers (e.g., UI 312) distributed across different cloud networks. The consumers distributed across different cloud networks may consume the data distribution network (DDN) 1750 data based on the API server policies 202. The command line interface CLI 314 of the API server 310 may manage topologies, policies 202 and access configuration of the asynchronous change data system (ACDS) for its consumers (e.g., consumer application 308) across distributed cloud networks. The data distribution network (DDN) 1750 of asynchronous change data system (ACDS) may allow cloud spanning of the distributed cloud networks. The data distribution network (DDN) 1750 of the asynchronous change data system (ACDS) may allow deployment of a large pool of computing resources over multiple cloud environments (e.g., private cloud, public cloud and/or hybrid cloud), according to one embodiment.

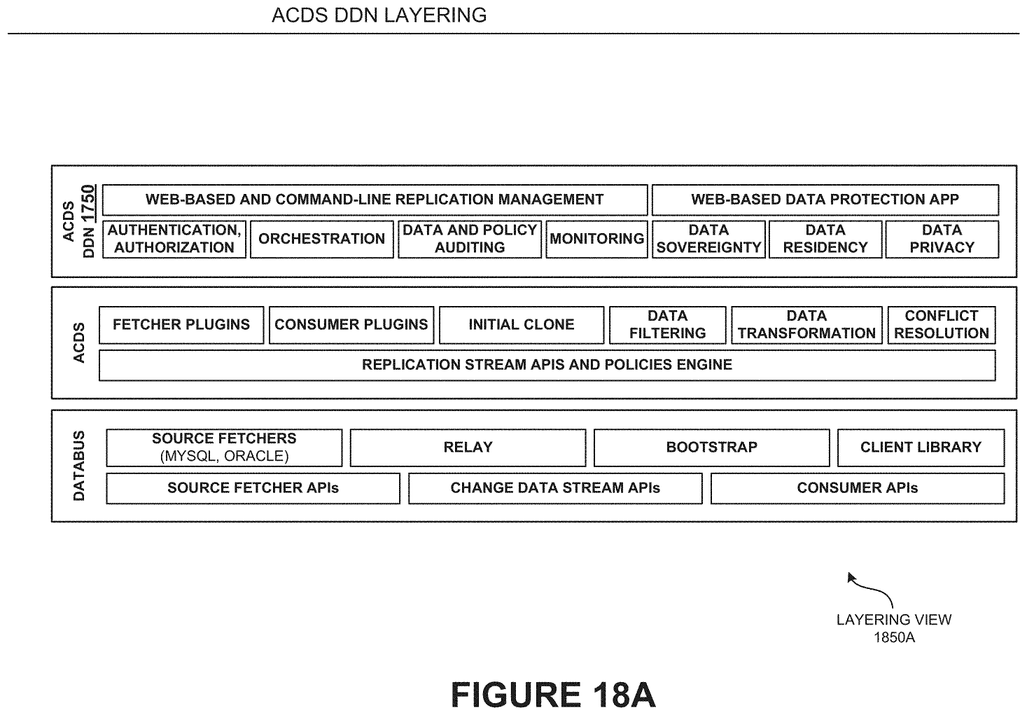

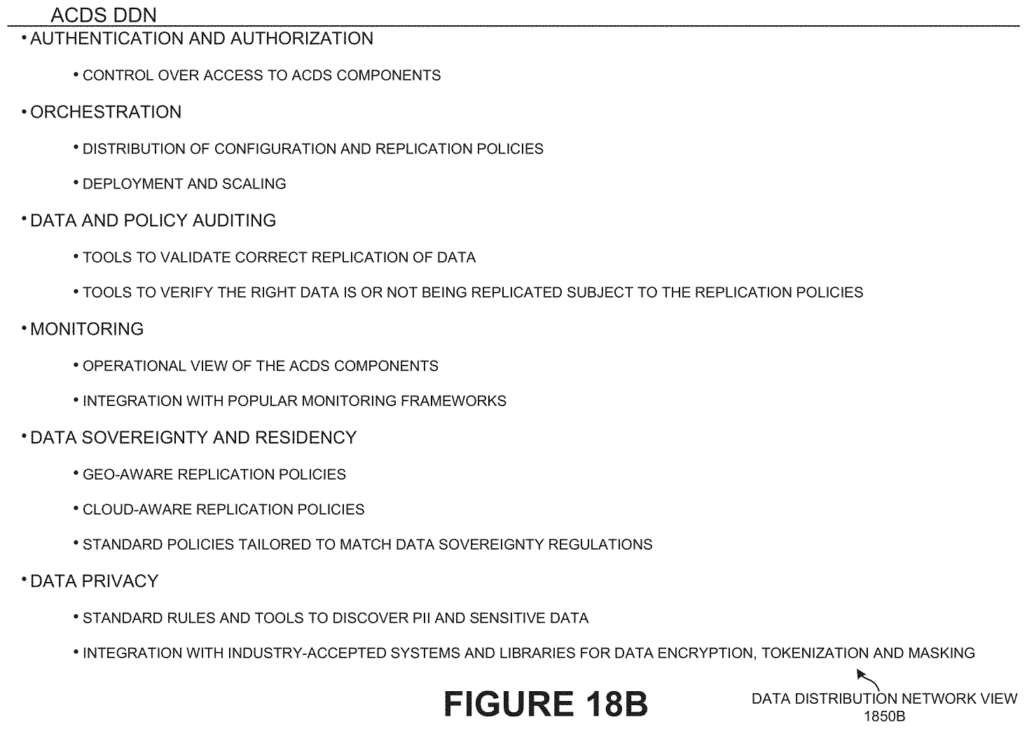

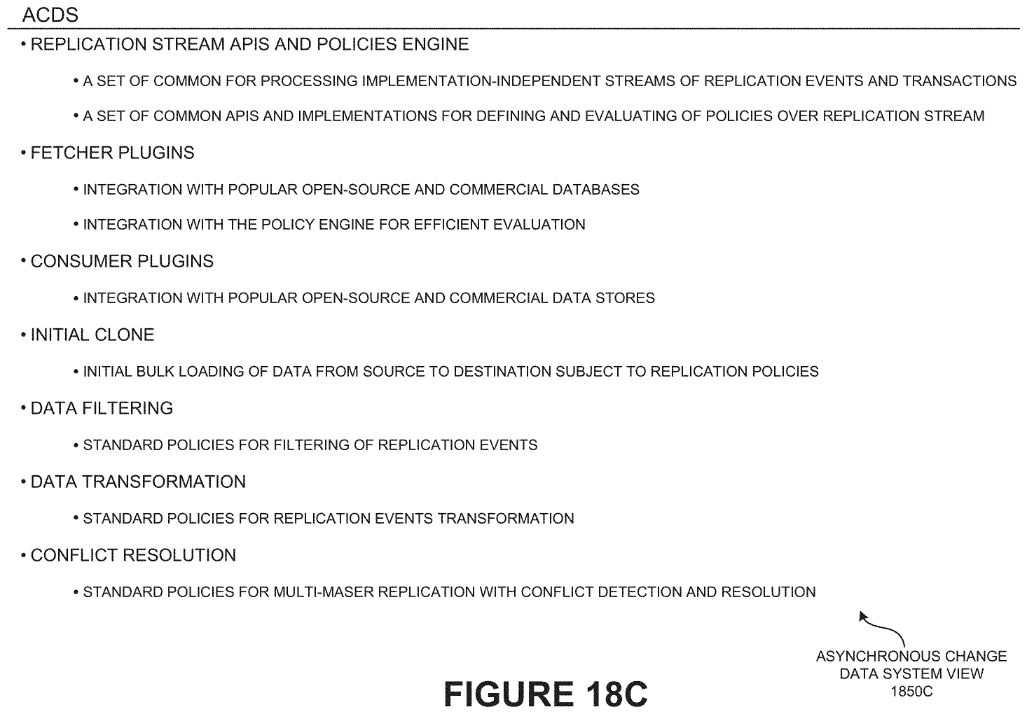

FIG. 18A is a layering view 1850A illustrating the layering of data distribution network (DDN) 1750 of the transactional replication bus 206. FIG. 18A shows three different layers of the transactional replication bus 206 that may include Databus, asynchronous change data system (ACDS) and data distribution network (DDN) 1750. The Databus may be a change-data capture system that uses Apache® Public License (version 2.0). The asynchronous change data system (ACDS) may be a system that allows the bus to move the data from source to destination and applies replication policies 202. The data distribution network (DDN) 1750 may be an orchestration system that manages and monitors the components in ACDS. The asynchronous change data system (ACDS) may extend the Databus by adding a fetcher plugin model 402 and a consumer plugin model 308B, criteria based cloning of initial copy of data from database and replication policies, according to one embodiment.

FIG. 18B is a data distribution network view 1850B describing the summary of the data distribution network (DDN) 1750 of the transactional replication bus 206. The data distribution network (DDN) 1750 of asynchronous change data system (ACDS) may provide the authentication and authorization of data to control over access to components connected in the network. The data distribution network (DDN) 1750 may be an orchestration bus to distribute the configuration and replicate the policies 202. Further, the orchestration policy of the data distribution network (DDN) 1750 may allow the deployment and scaling of the data.

The data distribution network (DDN) 1750 may provide data and policy auditing. The data and policy auditing of the data distribution network (DDN) 1750 may include tools to validate correct replication of data. Furthermore, the data and policy auditing of the data distribution network (DDN) 1750 may include tools to verify right data to replicate subject to replication policies 202. The data distribution network (DDN) 1750 may monitor the operational view of the ACDS component in the network. The data distribution network (DDN) 1750 may also monitor the integration with popular monitoring frameworks. The data distribution network (DDN) 1750 may include the data sovereignty and residency to provide the geo-aware and cloud-aware policies (e.g., using policies 202). The sovereignty and residency may provide standard policies tailored to match data sovereignty and regulations. In addition, the data distribution network (DDN) 1750 may provide data privacy. The data distribution network (DDN) 1750 may have standard rules and tools to discover personal identifiable information (PPI) 1750 and sensitivity data. The data distribution network (DDN) 1750 may integrate with industry accepted systems and libraries for data encryption, tokenization and masking, according to one embodiment.

FIG. 18C is an asynchronous change data system view 1850C describing the summary of the asynchronous change data system (ACDS) of the replication bus 206. The asynchronous change data system (ACDS) may include replication stream APIs and policies engine, fetcher plugins, consumer plugins, initial clone, data filtering, data transformation and conflict resolution, according to one embodiment.

Replication stream APIs and policies engine may include a set of common for processing implementation-independent streams of replication events and transactions. In addition, replication stream APIs and policies engine may further include a set of common APIs and implementations for defining and evaluating of policies 202 over replication stream, according to one embodiment.

The fetcher plugins 402 may allow the integration with popular open-source and commercial database systems. The fetcher plugins 402 may also allow integration with the policy engine for efficient evaluation. The consumer plugins 308B of the asynchronous change data system (ACDS) may allow integration with popular open-source and commercial data stores. Subject to replication policies, the asynchronous change data system (ACDS) may initially load the data from source to destination. The asynchronous change data system (ACDS) of the replication bus 206 may have the standard policies 202 for filtering and transformation of the replication events. The asynchronous change data system (ACDS) may have the standard polices 202 for multi-master replication with conflict detection and resolution, according to one embodiment.

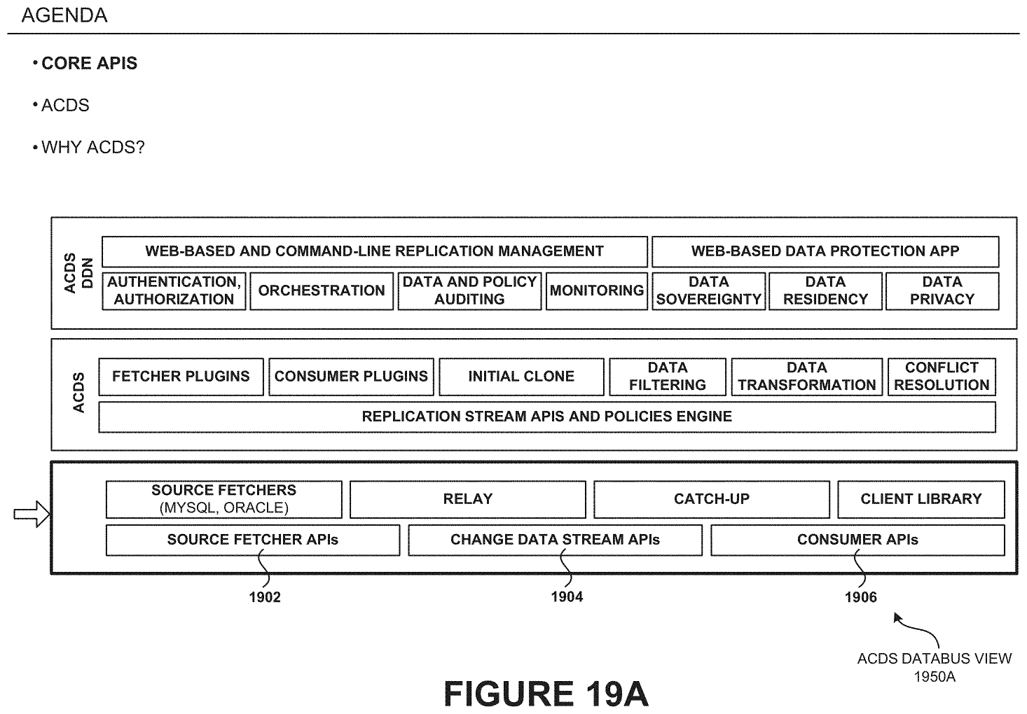

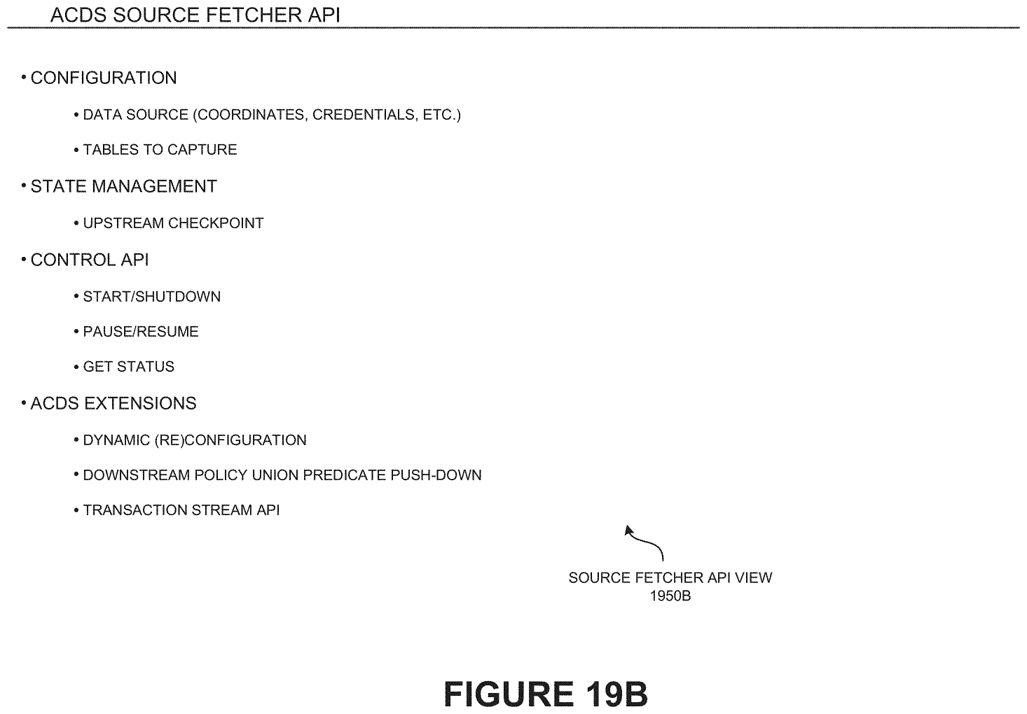

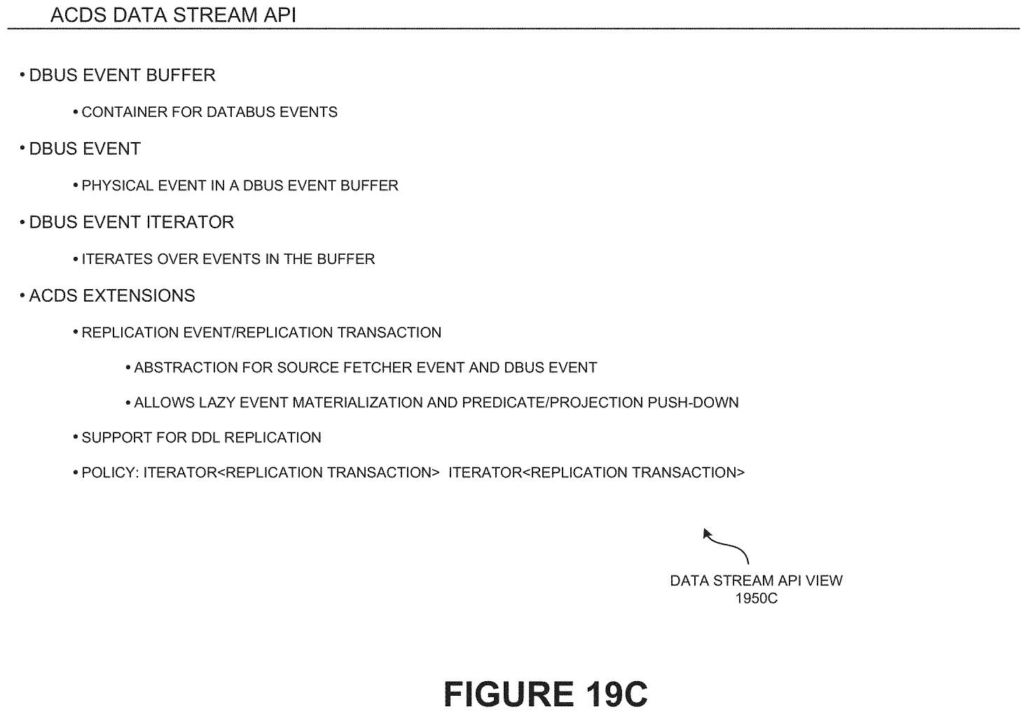

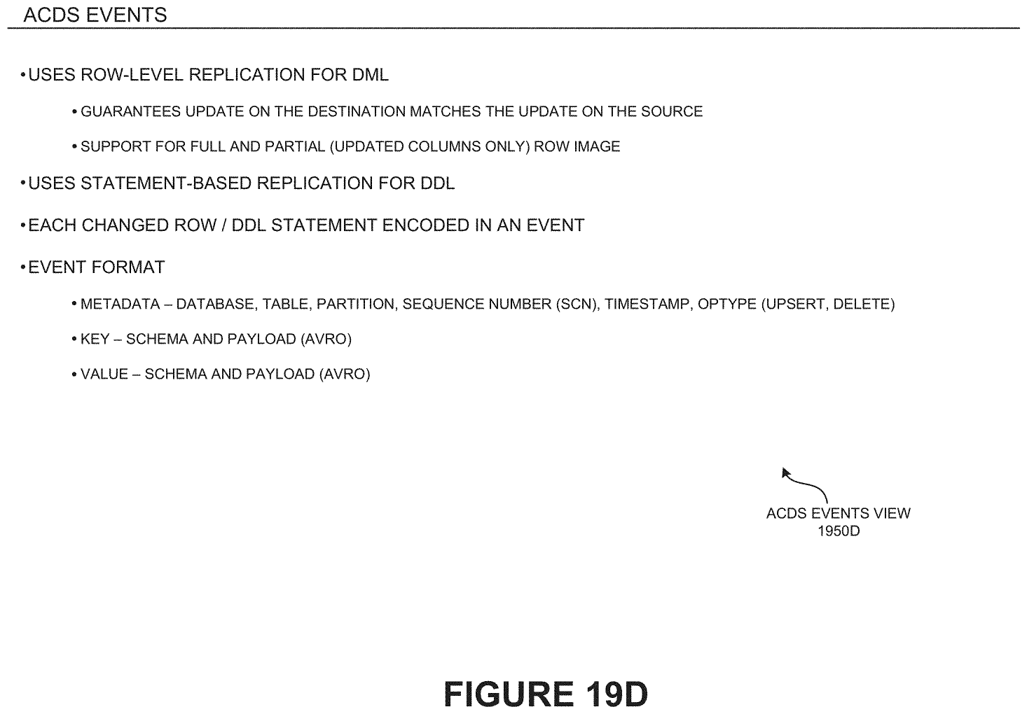

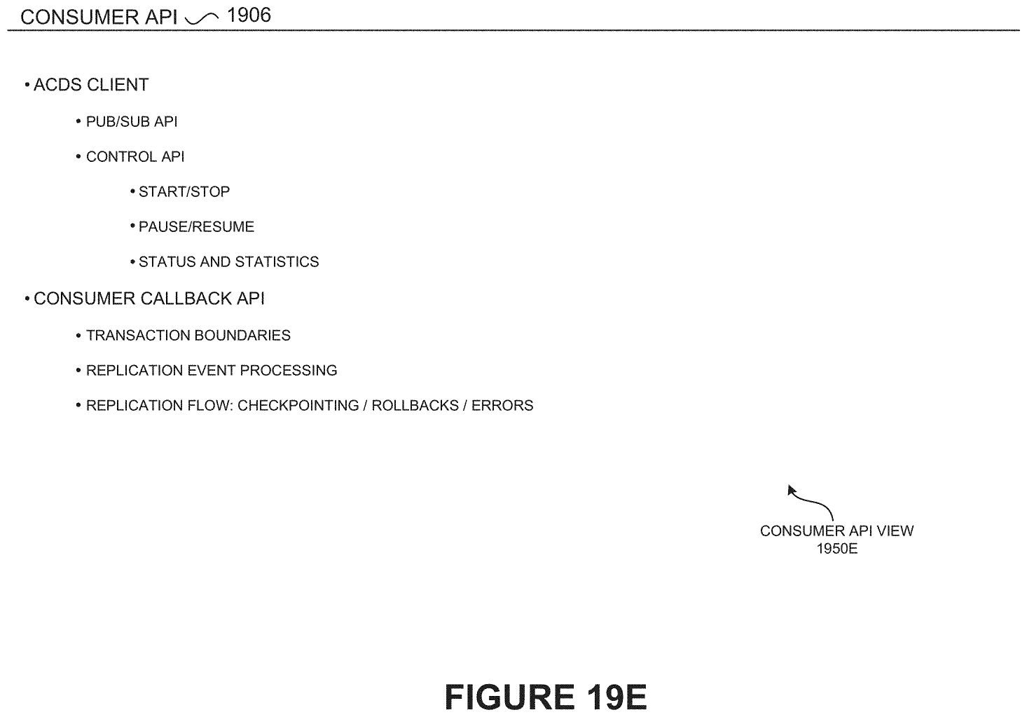

FIG. 19A is an ACDS databus view 1950A illustrates the ACDS databus which may be a primary Databus extended with an additional database integration with policies 202 configured based on a model specifying what may get processed on the bus. The primary Databus may include source fetchers (e.g., MySQL. Oracle), relay, catch-up, and client library which may be extended by the ACDS Databus API. The ACDS Databus API may leverage the primary Databus to include a core API by extending the source fetcher API 1902, change data stream APIs 1904, and consumer APIs 1906, according to one embodiment.

FIG. 19B is a source fetcher API view 1950B illustrating the source fetcher API 1902 which may leverage the ACDS Databus API. The source fetcher API 1902 may be configured based on the data source (e.g., coordinates, credentials, etc.). The source fetcher API 1902 may have state management through the upstream checkpoint. The source fetcher API 1902 may include control API, such as start/shutdown, pause/resume, and get status. The source fetcher API 1902 extensions may include dynamic (re)configuration, downstream policy union predicate push-down, and transaction stream API, according to one embodiment.

Predicate pushdown may allow predicating the source only to filter a specific event. For example, the source fetcher API 1902 may filter events only for the account in user account table. Evaluating the predicate may cause it to put it closer to the source, making it more efficient, according to one embodiment.

FIG. 19C is a data stream API view 1950C illustrating the data stream API of the ACDS. The data stream API of the ACDS may include Dbus event buffer. Dbus event. Dbus event iterator and Databus extensions. The data bus may come with some data stream API or kind of what flows on the bus. The central concept of the Dbus event buffer is that it may store the changed data and allow the downstream consumer application 308 to read that data. The Dbus event buffer may be a container for Databus events. The Dbus event may be a physical event in the Dbus event buffer. The Dbus event iterator may iterate over events in the buffer. The data stream API extension may include replication event/replication transaction. The data stream API extension may support for DDL replication. The data stream API policy may be:
Iterator<ReplicationTransaction> [symbol] Iterator<ReplicationTransaction>.

FIG. 19D is an ACDS events view 1950D illustrating the ACDS events of the data stream API. The ACDS event on the bus may represent the rows that have changed in the source database 300. The ACDS events may use row-level replication for data manipulation language. The ACDS event may guarantee that update on the destination database 302 matches the update on the source database 300 and may support for full and partial (updated columns only) row image. The ACDS event may use statement-based replication for DDL. Each changed row/DDL statement may be encoded in an event, according to one embodiment.

The event format may be metadata—database, table, partition, sequence number (SCN), timestamp, optype (UPSERT, DELETE): Key—Schema and Payload (Avro) and value—Schema and Payload (Avro), according to one embodiment.

FIG. 19E is a consumer API view 1950E illustrating the consumer API 1902 of Databus. The ACDS client of the consumer API 1902 may include the Pub/sub API and control API. The control API may authorize start/stop, pause/resume, and provide status and statistics. The consumer callback API may include transaction boundaries, replication event processing, and replication flow, such as checkpointing/rollbacks/errors, according to one embodiment.

Publisher/Subscriber may be a kind of class of API. The client library may know how to interact with the bus which may further know how to control the API to control the consumer application 308 and then use the callback API to implement the plugin, according to one embodiment.

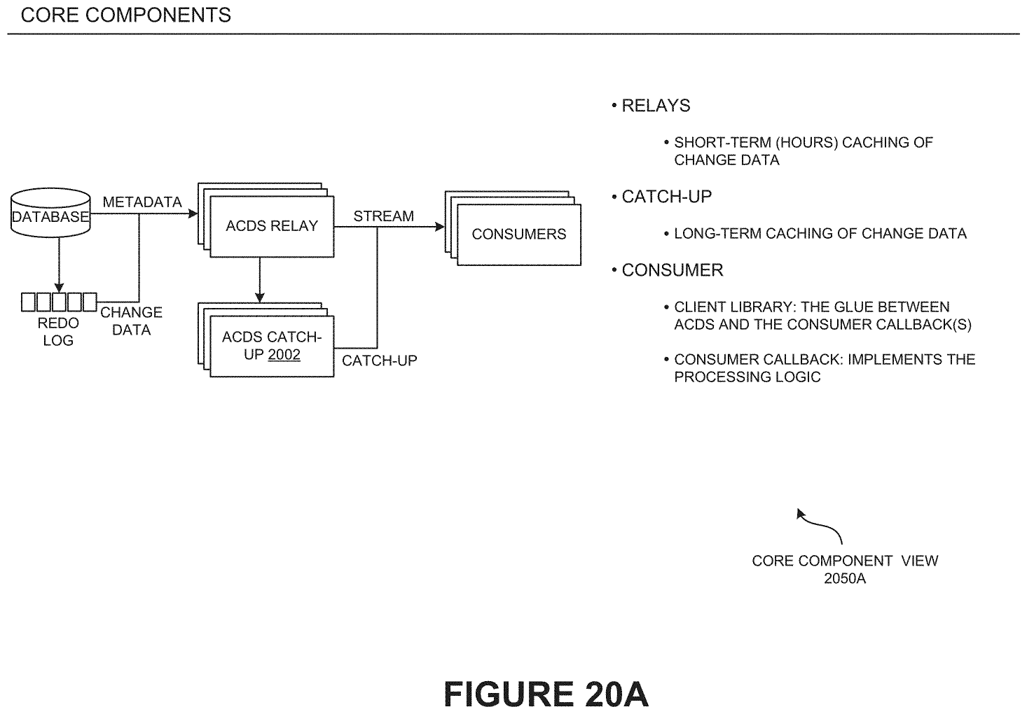

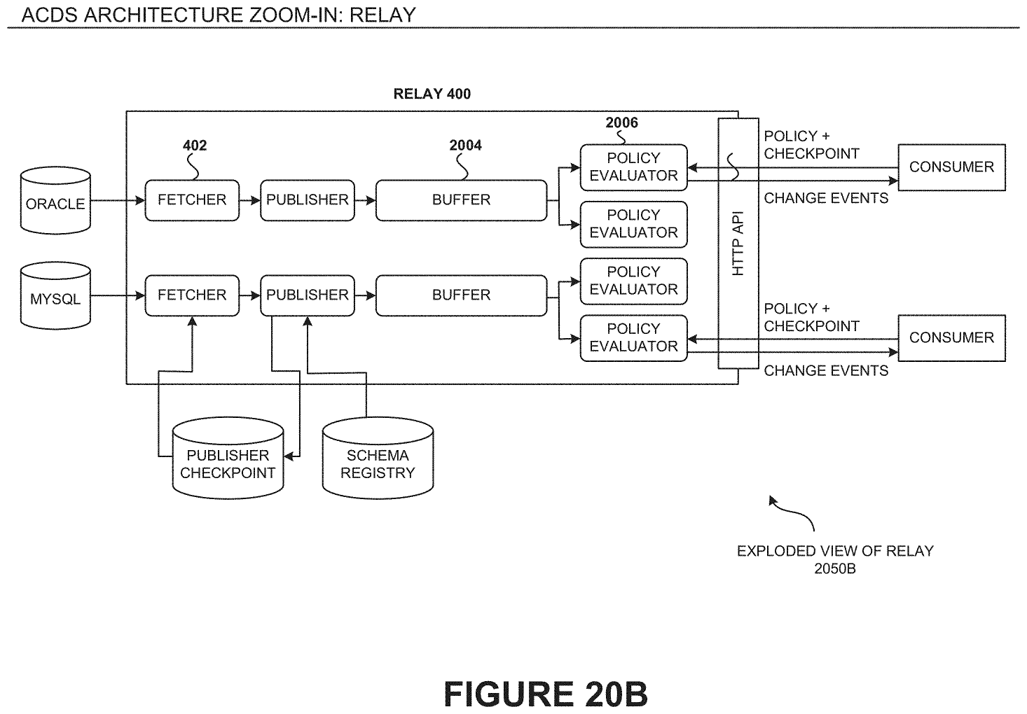

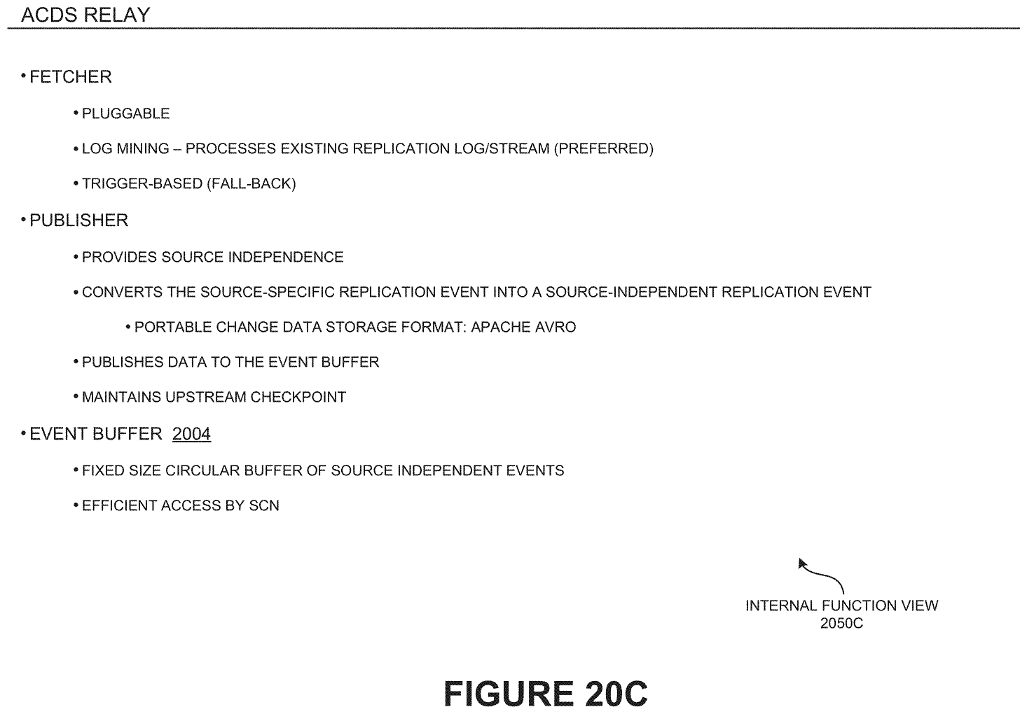

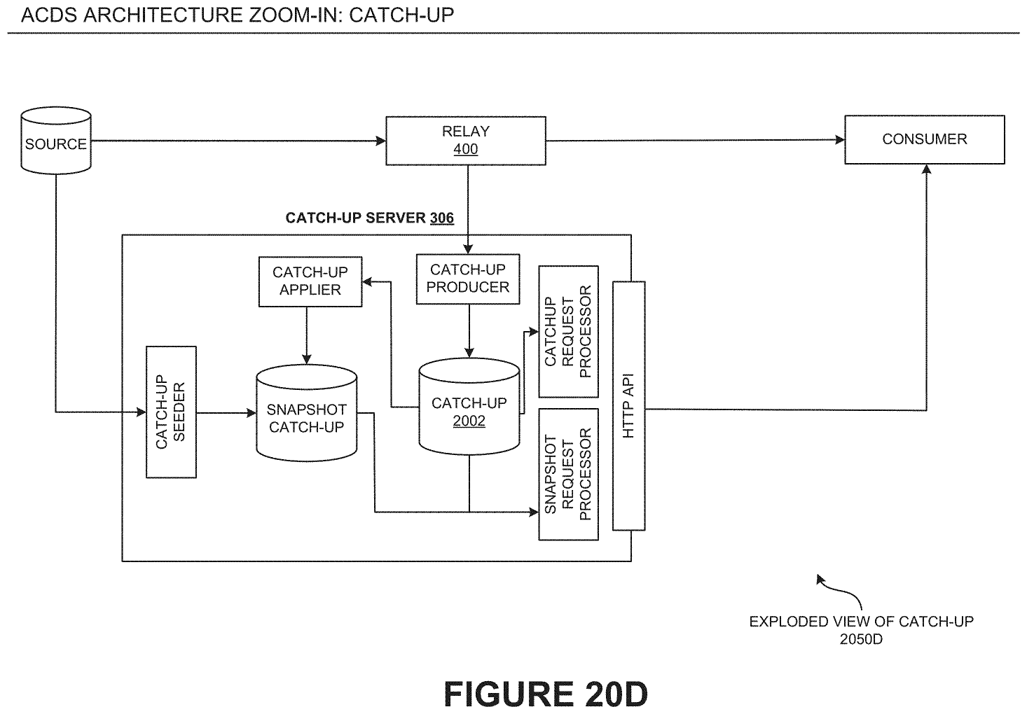

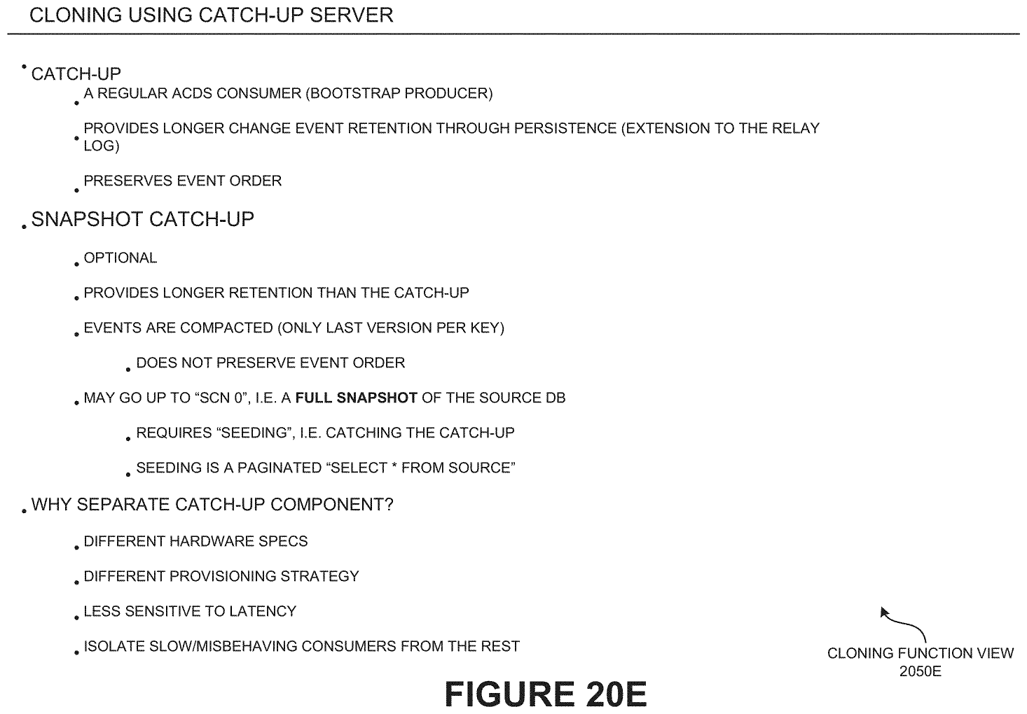

FIG. 20A is a core component view 2050A illustrating the core component of the Databus of the replication bus 206. The core component of Databus may include the relay 400, catch-up 2002, and the consumer application 308. The relay 400 may read the data from Databus. The relay 400 may store the changed data for short term. The catch-up 2002 may store the changed data for long term. The consumer application 308 may include client library and consumer callback. The client library may be used to connect the asynchronous change data system (ACDS) and consumer callback. The consumer callback may implement the processing logic (e.g., using consumer plugin 208B), according to one embodiment.

FIG. 20B is an exploded view of relay 2050B illustrating the exploded view of relay 400 of the asynchronous change data system (ACDS) architecture. The relay 400 may include the fetcher 402, the publisher 404, the buffer 2004, the policy evaluator 2006, the API server 310. The fetcher 402 of relay 400 may extract the data stream from databus (e.g., oracle and/or MySQL etc.). Further, the fetcher 402 may integrate the data extracted from database and transmit it to buffer through the publisher 404. The buffer 2004 may make available the data to consumer application 308 after processing through it policy evaluator. The consumer application 308 may access the data through API server 310, according to one embodiment.

FIG. 20C is an internal function view 2050C describing the internal function of the relay 400 of the asynchronous change data system (ACDS) architecture. The fetcher 402 of relay 400 may be a pluggable fetcher 402. The fetcher 402 of relay 400 may support the log mining to process the existing replication stream. The relay 400 may have a trigger-based fetcher 402. The publisher 404 of relay 400 may provide the source independence. The publisher 404 may convert the source-specific “ReplicationEvent” into a source-independent “ReplicationEvent”. The portable change data storage may be Apache Avro®. The publisher 404 may publish the data to event buffer 2004 of the relay 400. The publisher 404 may maintain upstream checkpoint. The event buffer 2004 may be a fixed size circular buffer of source independent events. The event buffer 2004 may be efficiently accessed by the SCN, according to one embodiment.

FIG. 20D is an exploded view of catch-up 2050D illustrating the exploded view of catch-up of the asynchronous change data system (ACDS) architecture. The catch-up may store the changed data for a long term. The catch-up 2002 may include catch-up, snapshot catch-up, catch-up seeder, catch-up applier, and catch-up producer etc., according to one embodiment.

FIG. 20E is a cloning function view 2050E describing the cloning function of the catch-up server of the asynchronous change data system (ACDS). The catch-up 2002 may be used by a regular ACDS consumer. The catch-up 2002 may provide the longer change event retention through persistence. The catch-up 2002 may preserve the event order. The snapshot catch-up may be an optional step in the cloning using catch-up server 306. The snapshot catch-up may provide longer retention than the catch-up 2002. The events of snapshot catch-up may be compacted that does not preserve the order. The snapshot catch-up may go up to “Scn 0” (i.e., a full snapshot of the source database 300). Based on the hardware specification and provisioning strategy of the system may have separate catch-up 2002 component. The separate catch-up 2002 component may isolate the slow and/or misbehaving consumer applications 308 from the rest, according to one embodiment.

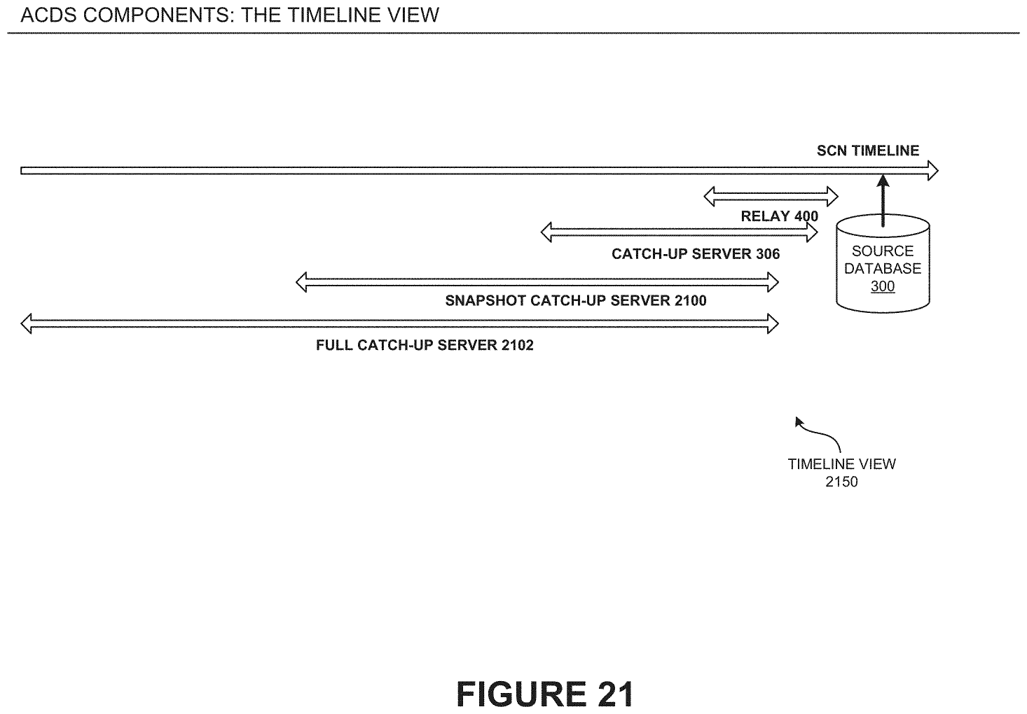

FIG. 21 is a timeline view 2150 illustrating the timeline view of ACDS component. The SCN timeline may be a commit timeline. The commit timeline describes order of changes as they happen in the source database 300. SCN timeline comes from the Oracle® clock as a system change number. It is like a logical clock which tells about all the events in the Oracle® database. Different databases may have different names for that. The commit timeline may have a relay 400 which may be very close to the source database 300 and contain the changed data or changed event course in the timeline to the source database 300. But it may have limited retention since it may store only few things in the memory. Then it may have to catch-up 2002 because it reads the data from the relay 400, but it may have to slack behind the timeline, but because it stores the data on the catch-up server 306, it may have a larger retention. The latency of commit timeline may be how far behind and how far back it may retain the data. It may essentially be cache hierarchy because each of those components are catching portion of the timeline, according to one embodiment.

The snapshot catch-up server 2100 may keep the latest version of data. The snapshot catch-up server 2100 may keep every single change in the database and does not retain the data since the beginning of time. The full catch-up server 2102 may retain data since the beginning of time and may literally be the full copy of the source database 300. If someone doesn't want, it may not go to the source database 300. The ACDS may not use the full catch-up and/or the snapshot catch-up, because those may require computationally-intensive processing of large amounts of data and are being replaced by criteria based clone (CBC), according to one embodiment.

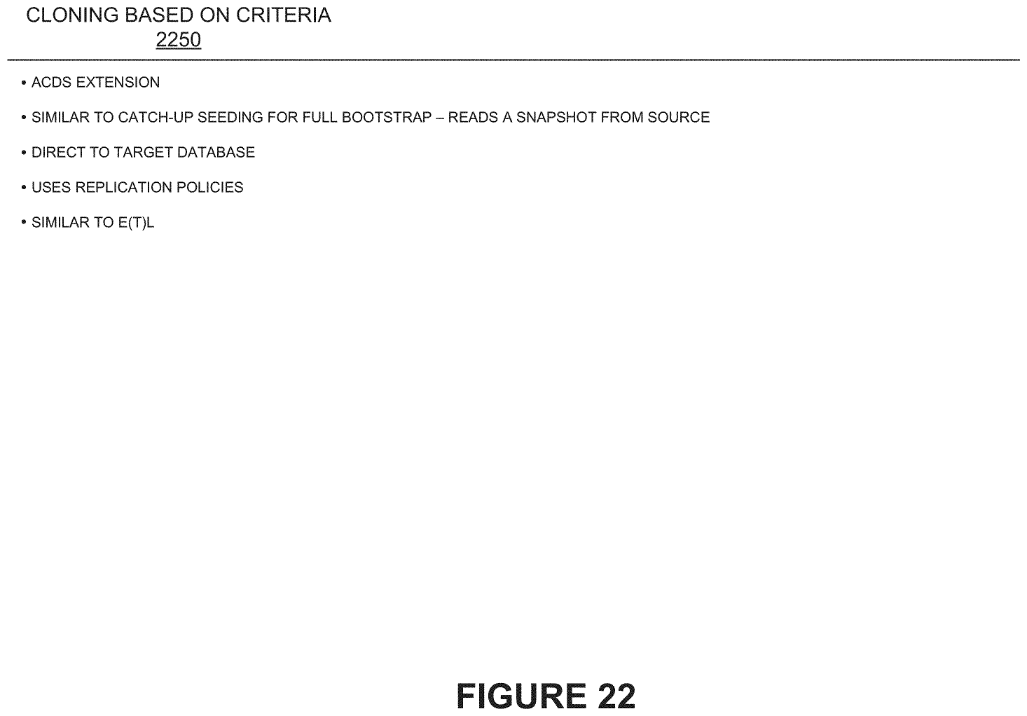

FIG. 22 illustrates the cloning based on criteria 2250. The cloning based on criteria may be an ACDS extension. The cloning based on criteria may be similar to catch-up seeding for full catch-up—and may read a snapshot from source database 300. Cloning based of criteria may allow automatic initiation of change data replication directly to the target database (e.g., destination database 302). Cloning based of criteria may use replication policies 202 to directly replicate data from source to destination database 302. The catch-up server 306 may move the data from the source database 300 to the target database (e.g., destination database 302) much faster. The catch-up server 306 may not use the criteria based clone. The catch-up server 306 may store historic database, which allows consumer applications 308 to read. The basic idea of cloning based of criteria may be that if the consumer application 308 wants to read the data that is about a month old, it typically it allows data to move and/or copy all the data faster and in parallel. The cloning based of criteria may be similar to E(t)L (e.g., extract, transform and load), according to one embodiment.

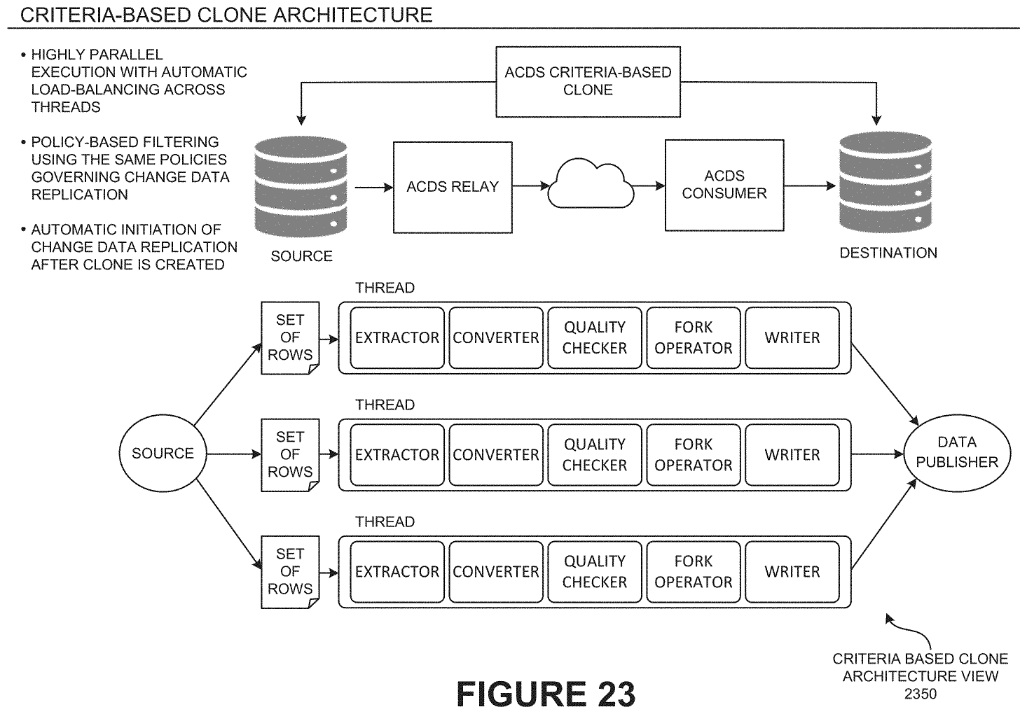

FIG. 23 is a criteria based clone architecture view 2350 illustrating the criteria based clone architecture of the asynchronous change data system (ACDS). The criteria based clone may provide policy-based filtering using the same policies 202 governing the change data replication. The criteria based clone may provide an automatic initiation of change data replication after clone is created. The criteria based clone may be executed in parallel with automatic load-balancing across threads, according to one embodiment. The criteria-based clone may be based on an Apache® 2.0 ETL framework like Apache® Gobblin.

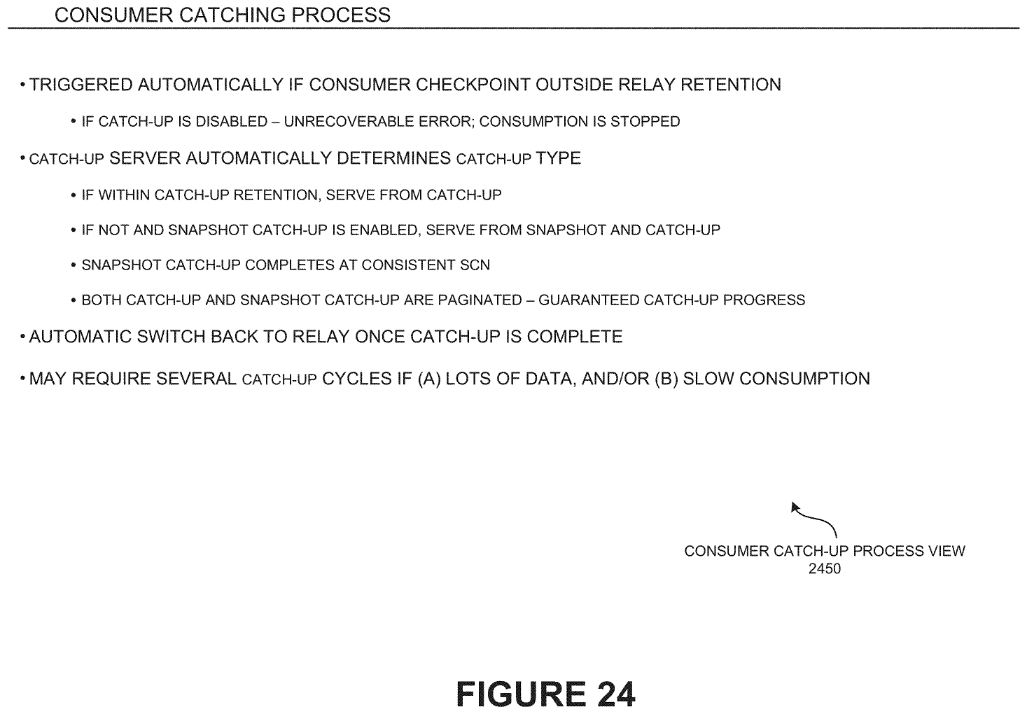

FIG. 24 is a consumer catch-up process view 2450 describing the consumer catch-up process of the consumer application 308. The consumer catch-up process may be automatically triggered if consumer checkpoint is outside relay retention. If the catch-up process is disabled, the unrecoverable error may occur and/or consumption may be stopped. In the consumer catch-up process, the catch-up process may automatically determine catch-up type. If the server gets catch-up within catch-up retention time then it may serve from catch-up 2002. If the server does not get catch-up within catch-up retention time and if snapshot catch-up is enabled, it may serve from snapshot and catch-up. Snapshot catch-up may complete at consistent SCN. The catch-up 2002 and snapshot catch-up may be paginated to provide guaranteed catch-up progress. The consumer catch-up process may automatically switch back to relay 400 once catch-up 2002 is complete. The consumer catch-up process may require several catch-up cycles if there is lots of data and/or slow consumption, according to one embodiment.

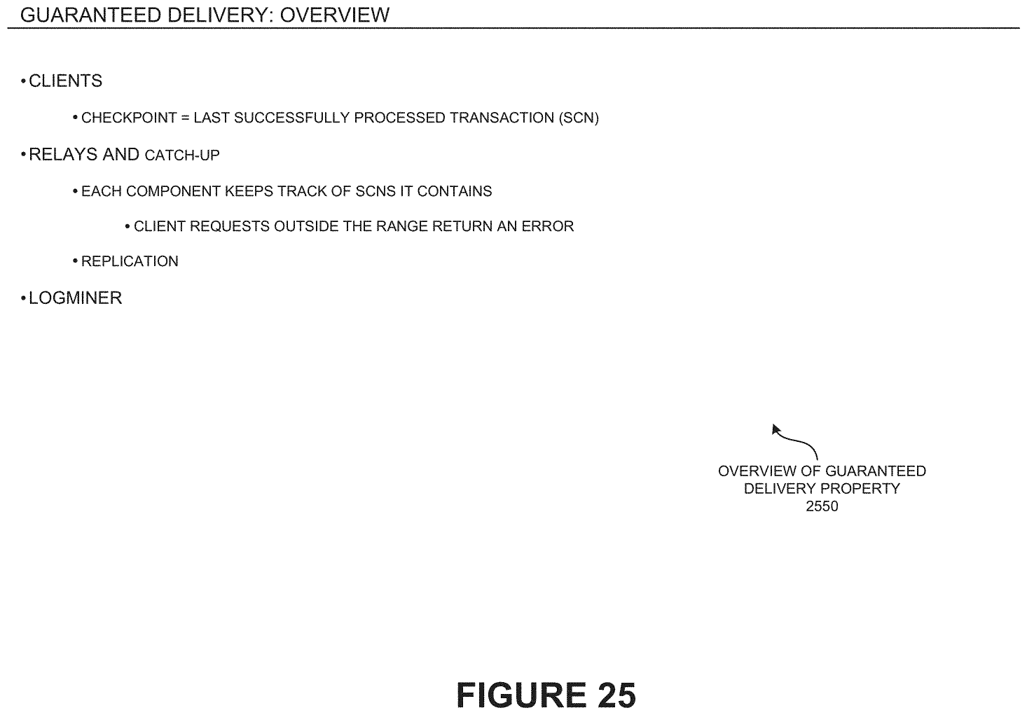

FIG. 25 is an overview of guaranteed delivery property 2550 describing the overview of guaranteed delivery property of the transactional replication bus 206. The transactional replication bus 206 may deliver the each change of SCN timeline to the client at checkpoint (e.g., determined by the last consumed transaction in that the commit timeline). Each component (i.e., relays 400 and catch-up 2002 etc.) may keep track of contained SCNs and replicate the data to deliver it to the consumer application 308. The log miner of the asynchronous change data system (ACDS) may enable the consumer application 308 to archive the redo log files through an interface, according to one embodiment.

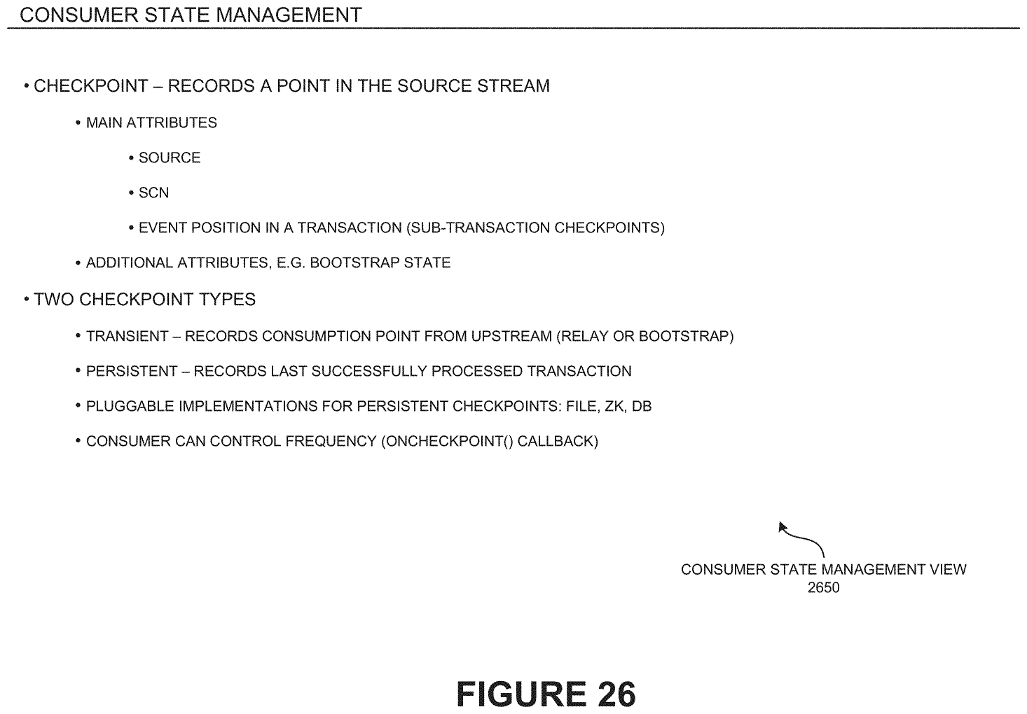

FIG. 26 is a consumer state management view 2650 describing the consumer state management of the asynchronous change data system (ACDS). The consumer state management may be done automatically through the client library. The checkpoint may record a point in the source stream. The main attributes of the checkpoint may include the source, the SCN and the event position in the transaction (e.g., sub-transaction checkpoints etc.). The checkpoint may have additional attributes (e.g., catch-up state). There may have two types of checkpoints (i.e., transient checkpoint and persistent checkpoint). The transient checkpoint may record a consumption point from the upstream (i.e., relay 400 and catch-up 2002). The persistent checkpoint may record a last successful processed transaction. There may have pluggable implementations for persistent checkpoints (e.g., file, ZK—Apache® ZooKeeper, DB), according to one embodiment.

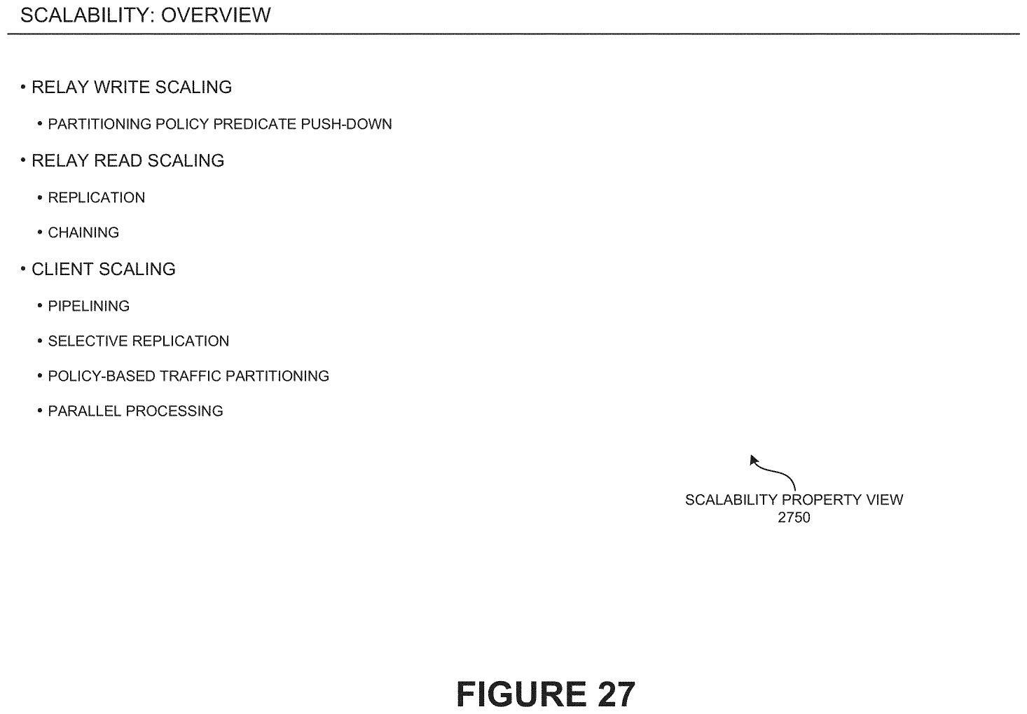

FIG. 27 is a scalability property view 2750 describing the overview of scalability property of the transactional replication bus 206.

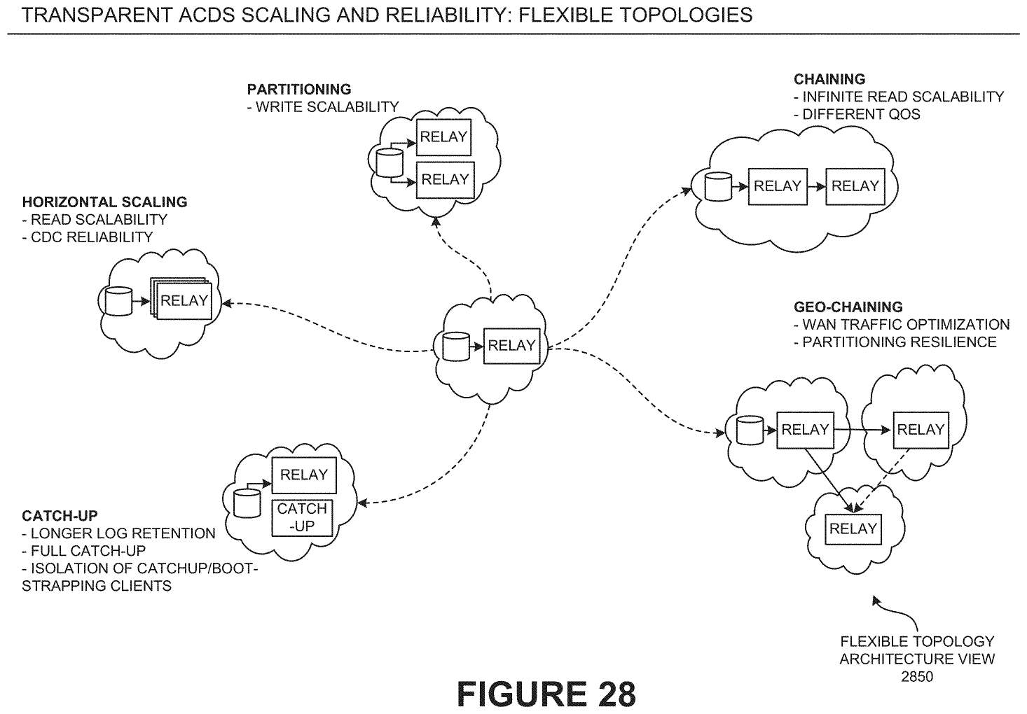

FIG. 28 is a flexible topology architecture view 2850 illustrating the flexibility of the ACDS architecture. It may start with a simple model where it may have a single source ACDS and a single relay 400. It may start from simplest deployment. It may have a single source ACDS and a single relay 400 instance which can read from that. It may have horizontal scaling, which is, it may add more relays 400 to support more consumer applications 308 to achieve high availability (HA) for other relay 400 instances. The flexible database architecture may allow partitioning of the data stream. Hence, in a single stream, one part of string may consume one part of data while another string may consume another part of data by partitioning of the data stream, according to one embodiment.

Chaining may allow infinite (e.g., up to the hardware limits of the underlying computing infrastructure) read scalability of ACDS across the network. The chaining may be a variation of geo chaining wherein it may chain the relays 400 in different geographies. It may improve latency by using the relay 400. Geographic chaining may allow consumer application 308 to access the relay 400 in the cloud of same region and improve latency. The last part catch-up 2002 may have two paths, one may be for the fast path for online path in memory and the other may be slower path for all the data that goes through the catch-up 2002, according to one embodiment.

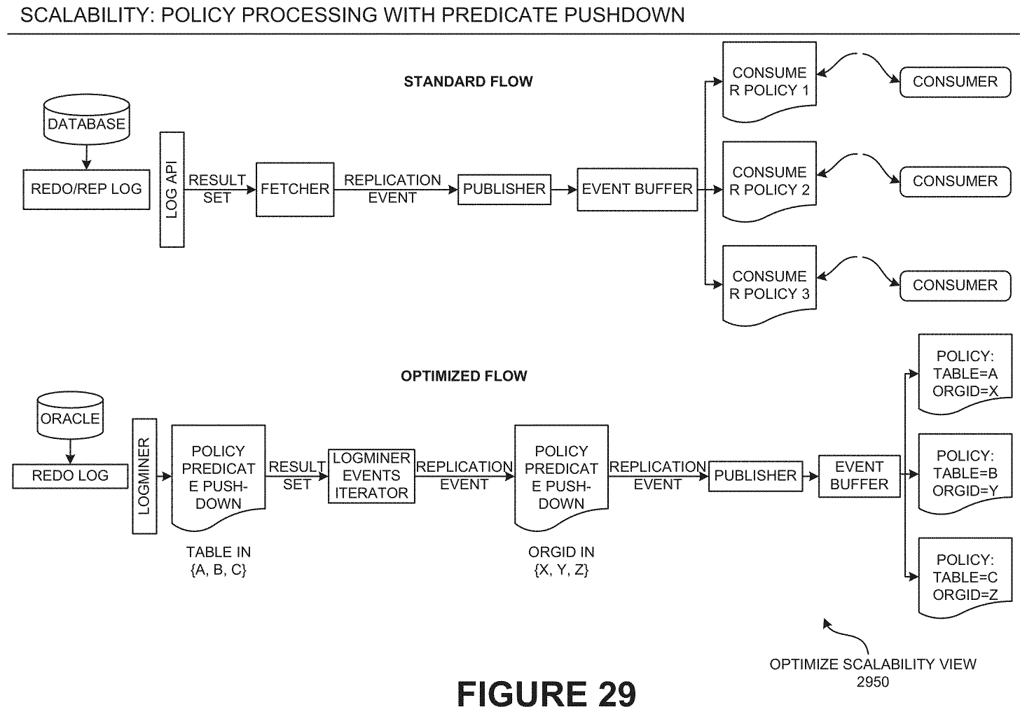

FIG. 29 is an optimize scalability view 2950 illustrating the policy processing with predicate pushdown. The figure shows a typical model that does not have a predicate pushdown. The typical model may have a number of consumer applications 308 and each of the consumer applications 308 may have its own policy 202 to replicate the data. An optimized dataflow model may have a policy 202 that is a union of all the consumer policies 202 that may evaluate earlier using a policy 202 predicate push-down depending on the kind of capabilities the fetcher 402 has. The fetcher 402 may do filtering on the table and if the fetcher 402 does not have the capabilities to filter in the table, then it may evaluate before the publisher layer, according to one embodiment.

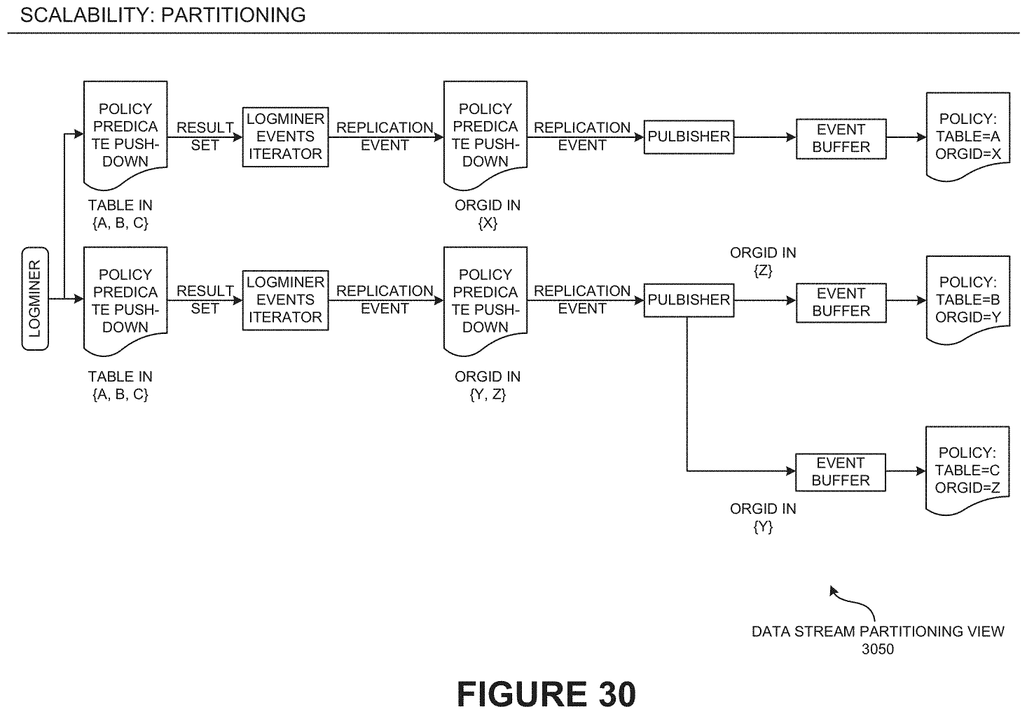

FIG. 30 is a data stream partitioning view 3050 illustrating how the partitioning of data stream is done. Partitioning may be located inside the relay 400. Partitioning may be written to the different buffers. There may be some kind of natural serializing of the processing inside the single pipeline, but partitioning may create independent pipeline to essentially parallelize the processing, according to one embodiment.

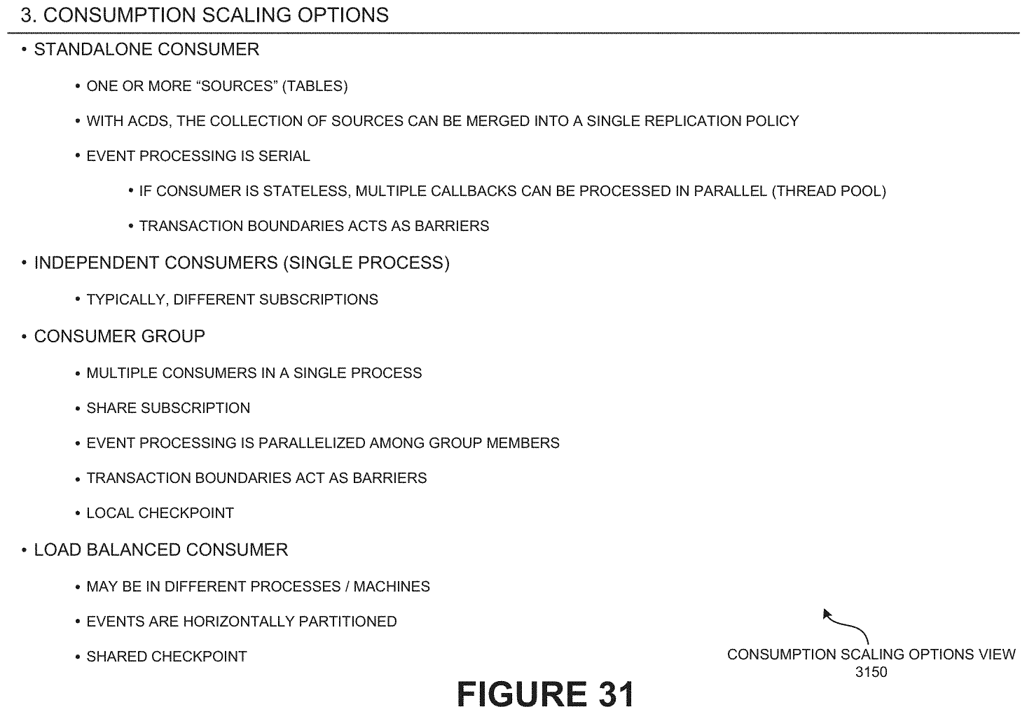

FIG. 31 is a consumption scaling options view 3150 describing the consumption scaling options of ACDS. The consumption scaling options of ACDS may include standalone consumer, independent consumers (e.g., single process), consumer group, and/or a load balanced consumer. The standalone consumer may have one or more sources (e.g., tables). With ACDS, the collection of sources may be merged into a single replication policy for standalone consumer. The event processing may be serial if consumer is stateless, multiple callbacks can be processed in parallel (e.g., a thread pool). The transaction boundaries may act as barriers for a standalone consumer. For independent consumers, the consumption scaling options may typically be different subscriptions. The consumption scaling options for a consumer group may be multiple consumers in a single process, shared subscription, event processing may be parallelized among group members, transaction boundaries may act as barriers and may have local checkpoint. The consumption scaling options for a load balanced consumer may be in different processes/machines, events may be horizontally partitioned, and may have shared checkpoint, according to one embodiment.

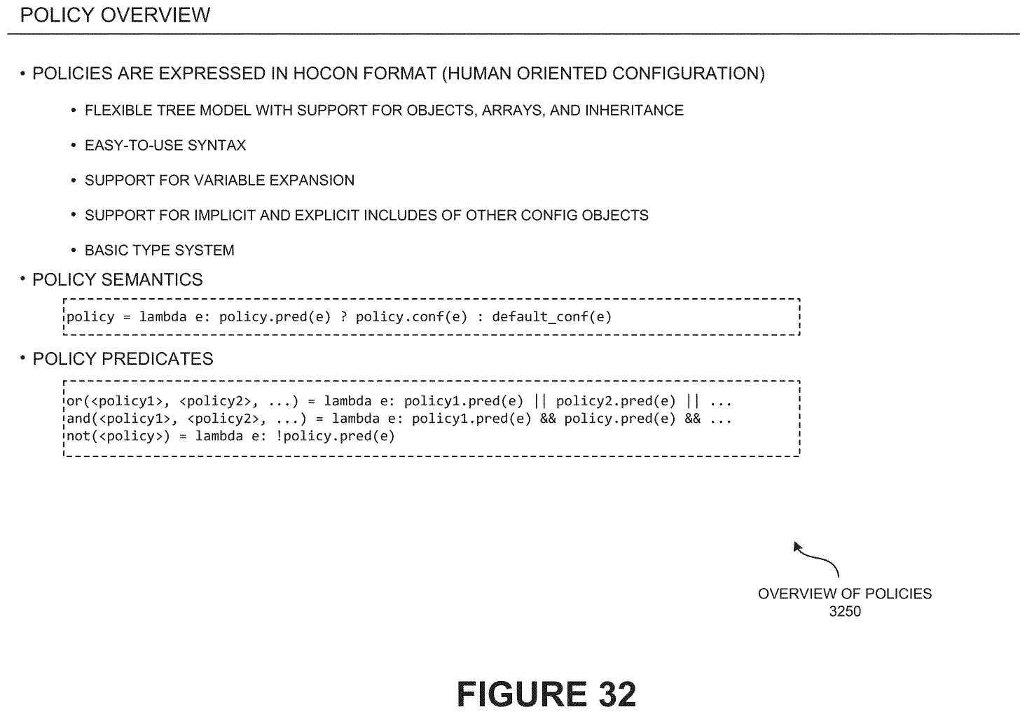

FIG. 32 is an overview of the policies 3250 describing the overview of the policies 202 of the asynchronous change data system (ACDS). The policies 202 may be a combination of predicate and transformation. The policies 202 of the asynchronous change data system (ACDS) may be expressed in the HOCON (Human-Optimized Object Configuration Notation) format. The policies 202 may have flexible tree model to support objects, arrays, and inheritance. The policies 202 may have easy-to-use syntax. The policies 202 may support variable expansion. The policies 202 may support implicit and explicit including other configured objects, according to one embodiment.

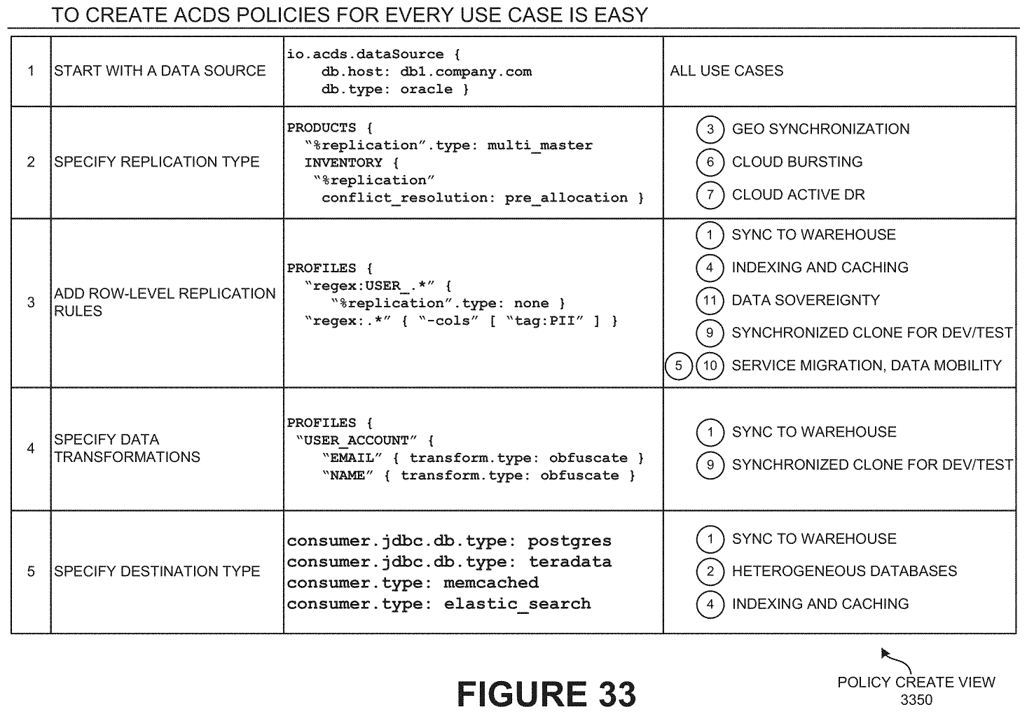

FIG. 33 is a policy create view 3350 describing the steps involved to create policies 202 for every use case. The steps to create policies 202 may include start with a data source (e.g., source database 300), specify replication policy, add row-level replication rules, specify data transformation, and specify destination type, according to one embodiment.

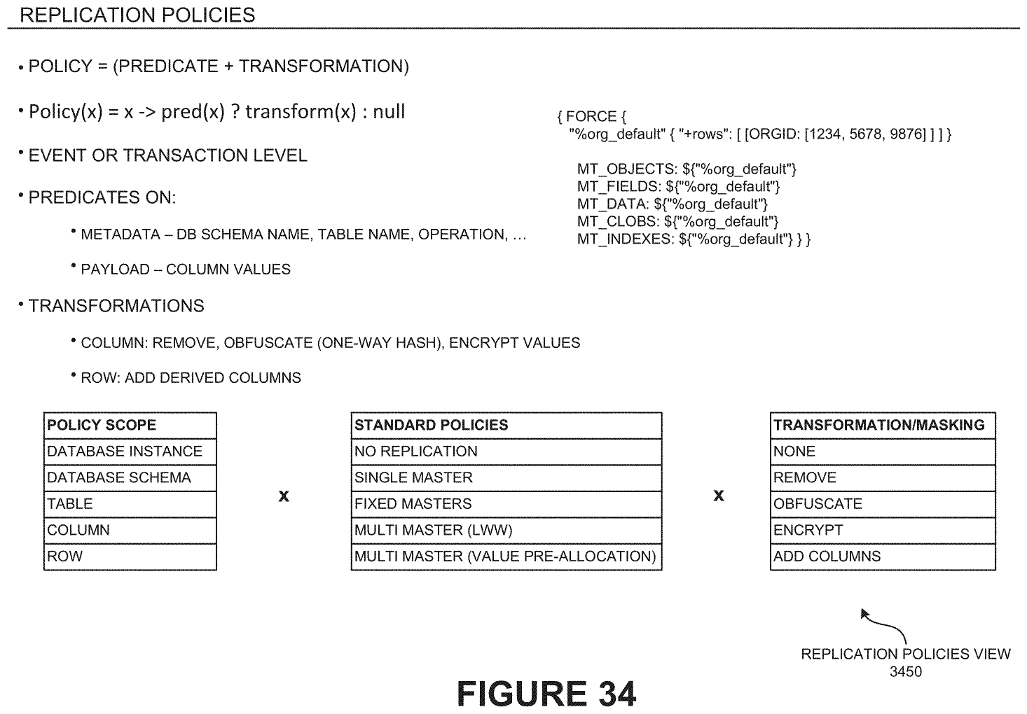

FIG. 34 is a replication policies view 3450 describing the replication policies of the asynchronous change data system (ACDS). The policies 202 may be combination of predicate and transformation. The policy scope may include database instance, database schema, table, column and row. The standard policies 202 may include single and/or fixed masters. The standard policies may include multi master for last writers wins (LLW) and value pre-allocation. The standard policies may not include replication of data. The transformation/masking may include removal of column, obfuscation of column, encryption of column and addition of column, according to one embodiment.

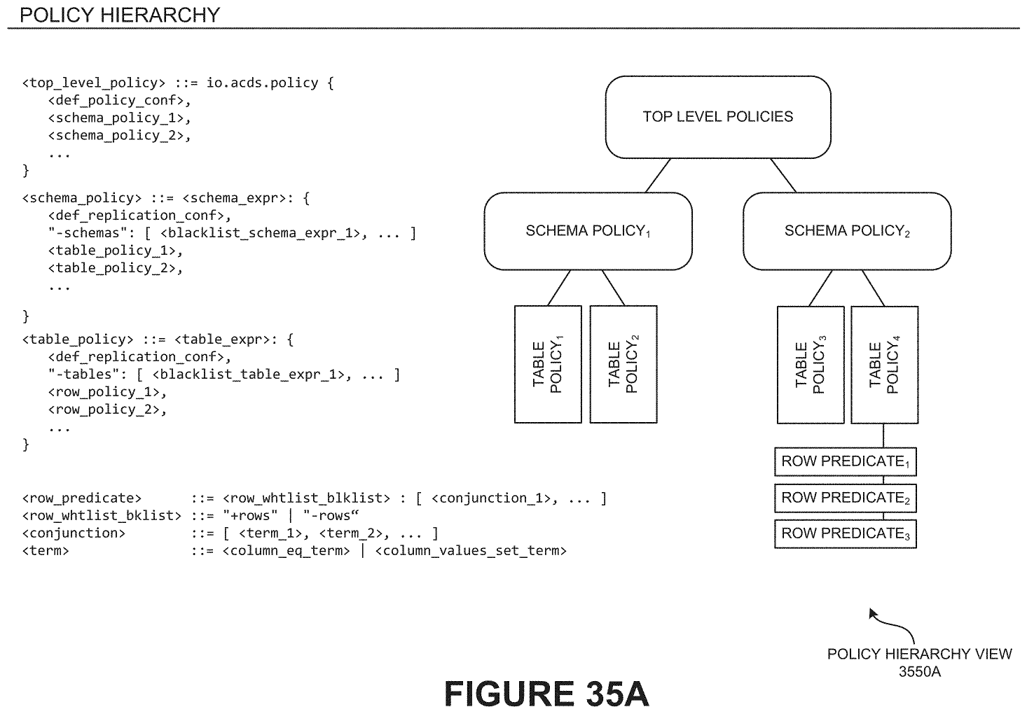

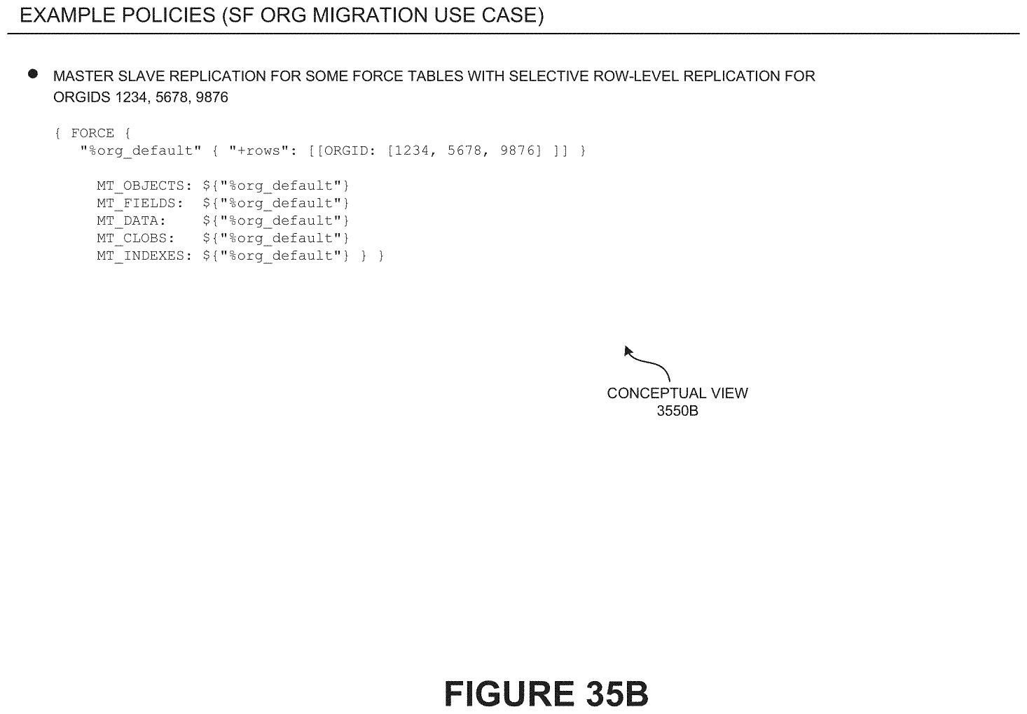

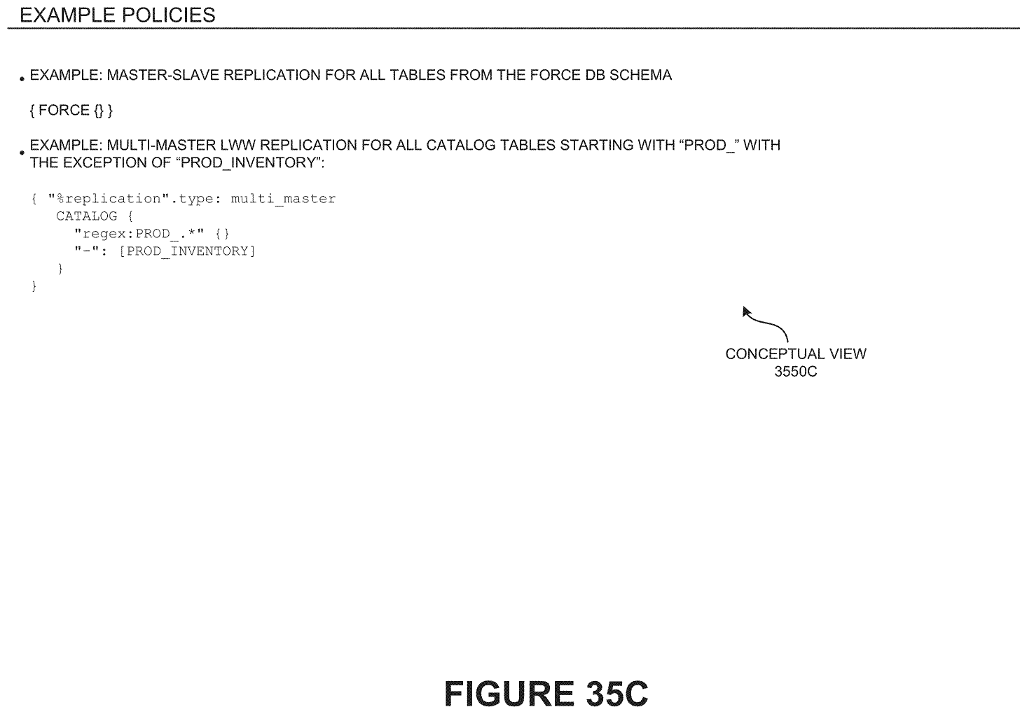

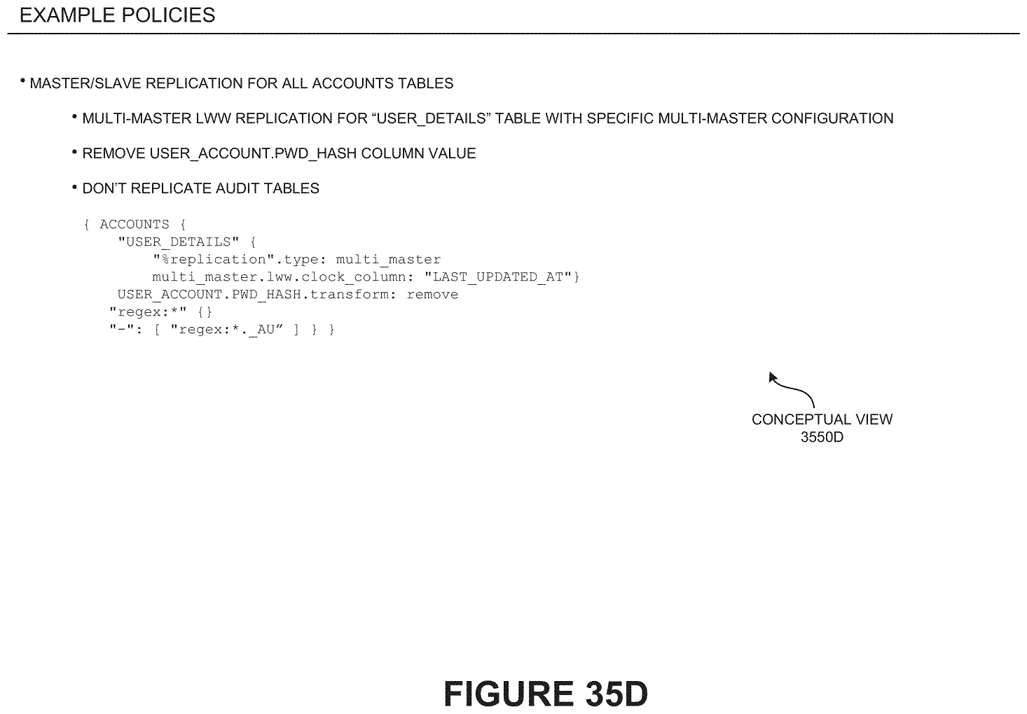

FIG. 35A is a policy hierarchy view 3550A describing the policy hierarchy of the asynchronous change data system (ACDS), according to one embodiment.

FIG. 35B-35D is a conceptual view 3550B-3350D describing the examples of policies 202 of the asynchronous change data system (ACDS), according to one embodiment.

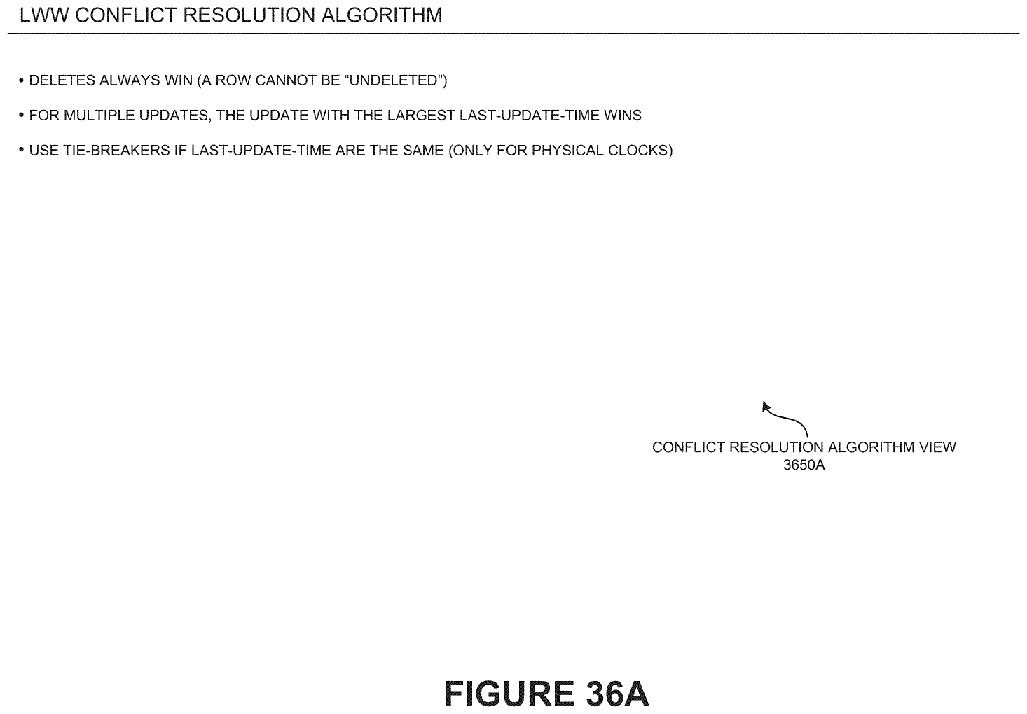

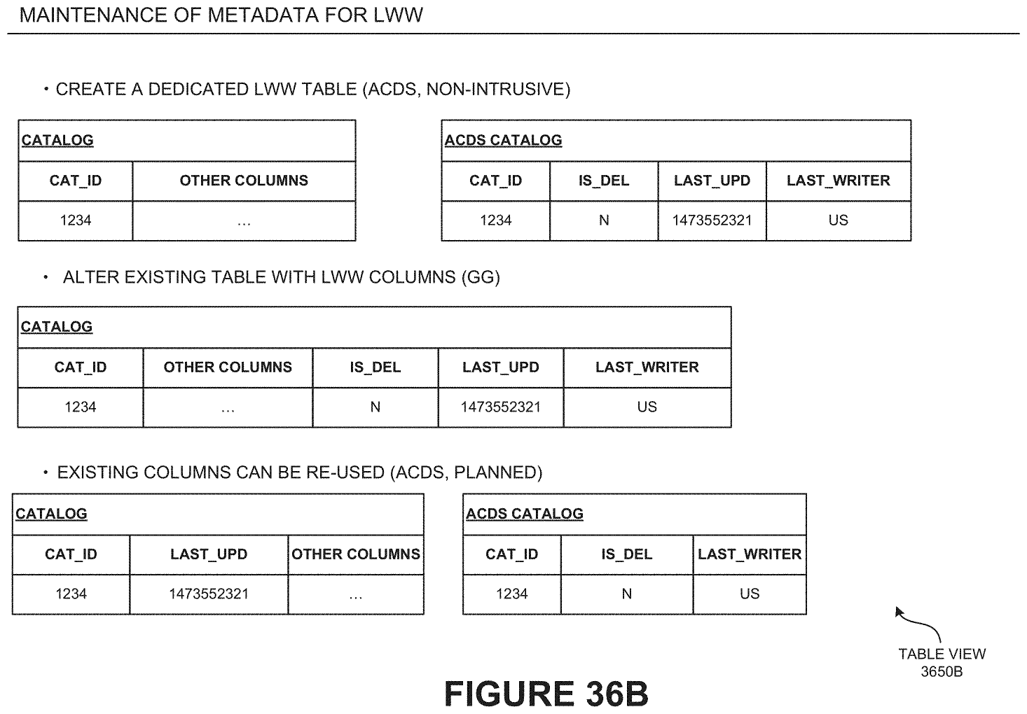

FIG. 36A is a conflict resolution algorithm view 3650A describing the last-writer-wins (LWW) conflict resolution algorithm. The last-writer-wins may be specific to multi master application. The last-writer-wins may write the data in independent database instances. Writing the data in independent database instances may raise conflict if same row is updated at same time in different instances. The policy 202 may allow resolving those conflicts. The implementation of last-writers-wins policies 202 may resolve the conflicts without changing the structure of schema, according to one embodiment.

FIG. 36B is a table view 3650B describing the maintenance of metadata of the last writers wins.

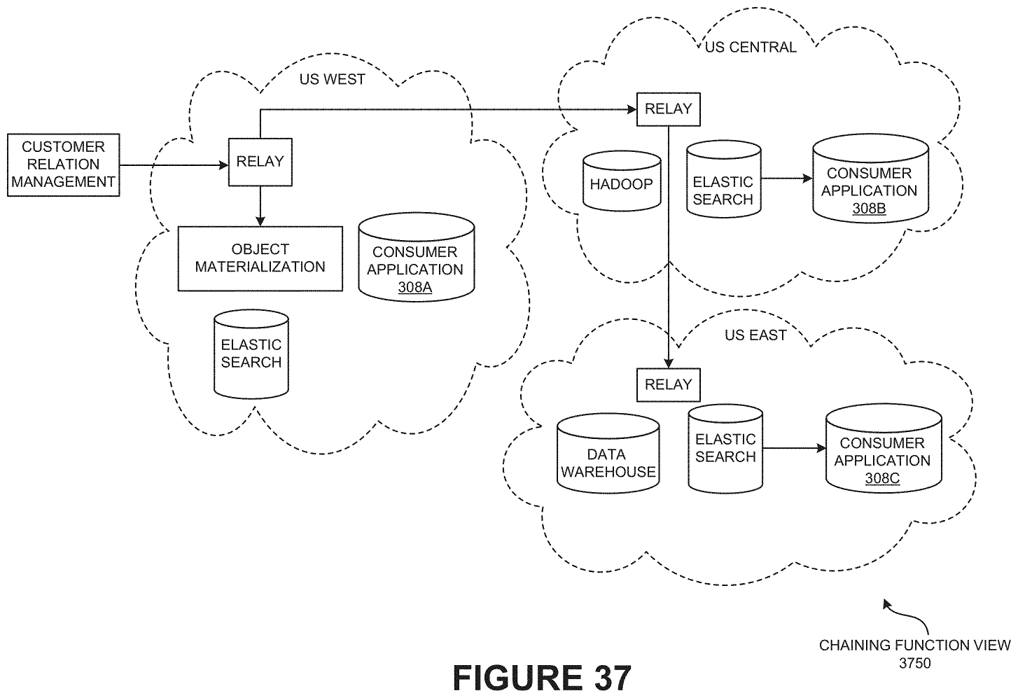

FIG. 37 is a chaining function view 3750 illustrating the example embodiment of chaining function of the asynchronous change data system (ACDS). FIG. 37 illustrates an example embodiment showing US west, US central and US east in the distributed geographical area. The US west cloud network may further include customer relationship management server (CRM), relay 400, object materializer and Elasticsearch®. US central cloud network may further include relay 400, Hadoop and Elasticsearch®. The US east cloud network may further include relay 400, Elasticsearch® and data warehouse, according to one embodiment.

The relay 400 of US west cloud network may capture all the data from the source database 300. The CRM of the US west cloud network may catch data from database and make required changes. The relay 400 may capture the changes done in the CRM. The relay 400 may send the data to the object materializer (e.g., using object materialization 708) to create the customer object (e.g., product object 902). The object materializer 708 may write the object on elastic search, according to one embodiment.

The US west cloud network, the US central cloud network and the US east cloud network may have Elasticsearch® to aggregate the collected information for customer (e.g., consumer application 308) in a single document. The Elasticsearch® may enable customer to find the information. Hadoop may be an open-source software framework for storing and processing large data sets. Hadoop may facilitate machine learning. US East cloud network may have a data warehouse System for business analysis.

For this example embodiment, the user (e.g., consumer application 308) may not need to send data individually to each consumer. The relay of one consumer may replicate the data to the relay 400 of the subscribed consumer. The relay 400 of US west cloud network may replicate the data to the relay 400 of the US central cloud network. The relay 400 of US central cloud network may replicate the data to the US east cloud network. Thus the relay 400 of subscribed consumer may receive separate copy of database. Each of the consumers may have replication policy 202 that may not have PII. The policies 202 of the consumer application 308 may be applied on the data received by the relay 400. The consumer application 308 may process the application of policies 202 on the received data, according to one embodiment.

This disclosure presents a method and system to deliver a platform for data synchronization and integration across an enterprise and/or cloud. This disclosure presents an asynchronous change data system (ACDS). The asynchronous change data system (ACDS) of the present disclosure offers a timeline consistent distributed data synchronization bus across a range of source and target data systems. The asynchronous change data system (ACDS) of the present disclosure may provide a flexible shared-nothing architecture with strong consistency to allow building highly available and scalable deployments. The asynchronous change data system (ACDS) of the present disclosure may allow the distributed data synchronization bus to be scaled to achieve throughput of hundreds of thousands of events and hundreds of megabytes per second in both its relay and consumer tiers.

According to one embodiment, the asynchronous change data system (ACDS) of the current disclosure provides:

1. A Source-independent transactional bus optimized for change data based replication

2. A Policy engine for selective replication, on-the-fly data transformation and conflict resolution

3. A Pluggable architecture to extend support for data sources, consumers, and policies

4. A set of tools and web-based UI to simplify the management of ACDS in a geo distributed environment.

The asynchronous change data system (ACDS) of the current disclosure may have scalability of a distributed data synchronization bus. There may be multiple dimensions to scalability. One dimension may be how fast each individual component can read and process the event stream. Another important aspect of scalability may be how to scale the system beyond a single component. The real-time replication path from the source database through the ACDS may relay to the consumers. Furthermore, the relay tier may have an inbound throughput aspect (e.g., how quickly it can read from the upstream database) and an outbound throughput aspect (e.g., how quickly it can serve the consumers).

The real-time path of the asynchronous change data system (ACDS) of the current disclosure may consist of the following systems:
Source database whose changes are captured and published to the ACDS data synchronization bus
Relay that is responsible for capturing the changes from the source database and publishing them to the bus
Consumers that subscribe to the change stream for a specific database.

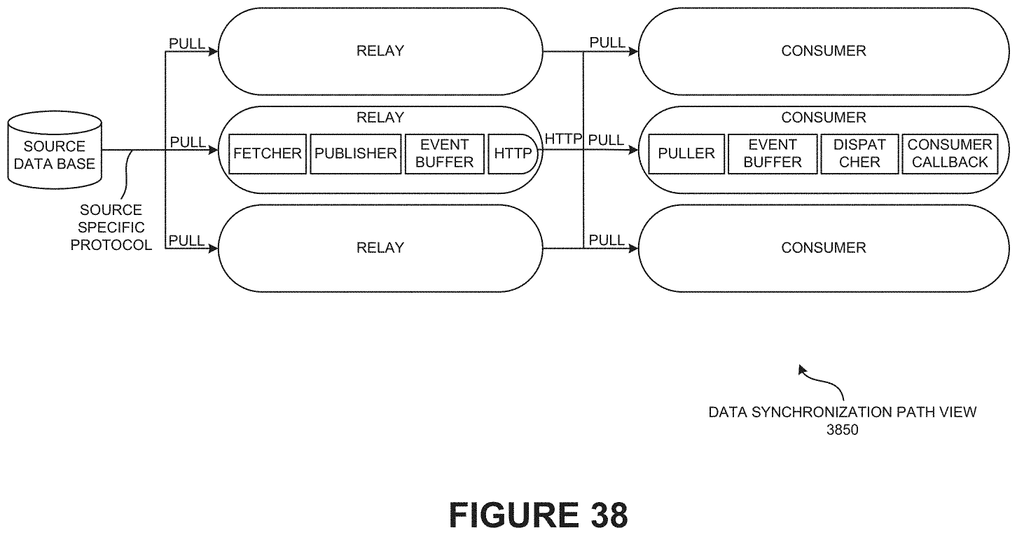

FIG. 38 is a data synchronization path view 3850 illustrating the ACDS real-time data synchronization path, according to one embodiment.

In another embodiment, the relay fetcher may pull the change data using a source-dependent protocol. For example, this is JDBC for Oracle (using the LogMiner fetcher), or GoldenGate Java exit for multiple databases including Oracle, or the binlog protocol for MySQL and MariaDB. The database change events may be converted into source-independent ACDS replication events and replication policies may be applied to these events. The events are then published transactionally by the relay Publisher to the relay Event Buffer where they are available for consumption by downstream subscribers, the ACDS consumers.

The ACDS consumers may continuously pull replication events from the relay over HTTP protocol. The consumer Puller may store those events in a consumer Event Buffer while there is free space in the buffer. The consumer Dispatcher may asynchronously pull events from the event buffer and pass them to the Consumer Callback for processing. Once the consumer callback processes all events in a transaction, those events may be removed from the event buffer to free up space for the Puller to fetch more events from the relay, according to one embodiment.

The entire real-time data synchronization path may form an asynchronous multi-staged processing pipeline designed for high throughput and low latency.

Present disclosure may employ replication and partitioning to further improve scalability:
Relay instances may be replicated so that they can support more consumers
Relay instances may be partitioned (through fetcher policies) so that each instance processes a portion of the incoming database traffic. On aggregate, the partitioned relays may process higher volumes of incoming data.
Like the relays, the consumer instances may be partitioned so that each consumer may process only a portion of the replication events stream.

The performance configurations may employ all the above techniques to maximize throughput for the lowest latency.

In yet another embodiment, particular innovative features of present disclosure may include:

ENVIRONMENT AND WORKLOAD: Present disclosure offers a method to measure the effective throughput of change-data-capture events through ACDS in various stages of the pipeline across a number of different hardware configurations.

ENVIRONMENT: All of the tests performed have been conducted in the cloud, on Google Compute Engine, by provisioning a number of VMs to host the services used by ACDS. During these tests, same test have been performed across a number of machine-types to show how ACDS takes advantage of increased capacity on the same VM. The machine-types used are the following:

Machine Type and Description:

N1-standard-2 Standard machine type with 2 virtual CPUs and 7.5 GB of memory.

N1-standard-4 Standard machine type with 4 virtual CPUs and 15 GB of memory.

N1-standard-8 Standard machine type with 8 virtual CPUs and 30 GB of memory.

The VM instances have been configured with SSD and they are running Linux Ubuntu Xenial 16.04. To ensure minimal network latency, each of the VM instances have been provisioned in the same region and availability zone, according to one embodiment.

WORKLOAD: For each of the tests conducted, a source database may be configured and a workload of database transactions may be created that will generate redo events for ACDS to mine as part of replication, according to one embodiment.

For the purposes of this test, MySQL 5.7 may be chosen as the source database. The load may consist of 4,800,000 record updates to the database with no replication active at the time, such that the entire load will be available once the test is started. In MySQL, we use binlog as the source of change-data events, according to one embodiment.

The content of the change data may consist of 3 tables, with the size of each record in the table about 1100 bytes. As the load is generated, each of the columns are filled with random data. The load is evenly spread amongst the 3 tables.

MySQL may run on its own machine on a 16-CPU VM to ensure it can handle the load.

METHODOLOGY: A typical ACDS pipeline consists of the following:

1) A source database

2) One or more relays

3) One or more consumers

4) A target destination (DB, KV store. FS, etc.)

In one more example embodiment, the following diagram illustrates the various stages in a simple ACDS pipeline. Due to the flexible topology inherent in ACDS, more advanced configurations are possible through chaining, but for this test, the following flow was used.

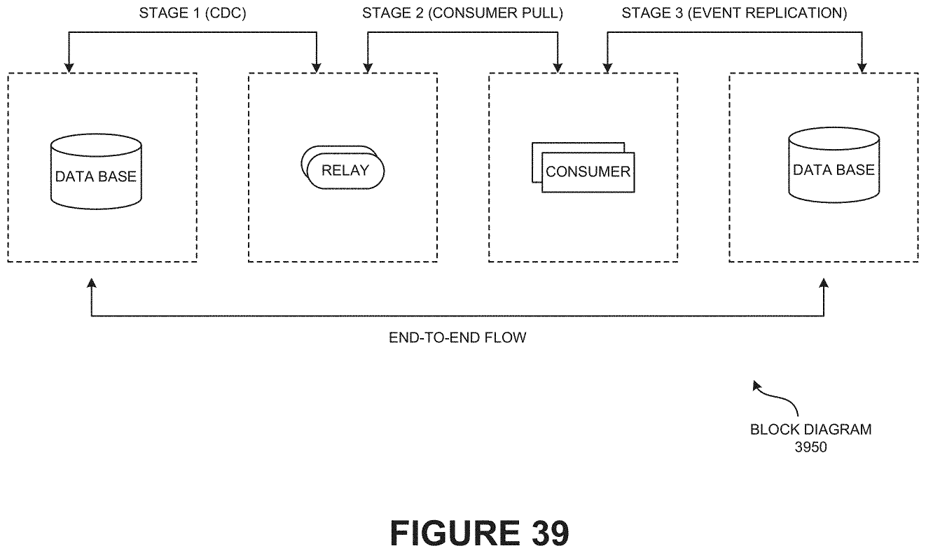

FIG. 39 is a block diagram 3950 illustrating the performance methodology to measure the performance of ACDS, according to one embodiment.

In the testing, stage 1, stage 2, and end-to-end throughput were measured. The final stage has been mocked out in this test. Even without that final stage, we can accurately measure the performance of ACDS as change-data flows through it.

Scalability: Measuring Stage 1 Performance (MySQL Binlog to Relay)

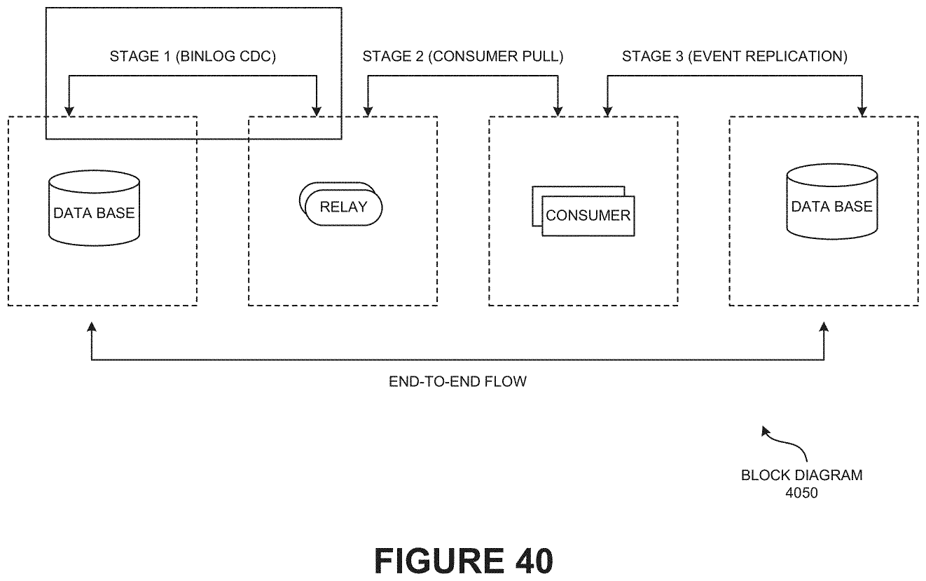

FIG. 40 is a block diagram 4050 illustrating the measuring of stage 1 performance across a number of different configurations, according to one embodiment.

In order to measure stage 1 performance, a load generator may be used that creates a number of database updates that in turn generates replication log entries. While this load generation occurs, neither the ACDS relay components nor the ACDS consumer components may run. Once the load generation is complete, the Relay(s) are started up and they begin mining change data events from the replication log via MySQL binlog, and timing measurements are written through logging to capture the beginning timestamp and the ending timestamp for the load. In this case, since the consumer is not running, the data will stop flowing at the end of stage 1, according to one embodiment.

The following table lists the measured performance across a number of different configurations.

TABLE 1
VM Configurations and Results from Stage 1:

| Instance Type | VM [symbol] | Relay | Load | record size | CPU load | vCPUs | duration | rate ev/s | rate Mbit/s |
|---|---|---|---|---|---|---|---|---|---|
| n1-standard-2 | 1 | single relay | 4,800,000 | 1100 | 0.90 | 1. [symbol] 0 | 15 [symbol] .10 | 30,750 | 338 |
| | | 2-cpu | | | | | | | |
| n1-standard-4 | 1 | single relay | 4,800,000 | 1100 | 0.78 | 3.10 | 112.78 | 42,560 | 468 |
| | | 4-cpu | | | | | | | |
| n1-standard-8 | 1 | single relay | 4,800,000 | 1100 | 0.52 | 4. [symbol] 7 | 62.10 | 77,295 | 850 |
| | | 8-cpu | | | | | | | |
| n1-standard-8 x 2 | 2 | 2 relays | 4,800,000 | 1100 | 0.56 | [symbol] | 42.44 | 113,114 | 1,244 |
| | | 8-cpu | | | | | | | |
| n1-standard-8 x 3 | 3 | 3 relays | 4,800,000 | 1100 | 0.55 | 13.15 | 29.20 | 1 [symbol] 4, [symbol] 67 | 1, [symbol] 8 |
| | | 8-cpu | | | | | | | |

[symbol]

indicates data missing or illegible when filed

The first 3 entries in this table show throughput scaling vertically on the same VM instance as the number of CPUs are increased. In the 4th entry, scaling horizontally by adding a second relay on another VM instance is done. In this case, the 4,800,000 records in the load are distributed to the 2 relays via our policy filtering mechanism. In this example, the incoming change data events may be filtered such that separate tables are handled by separate relays. The CPU measurements and rates are aggregated across the two instances. Similarly, in the final entry in the table the load across 3 relays is distributed resulting in 164,367 events per second and a data throughput rate of 1.8 Gbps. Additional gains may be realized by further partitioning the load and adding more relays. The following graphs depict the resulting data, according to one embodiment.

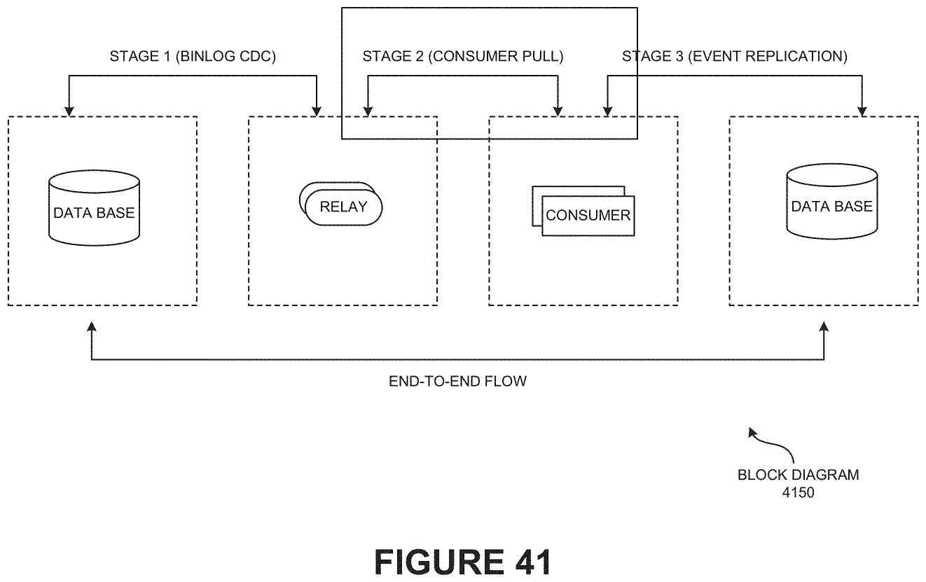

FIG. 41 is a block diagram 4150 illustrating the measuring of stage 2 performance, according to one embodiment.

Measuring Stage 2 Performance (Relay to Consumer):

In a further embodiment, to measure stage 2 performance, the change data is queued in the relay waiting for the consumer(s) to pull the events. Since ACDS is designed as a streaming data pipeline, the relay may be configured with a larger in-memory buffer to queue the change-data. For this test, a single 8-way 30 GB memory VM instance may be provisioned for the relay and then varied the configuration of the consumer(s).

First, the load generator may generate the 4.8M records that were preloaded into the relay event buffer. Once the records were fully queued, consumer(s) with timestamped logging in the consumer's logfiles were started up to track the length of time that elapsed from the first event to the last event. The following table shows the results.

VM Configurations and Results for Stage 2:

TABLE 2

| Instance Type | VM [symbol] | Consumer | Load | record size | CPU load | vCPU [symbol] | duration | rate ev/s | rate Mbit/s |
|---|---|---|---|---|---|---|---|---|---|
| n1-standard-2 | 1 | single consumer | 4,800,000 | 1100 | 0. [symbol] 5 | 1.80 | 110.08 | 43.805 | 4 [symbol] 0 |
| | | 2 cpu | | | | | | | |
| n1-standard-4 | 1 | single consumer | 4,800,000 | 1100 | 0.54 | 2.37 | 78.53 | [symbol] 0.815 | 5 [symbol] 9 |
| | | 4 cpu | | | | | | | |
| n1-standard-8 | 1 | 2 consumers | 4,800,000 | 1100 | 0.59 | 4.72 | 52.88 | 90.7 [symbol] 5 | [symbol] |
| | | 8 cpu | | | | | | | |
| n1-standard-8 | 1 | 3 consumers | 4,800,000 | 1100 | 0.79 | 0. [symbol] .32 | 35.72 | 1 [symbol] 4.378 | 1,478 |
| | | 8 cpu | | | | | | | |

[symbol]

indicates data missing or illegible when filed

In the first two tests, a single consumer was run across two different machine-types on Google Compute Engine with an increase in performance relative to the number of CPUs available. For the 3rd and 4th test, the configuration was increased to an 8-cpu machine and the load to scale was partitioned through multiple consumers. The following graphs depict the increase in throughput as we add additional capacity.

In these tests, all of the consumers were run on the same VM however if network I/O or disk I/O became the bottleneck on a single machine, the consumers could be easily distributed across different machines.

END-TO-END (MySQL BINLOG TO MOCK DB): The final step of these testing runs, is to measure the end-to-end replication performance (with a mocked out target DB) from the MySQL binlog through the consumer. We only performed this run for the largest configuration.

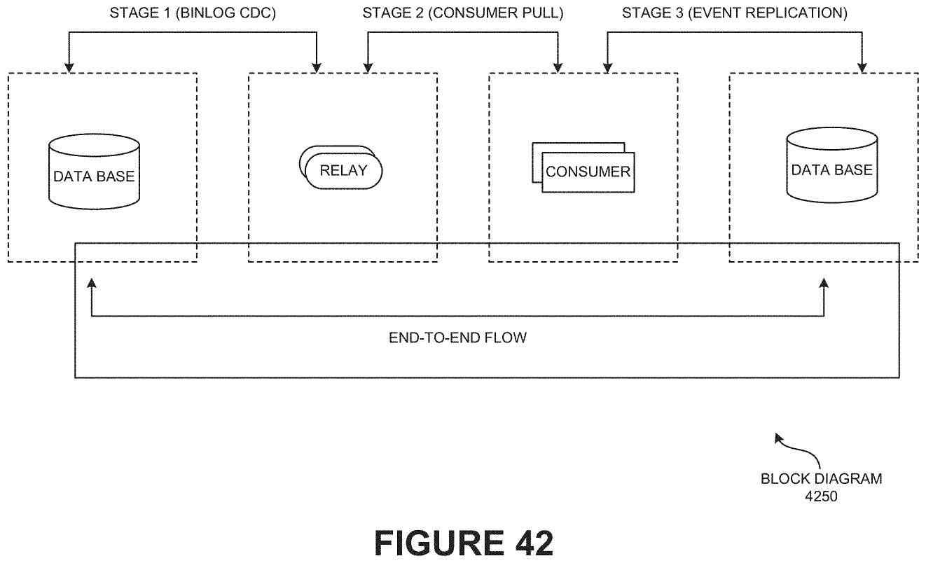

FIG. 42 is a block diagram 4250 illustrating the End-to-End MySQL binlog. Using the same load as the previous tests, we have created the following configuration to process the end-to-end load.

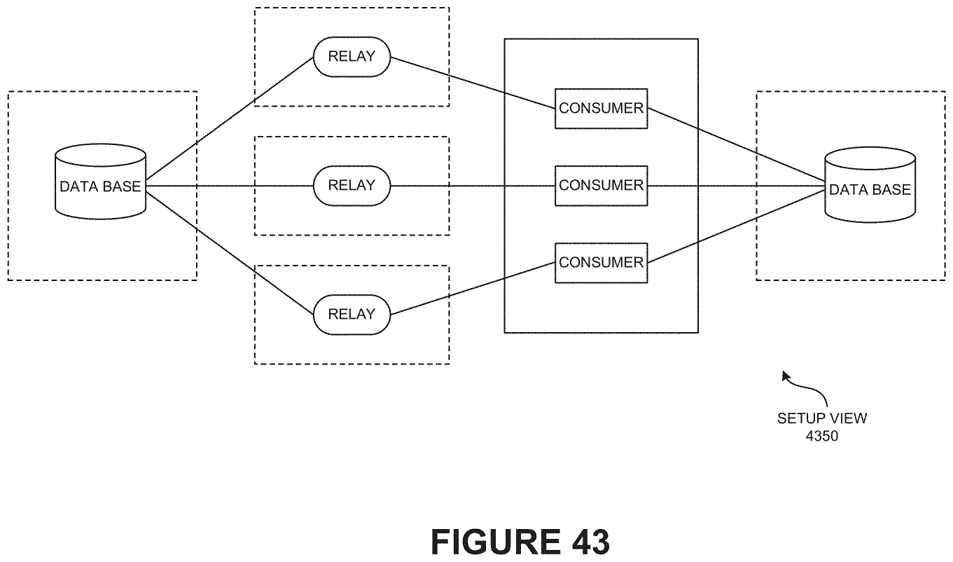

FIG. 43 is a setup view 4350 illustrating the End-to-end setup. And the results are presented in the table below:

TABLE 3
End-to-end results:

| Instance Type | VMs | Relay | Load | record size | duration | rate ev/s | rate MBit/s |
|---|---|---|---|---|---|---|---|
| n1-standard-8 | 4 | 3 relays, 3 consumers, 8 c [symbol] | 4,800,000 | 1100 | 33.66 | 142,602 | 1,569 |

[symbol]

indicates data missing or illegible when filed

From our stage 1 testing, we saw that the relays (3) were able to process incoming change data events at a rate of 164 k events per second. During our stage2 testing, we saw that the consumers (3) were able to process at 134 k events per second. When put together, they were able to stream from MySQL's binlog through the consumer to a mock DB at a rate of 142 k events per second. The slight uptick in performance is likely due to consuming from 3 relays for this final test, rather than a single relay in the stage 2 test, according to one embodiment.

ORACLE GOLDENGATE PERFORMANCE: As an additional data point, replication performance have been measured with an Oracle GoldenGate-based relay fetcher. Although GoldenGate is already a replication product from Oracle, a java-based Extract has been created that plugs into GoldenGate which can process change-data events using GoldenGate as the source, according to one embodiment.

The testing environment includes a pair of Google Compute Engine VM's (machine-type N1-standard-16). In this environment, the relay runs on the same VM as GoldenGate and Oracle. In this configuration, a single relay is run and a single consumer. As the previous section shows, if data can be partitioned across the pipeline, serious performance gains can be realized by scaling the system. The target system is a VM that is running HBase, using a phoenix jdbc driver to access HBase. In this case, the change data is not replicated to the same schema, but all change-data is written to a single table that contains the change-data in it, according to one embodiment.

The load generation setup is similar to the previous MySQL performance runs. We are writing to two tables on the source database with an approximate record size of 1100 bytes. The load consists of 2M records and the methodology used to capture throughput measurements on the individual stages in the pipeline, according to one embodiment.

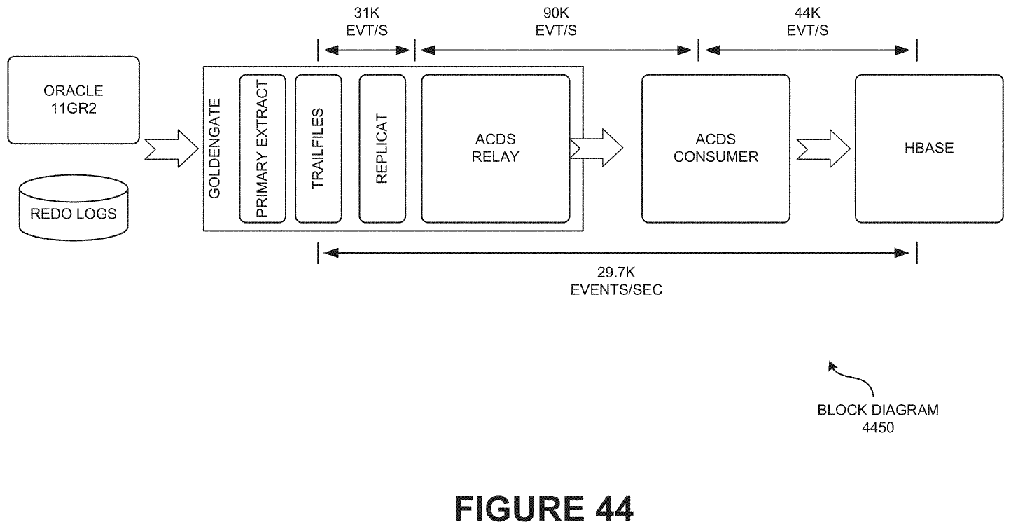

FIG. 44 is a block diagram 4450 illustrating Oracle GG to Hbase, according to one embodiment.

Other improvements may be implemented that will further raise the performance of ACDS. Current consumer may support transaction batching (aggregating multiple transactions into one write). Transaction batching may be critical for destinations where exactly-once is required, since it minimizes the number of round-trips to the target system (database) when the transactions are applied serially, according to one embodiment.

AUTOMATIC CONSUMER LOAD-BALANCING: At this time, partitioning of the replication event stream among a group of consumer instances requires manual specification of the policy for each consumer.

Automatic partitioning may be provided based on the Apache Helix1 cluster management framework. Given a set of policies which define the available partitions, they will be automatically distributed among the available consumer instances. Checkpoints are shared and if one consumer instance becomes unavailable, the partitions for which this instance was responsible will be distributed among all other available instances, according to one embodiment.

This approach is particularly useful if the partitioning can be done based on schema or based on tenant. As an example, the object materialization consumer will greatly benefit from this partitioning when applied on a per-tenant basis. Scalable consumer clusters can be built while minimizing the operational overhead, according to one embodiment.

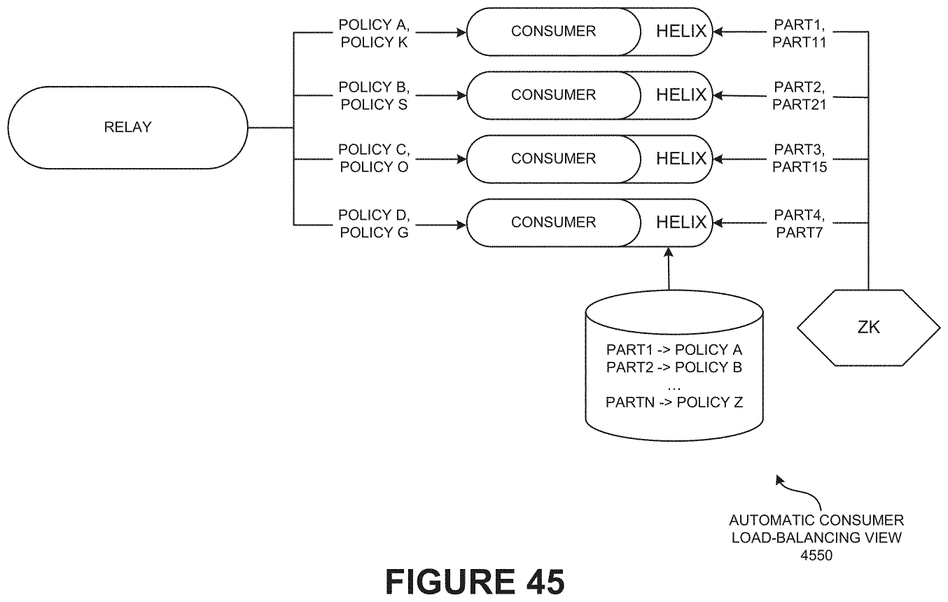

FIG. 45 is an automatic consumer load-balancing view 4550 illustrating the automatic consumer load-balancing, according to one embodiment.

CONSUMER MICRO-BATCHING: At this time, some consumer implementations (e.g., our Phoenix consumer) may have an ability to perform an internal parallelization of the processing of events. This can be particularly useful for alleviating latencies associated with writing to remote data stores or systems.

The core idea is to partition the incoming transaction batch (a group of one or more transactions) into micro-batches. The partitioning is performed by a pluggable Partitioner component. Partitioning can be done on different criteria, from an event round-robin through a transaction round-robin to partitioning based on a field (e.g. customer ID), according to one embodiment.

Each micro-batch is processed and stored to the backend database (or other system) in parallel. A Committer component keeps track of which micro-batches have committed and stores that in an internal checkpoint. Once all micro-batches have been applied, the ACDS checkpoint is advanced, according to one embodiment.

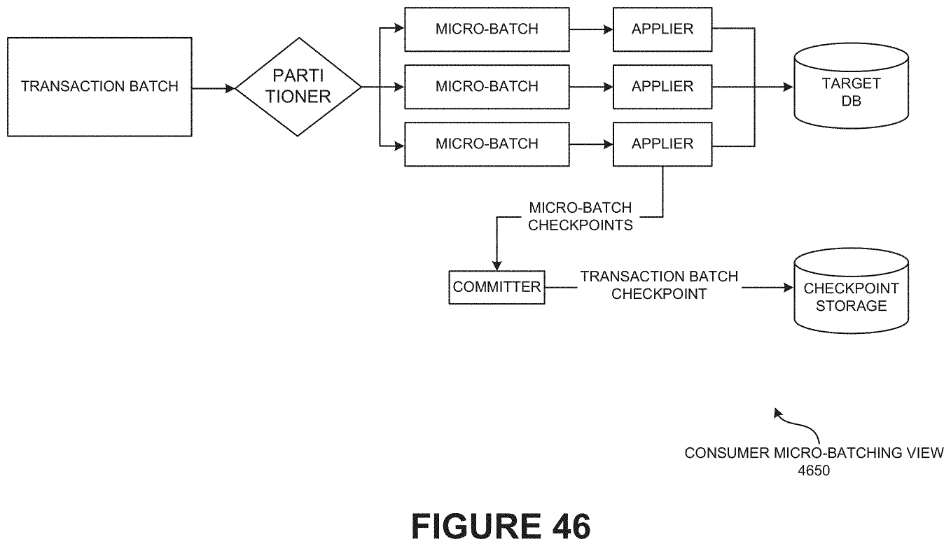

FIG. 46 is a consumer micro-batching view 4650 illustrating the consumer micro-batching, according to one embodiment.

The approach may be generalized as a common pattern available for all consumer implementations.

Combinations of multiple scaling techniques may also be possible. Micro-batching can be combined with transaction batching and can also be automatically load-balanced based on schema or tenant, according to one embodiment.

LONG-POLL CONSUMER PROTOCOL: Currently, the consumer polls the relay periodically for new events through HTTP request. Higher frequency of polling improves the replication latency to the consumer but increases the per-consumer load on the relay (HTTP request processing, increase garbage collection), according to one embodiment.

An important planned performance optimization is to establish a long-running request where the relay never terminates the response and new events in the relay's Event Buffer are sent immediately to all subscribed consumers with applicable replication policies.

This will allow consumers to run at optimal latency with minimal effect on relay CPU utilization, according to one embodiment.

ON-THE-WIRE COMPRESSION: In cases, where events contain large amounts of data (especially, text data), compression can significantly improve bandwidth utilization. We plan to add on-the-wire compression for the events sent from the relay to the consumer. We expect the effectiveness of the compression to increase with the long-poll consumer protocol feature, according to one embodiment.

The throughput of ACDS across various stages with multiple scaling configurations have been measured. It is observed that each individual component of the system can scale to tens of thousands of events and tens of megabytes per second. Further, it has been shown that with horizontal scaling, the aggregate throughput can be increased to hundreds of thousands of events and hundreds of megabytes per second. The system scales almost linearly, with the addition of new relay and consumer instances, which indicates that there is no inherent software bottleneck, according to one embodiment.

The asynchronous change data system (ACDS) of the current disclosure is suitable for providing solutions with low-latency, reliable data synchronization for a number of mission-critical use cases inside a modern enterprise. Further, additional embodiments of this disclosure may offer possible approaches for achieving high levels of availability that can fit the needs of a wide range of enterprises, according to one embodiment.

Support for running high-availability and reliable distributed applications is one of the key design aspects of the asynchronous change data system (ACDS) of current disclosure. Current disclosure presents a number of approaches to ensure the high availability of data synchronization solutions build using the disclosed ACDS technology. Current disclosure discusses how to ensure high availability within a single data center/availability zone and across data centers, availability zones and regions. Further, this disclosure looks at the availability problem end-to-end, i.e. does data actually flow through the ACDS bus, according to one embodiment.

PROBLEM STATEMENT: A typical ACDS deployment can be described as follows:

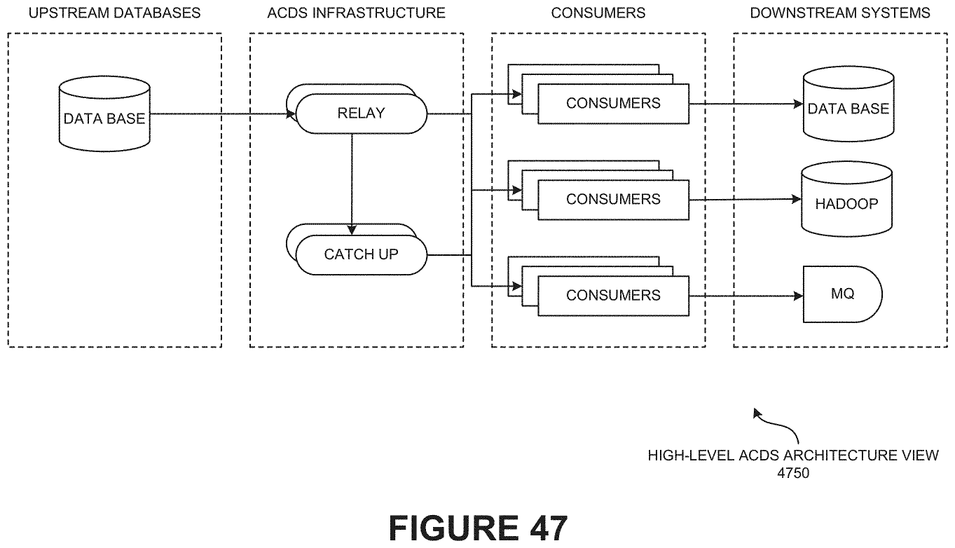

FIG. 47 is a high-level ACDS architecture view 4750 illustrating the high-level ACDS Architecture, according to one embodiment.

Four main types of systems and services may be identified:
Upstream source database system
ACDS infrastructure services
Consumer services
Downstream systems like other database systems, Hadoop and other file systems and message queues

All four types of components affect the availability of the system. This disclosure focuses on HA for the ACDS Infrastructure components and the consumer services. There is an already existing wide range of available resources for configuring and maintaining HA for database systems, Hadoop and message queue systems.

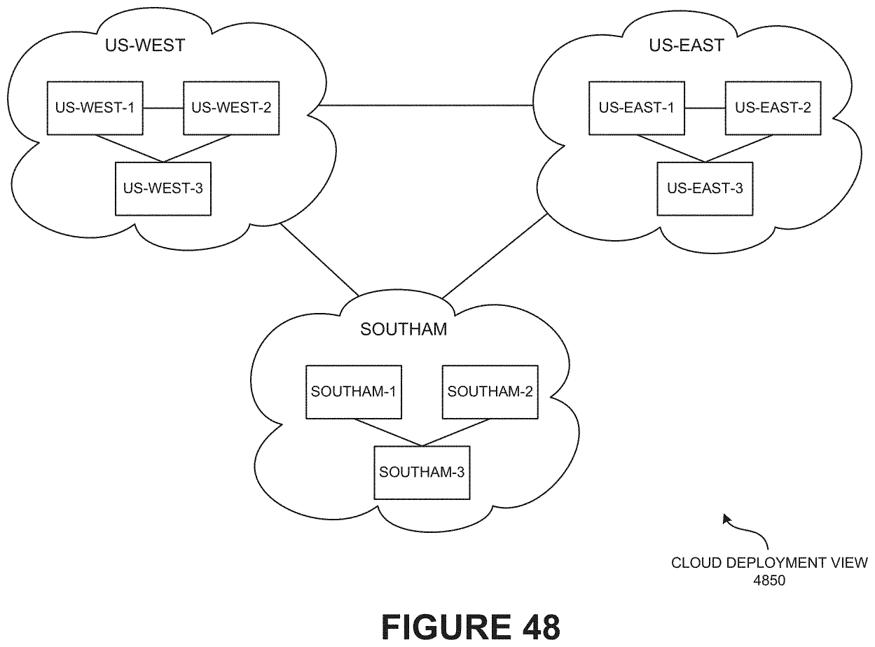

FIG. 48 is a cloud deployment view 4850 illustrating a typical cloud deployment model, according to one embodiment.

In FIG. 48, there are three regions (US-WEST. US-EAST. SOUTHAM) each with three availability zones. Each availability zone (AZ) provides isolated power and networking which provide a high-level of isolation from the other AZ in the same region. The AZ within the same region typically provide high level of network connectivity with low latencies due to the close geographical proximity. Regions are situated across the globe thus providing the highest level of isolation but the network connectivity is more limited due to the long geographical distances, according to one embodiment.

Popular public cloud vendors like Amazon Web Services, Google Cloud Engine and Microsoft Azure all provide a similar model to the above although naming, geographies and topology may differ, according to one embodiment.

ACDS DESIGN PRINCIPLES: TIMELINE CONSISTENCY: One of the most important design principles in present disclosure's ACDS provides is the timeline consistency for all components on the bus. This means that these components (including the geographically distributed in different AZs) follow the same commit timeline as defined by the source database. This includes all updates that happened in that database in exactly the same order. The logical clock associated with the commit timeline is also preserved, according to one embodiment.

The state (e.g., the checkpoint) of each component (e.g., relays, catch-up servers, consumers) is determined by the last consumed transaction in that the commit timeline. Further, ACDS middleware components relays and catch-up servers also have a low watermark of the earliest transaction that they can serve, according to one embodiment.

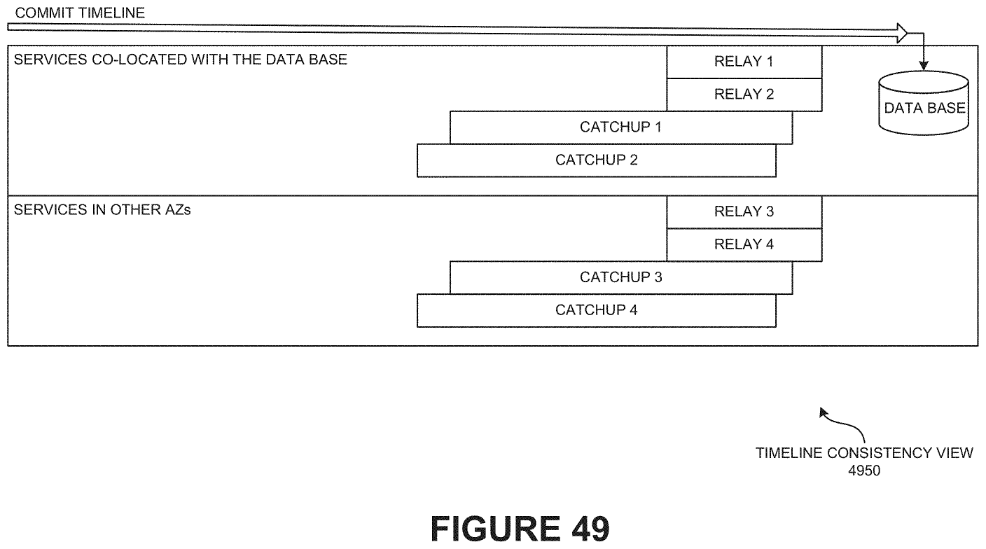

FIG. 49 is a timeline view 4950 illustrating the timeline consistency of ACDS, according to one embodiment.

From the above diagram, it can be observed that ACDS components form a cache hierarchy. A consumer can potentially be served by any component show range contains the consumer checkpoint. On the following diagram, the components that can serve the consumer have been highlighted.

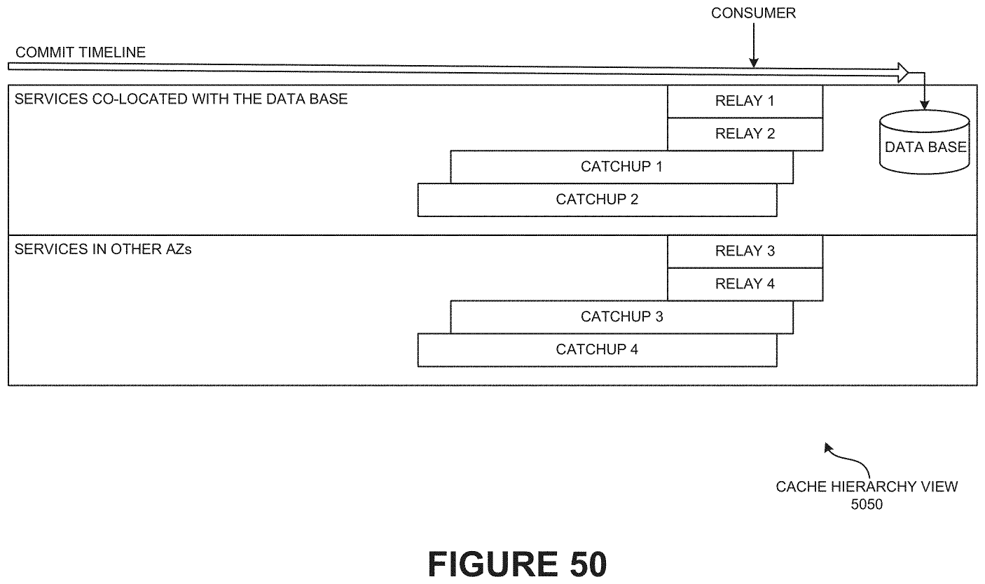

FIG. 50 is a cache hierarchy view 5050 illustrating the serving in ACDS as cache hierarchy, according to one embodiment.

Such flexibility and a wide range of alternatives that can be used to serve the consumer promote a very high level of availability, according to one embodiment.

The ACDS client library that manages the connections the relays and catch-up servers on behalf of the consumer services prioritizes connecting to relays over catchup servers as the former generally provide better latency due to the fast in-memory processing path, according to one embodiment.

PULL-BASED ARCHITECTURE: Another critical design principle is the pull-based architecture. Please refer to FIG. 1. All connections between all systems (e.g., DB, relays, catchup servers, consumers) are pull-based with connections initiated by the downstream components.

According to one embodiment, this architecture has the following implications.
The consumption state (e.g., the checkpoint) is localized and managed by the consumption side of each connection. There is no need for centralized repository for managing state which can become a single point of failure (SPOF) for the entire system.
Unavailability of the consumption side does not affect the availability of the producer side. The latter just continues processing. Thus, unlike push-based architectures, the producer side does not need to make a decision between (a) stopping processing until the consumer side becomes available potentially making the producer side unavailable too or (b) moving on and sacrificing consistency and correctness.
Unavailability of the producer side does not affect the availability of the consumer side. If the former becomes unavailable, the latter can failover to a different instance or cluster (e.g., due to the timeline consistency).

HIGH AVAILABILITY WITHIN A SINGLE AVAILABILITY ZONE: Within an availability zone, there is generally a high level of network connectivity, high bandwidth and low network latencies. This facilitates a large number of deployment topologies to ensure the high availability of ACDS-based data synchronization solutions, according to one embodiment.

First, we will look at deployment alternatives for the relay components.

RELAYS: The primary approach for maintaining high availability within an availability zone for the relays is through clustering and intra-cluster/inter-cluster replication. Consumers, catchup servers and other relays can be configured to consume from a cluster of relays. As discussed above, the timeline consistency property maintained by each relay ensures that all relay instances are fully interchangeable from the point of view of the downstream consuming service, according to one embodiment.

On start-up, the downstream service will choose an instance to connect to. Typically, this is done by choosing a random relay instance from the configured ones. If that instance is or becomes unavailable at any point, an automatic fail-over to a different instance will occur. More sophisticated load-balancing policies will be added with the Helix clustering feature (see below).

This allows the customers to build truly shared-nothing clusters with high availability and scalability, according to one embodiment.

Relay Clustering

There are three general types of relay clustering alternatives:
Customer-defined clustering with a load balancer
Clustering through an ACDS-managed cluster configuration
Clustering using Helix

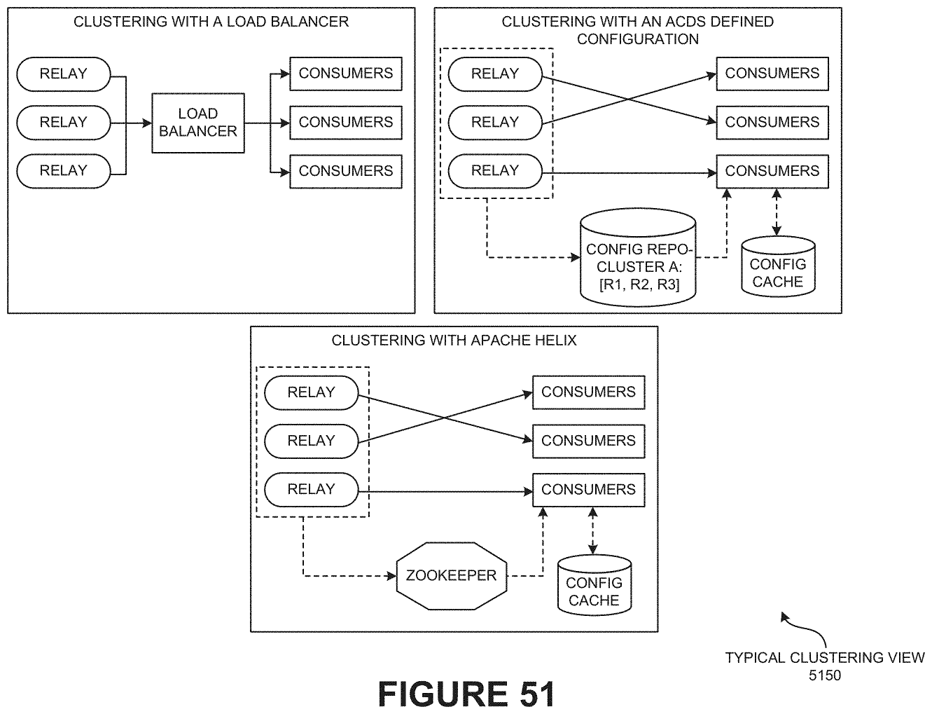

FIG. 51 is a typical clustering view 5150 illustrating the relay clustering types, according to one embodiment.

Note that consumers do not rely on the clustering approach to determine relay availability. Clustering bears importance only on relay instance discovery. Each consumer independently tracks which instances relay instances are actually available, according to one embodiment.

Let's look at each of these alternatives.

CUSTOMER-DEFINED CLUSTERING WITH A LOAD BALANCER: Consumers use standard HTTP to communicate with the relays. Thus, the relay instances can be placed behind a load balancer or a reverse HTTP proxy. The management of these instances is largely done outside ACDS. The load-balancer/proxy is assigned a single DNS hostname that is used by consumers to access the relay servers.

In another further embodiment, there are number of alternatives for load-balancers. These can generally be grouped into three categories:
Software load-balancers like HAProxy1 and NGINX Plus2
Hardware load-balancers like Citrix NetScaler3, F5 Big-IP4, and others
DNS round-robin

This approach works well if the customer already has existing infrastructure that utilizes load balancers and the customer wants to capitalize on the existing experience operating it.

The main downside of this approach is that the availability of the load-balancer becomes a central point of the availability of the entire system. This runs counter ACDS's approach of fully distributed, shared-nothing architecture. It is expected that customers choosing this approach have established ways to maintain such availability in the load balancer. Otherwise, the ACDS-managed cluster configuration approach presented next may be recommended, according to one embodiment.

When using this approach, configuring the consumers is as simple as setting the relay hostname.

acds consumer source—relays acds-relays.company.com
name myconsumer

CLUSTERING THROUGH AN ACDS-MANAGED CLUSTER CONFIGURATION: The definition and management of relay clusters through ACDS is the currently recommended approach for most deployment scenarios, according to one embodiment.

The idea is to use the tools and UI provided by ACDS to define and distributed the configuration about the available cluster (see the second diagram on FIG. 5). That information can be edited and stored a in configuration repository which can be a local file system, on shared storage as an NFS mount or through the asynchronous change data system API server, according to one embodiment.

First, this approach may not introduce a potential single point of failure (SPOF) on the critical data synchronization path. The cluster configuration information is sent asynchronously to all components which cache it. They will be able to continue to operate even in the case of temporary unavailability of the configuration repository. Outage can only occur if there is a simultaneous failure of the configuration source and all instances of the required ACDS replication bus, according to one embodiment.

Second, there is a tight integration of this approach with all disclosed tools and the UI which ensures a more consistent user experience.

This approach can still be integrated with external monitoring tools for availability through the aforementioned/admin HTTP call or through the metrics exposed by ACDS, according to one embodiment.

To define a cluster named “clusterA” consisting of two relay instances “relay1.company.com” and “relay2.company.com” one can use our acds command-line tool:

acds config cluster—action create—name clusterA
relays relay1.company.com.relay2.company.com

To configure the consumer instance “myconsumer” to read from the relay cluster “clusterA”, one can use:

acds consumer source—relays acds-cluster:clusterA
name myconsumer

Subsequent changes can be made to the relay instance in the cluster. For example, adding or removing relay instances can be done through:

acds config cluster—action add—name clusterA
relays relay3.company.com

acds config cluster—action remove—name clusterA
relays relay1.company.com

CLUSTERING USING HELIX: This extends the ACDS-managed cluster configuration alternative with integration with the Apache Helix5® cluster management framework. This approach provides the ability to manage the clusters much more actively. In particular, it allows:
Finer granularity tracking of the state of each instance.
Ability to easily setup typical cluster configurations like Leader/Standby and Master/Slave.
Better tracking of instances that have experienced and error and marking them as unavailable automatically.
Ability to quickly add and remove instances to clusters
Ability to take instances out of rotation without taking them down (e.g. for debugging or maintenance)
Ability to define sophisticated load-balancing algorithms.

CHAINING AND TIERING: Chaining is the use of one relay instance or a cluster as a data source for another relay instance or cluster.

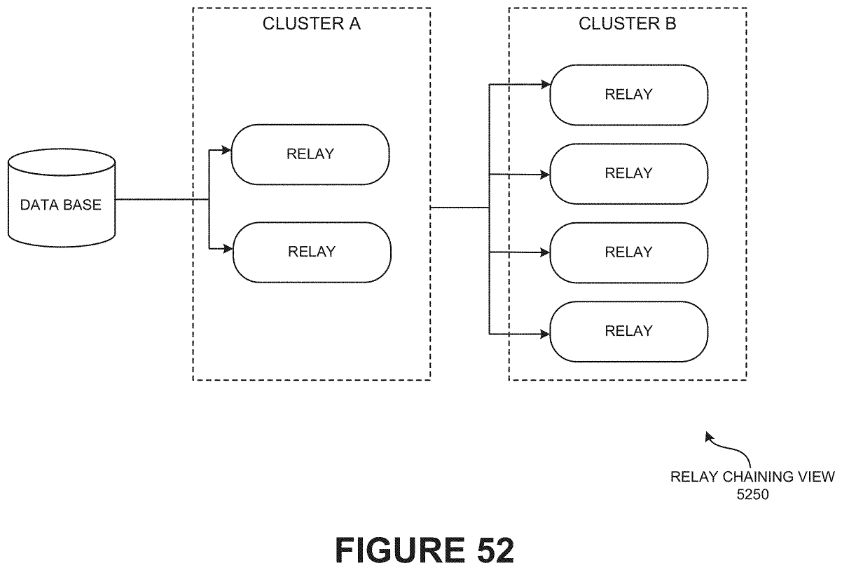

FIG. 52 is a relay chaining view 5250 illustrating the relay chaining, according to one embodiment.

Relay chaining may have application in both same-AZ deployment and cross-AZ deployments (discussed in the section “High availability across availability zones”).

Intra-AZ chaining allows to (a) grow relay clusters to a practically unlimited number of relay instances and consumers and (b) define different levels of service based on tiering of the relays, according to one embodiment.

For the first use-case, consider FIG. 52. We were able to have 6 relays available to downstream consumers while only having two relays directly connected to the database. This is important because relays generate some small overhead in the source database. That overhead may add up if this is a high-traffic DB and there are multiple relays connected to it. On the other hand, relays are optimized to serve a large number of streaming consumers. Thus, Cluster A can serve a much higher number of relays in Cluster B. Then, customers have choice to configure downstream consumers to connect to the relays in Cluster B or both clusters. This architecture allows serving of practically unlimited number of consumers, according to one embodiment.

The second use case is an extension of the first one. Consider FIG. 7. We have switched the names of the clusters to Tier1 and Tier2 to denote their purpose. Tier 1 is closer to the database and thus provides lower latencies. On the other hand, it has more limited capacity and disruptions to the service have harsher implications. Thus, we can reserve this cluster to a limited number of consumers which require higher Quality-of-Service (QoS) in terms of latency and predictability. In the current release, each relay in a chain can be configured separately, according to one embodiment.

Future release will allow the central API server to hold these configurations and push them automatically to the relays.

On the other hand. Hadoop consumers tend to be more numerous and do not have as strict latency requirements. Sometimes they come in big bursts due to (misconfigured) batch jobs. Therefore, they are isolated to a separate (chained) cluster with lower QoS, according to one embodiment.

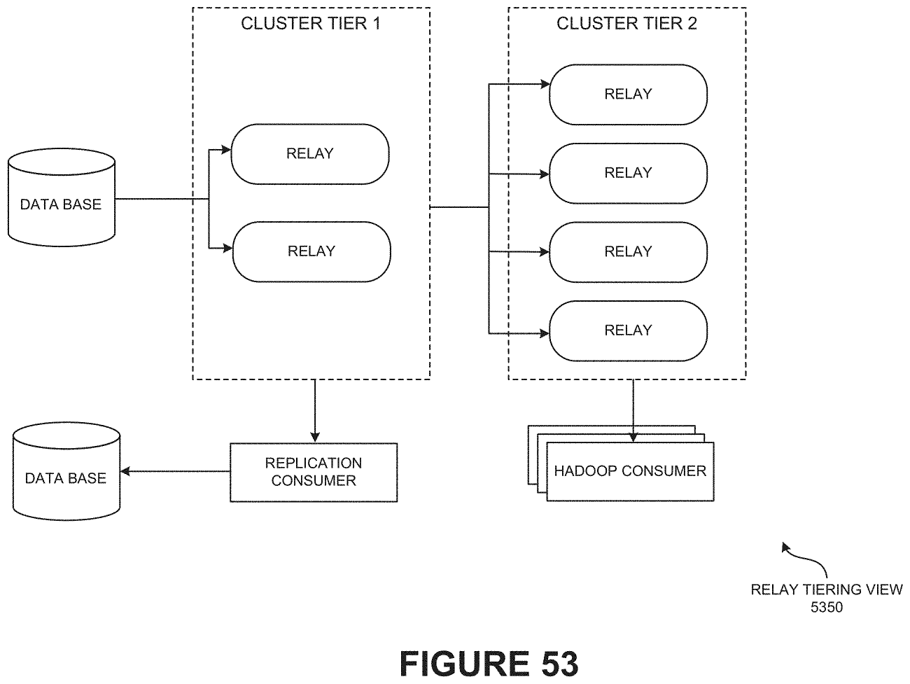

FIG. 53 is a relay tiering view 5350 illustrating relay tiering, according to one embodiment.

This approach can be extended to have a number of specialized clusters for different classes of consumers if necessary. This can be combined with policies. For example, the Tier2 can enforce a policy that all sensitive fields are removed so it does not get exposed to less secure analytics jobs, according to one embodiment.

CATCHUP SERVERS: The catchup service has two parts: the Catchup Consumer which is responsible for maintaining the persistent log and the Catchup Server which is responsible for serving consumer request from the persisted log.

THE CATCHUP SERVER: The Catchup Server is similar to the relays and its clustering types are very similar to relay clustering ones: with a load-balancer, ACDS cluster configuration, and Helix-based. The main difference is that chaining of catchup servers is currently not supported, according to one embodiment.

The commands for managing the catchup server clusters are also similar. To create a new catchup cluster, one can type:

acds config cluster—action create—name clusterX
catchup catchup 1.company.com,catchup2.company.com

One can also combine a group of relays and catchup servers into a single cluster:

acds config cluster—action create—name clusterX
catchup catchup1.company.com.catchup2.company.com
relays relay1.company.com.relay2.company.com

THE CATCHUP CONSUMER: The Catchup Consumer is the other part of the catchup service and it is managed similarly to any other consumers. This is described in the next section on consumers, according to one embodiment.

CONSUMERS: Consumer high availability is not managed by ACDS in our first release. Our next release will add support for automatic consumer failover through the Helix cluster management framework (see the “Clustering using Helix” section above).

The recommended approach for consumer process HA currently is to use a container restart policy through Docker or container management framework such as Kubernetes. On restart, the consumer will re-read the last persisted checkpoint and continue from that point on, according to one embodiment.

HIGH AVAILABILITY ACROSS AVAILABILITY ZONES: In this section, we will look at building HA ACDS deployment spanning multiple AZs in the same or different regions. The recommended approach is to use chained relay cluster as show on FIG. 8 Cross AZ Relay Chaining.

This approach limits the amount of cross-AZ network traffic, as it happens only between the pairs of relay clusters. Any additional catchup services and consumers are connected only to their local cluster.

Single node failures within the local relay cluster are handled in the same as the single AZ HA scenarios. Consumer services will automatically switch to other available relays.

If the entire local relay cluster fails (say cluster3 with R31 and R32), consumers can be configured to switch to a different AZ (e.g. cluster2). Even though this will most likely increase the cross-AZ network traffic, it is a temporary solution until the relay cluster is restored, according to one embodiment.

acds consumer source—relays acds-cluster:cluster2
name myconsumer

Currently, the re-configuration needs to be performed manually. In a future release, with the addition of Helix clustering support, this can happen automatically. Consumer services can be configured to access both clusters. There will be weights associated with those connections and the client library will always prefer a connect with lower weight unless none is available.

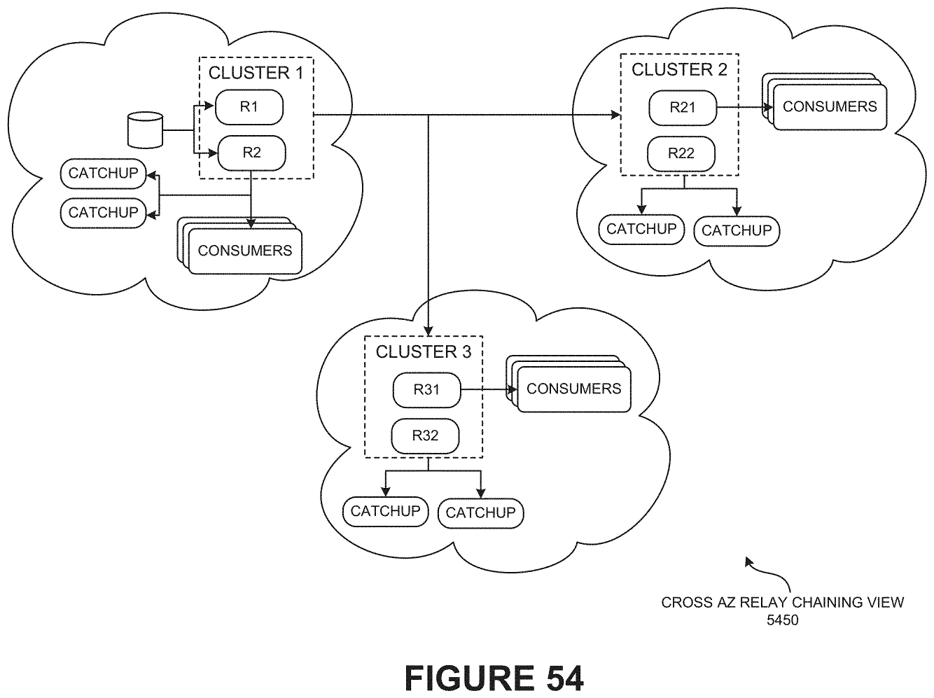

FIG. 54 is a cross AZ relay chaining view 5450 illustrating the Cross AZ Relay Chaining, according to one embodiment.

If the network connectivity between two AZ is interrupted, an AZ fail-over needs to be performed. Similarly, to the local relay cluster failure, the relay cluster needs to be reconfigured to connect to a relay cluster from a different AZ, according to one embodiment.

DATA AVAILABILITY: A lot of the previous discussion focused on availability at the system components level. That is a necessary condition for the end-to-end data synchronization flow to be considered available but it is not sufficient. Even when components appear available they may not be able to replicate data due to internal processing errors or upstream issues. Detection of such issues becomes increasingly important in highly distributed systems as local components may look healthy due to limited view of the global state of the system, according to one embodiment.

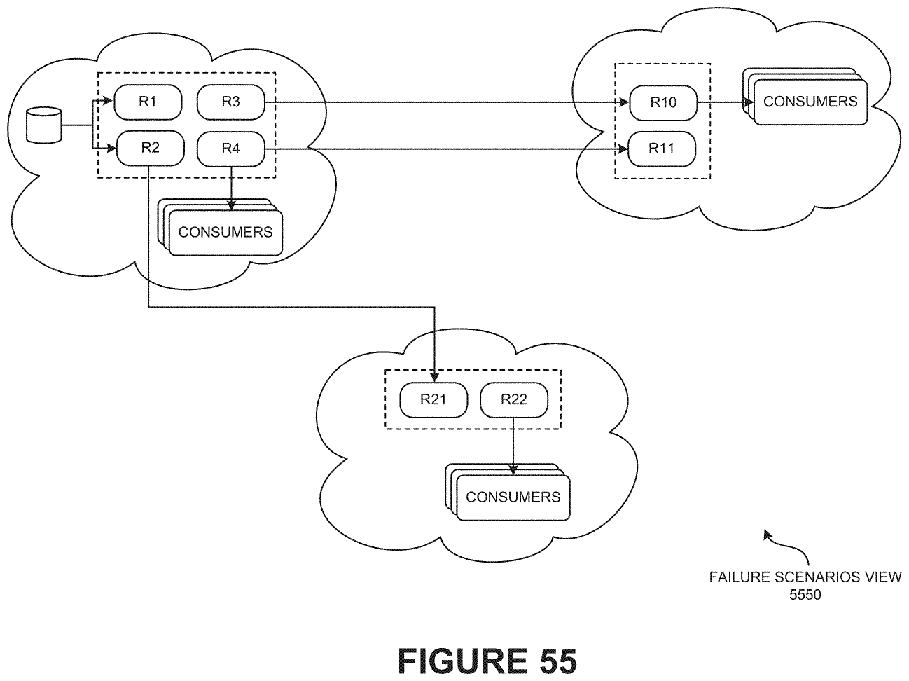

Consider the following scenarios on FIG. 55.

FIG. 55 is a failure scenarios view 5550 illustrating the sample Failure Scenarios, according to one embodiment.

R2 is experiencing a GC storm due to misconfiguration and is unresponsive or returns frequent Out-Of-Memory errors. R10 is experiencing a network connectivity issue to R3. In both cases, this may lead to data unavailability in downstream consumers to R22 and R10 since those may appear healthy but they are unable to serve change events.

ACDS provides several safeguards against above conditions, according to one embodiment.

First, the catchup servers (apart from serving lagging/misbehaving consumers) can also act to ensure data availability in case relay cluster experiences issues with drops in its event buffer caches retention, according to one embodiment.

Second, any error in communication between two components (e.g., consumer and relay or catch-up server) will trigger a fail-over to a different instance.

Third, if the consumer detects a period during which no changes have arrived from a relay, it will also trigger an automatic failover to a different instance, according to one embodiment

Finally, all components (e.g., relays, catchup servers, consumers) expose metrics about the last processed transaction and the overall replication lag. This can be used in connection with external monitoring systems to trigger alerts and operator intervention to maintain the required level of availability. The metrics collected from each of relays and consumers can be fed to any logging/monitoring system (like ELK) and anomalies can be detected, according to one embodiment.

HA support in ACDS transactional replication bus. Current disclosure's ACDS pull-based timeline consistent architecture allows for building of highly-available mission-critical enterprise applications for real-time data synchronization and integration, according to one embodiment.

Summary of HA Features:

| HA | Current Automatic | | |
|---|---|---|---|
| dimension | Support | Current Manual Support | Future |
| Relay | ACDS-base | Manual LB clustering | Helix-base |
| (Intra AZ) | clustering | Cluster state monitoring | clustering |
| | Relay chaining | | |
| | Relay tiering | | |
| Catchup | ACDS-based | Manual LB clustering | Helix-based |
| (Intra AZ) | clustering | Cluster state monitoring | clustering |
| Consumer | Container restarts | Cluster state monitoring | Helix-based |
| (Intra AZ) | | | clustering |
| Cross AZ | | Manual cross-AZ failover | Cost-based load |
| | | | balancing |
| | | | Automatic cross |
| | | | AZ failover |
| Data | Catchup service | Watermark monitoring | Metrics-based |
| | Failover on no | | fallover |
| | incoming data | | |
| | Failover on error | | |

Snapshot materialization and application consistency: In Computer Science the sequential access to a disk may be much faster than random access. Even with SSD, sequential access may give 200-300 MBps and random access may give 1,000-10,000 seeks per second. In the initial state of the system, the append-only databases may parallelly read a source database from multiple worker threads and load into the target append-only system.

The table entries may have various transaction timelines and there is no guarantee that the state of tables is consistent with a single timeline. The system may periodically merge an old snapshot of the system with the additions made, since in-place updates are not possible. When this periodic merge is automated (as in HBase and Lucene), and if the changes applied to the system come from a transactional system, the state of a snapshot may be transactionally inconsistent. Further, when the changes are applied, to create a new snapshot, the changes may include multiple changes to the same element which has to be sorted and the final value alone has to be applied.

To make state of table and state of database consistent to a single timeline a snapshot materialization technique may be used. The snapshot materialization may include running a change capture system to capture all changes while the initial load is progressing. All change transactions may be applied to a particular transaction id when the initial load is completed. In snapshot materialization process, the reappearance of a record may be removed using keys that handle de-duplication of entries. A key may be a primary key and/or a composite key. The snapshot materialization may be applicable to any target database. The target database may be RDBMS (in-place update) and/or HDFS (append-only) databases. The snapshot of the system may be deemed consistent if the state of the whole system is the same as the source database at a certain transaction id.

HIVE+SNAPSHOT MATERIALIZATION: The sequence number (SCN) may be used as a moniker for transaction-id (e.g., system change number in Oracle). The transaction-id may be replaced by GTID (for MySQL). LSN (for SQL Server), and/or XID (PostgreSQL). For each source table A, A_INC table and Table A with current snapshot data may be maintained.

FIG. 56 is a snapshot materialization view 5650 illustrating the hive+snapshot materialization, according to one embodiment.

An asynchronous program (Hive SQL script. Spark. Regular M/R) joins the most recent partitions of the incremental table with the snapshot table to produce a new snapshot:
A_INC (Partitions SCN1, SCN2, . . . , SCN_N)*Snapshot A with snapshot SCN═SCN0>SCN1 =Snapshot A′ with snapshot SCN=SCN_N

The above join may be essentially grouping by key, ordering by SCN and picking up the version with the largest SCN. Both incremental and snapshot tables may need to be co-bucketed for efficient join.

Advantages

Easily accessible incremental data for RT analytics

Can use any format supported by Hive (e.g., ORC. Avro. Parquet, etc)

Consumer does only straightforward inserts

More traditional use of Hive

Historic snapshots—Time Machine (!)

### Disadvantages/Challenges/Risks

Need to implement the snapshot materialization program

Handling of partial updates will be tricky with plain Hive SQL—the source needs to be configured for full row capture or Spark materialization needs to be implemented

Snapshots are refreshed only periodically

HIGH LEVEL SOLUTION OUTLINE: The snapshot table, the streaming partition, and the delta partition may be required inside the Hive/HDFS to achieve high-level solution outline architecture. The snapshot table may be a destination table to contain all data from the source table at a point in time T. The snapshot table may contain the image of the row at that point in time, for every single source row. The structure of the snapshot table may same as the source table. The Spark approach may enable to align all snapshot tables to represent a snapshot of the source database.

The streaming partition may contain every single change between two points in time T1 and T2. The streaming partition may contain columns with metadata such as the SCN, index within the transaction, operation (INSERT, DELETE, UPDATE), timestamp, etc. apart from the standard source columns. Each mutation of a source row may be stored as a separate row in the partition.

The delta partition may be similar to a streaming partition. The delta partition may contain the latest version of any row mutation between two points in time T1 and T2. A snapshot table at time T may be viewed conceptually as a delta [0, T] with all the metadata and DELETEd rows stripped.

The BQ Merge may not need to create a new snapshot of the table. The BQ Merge may enable to do more frequent MERGEs. The merge may be done on a table-by-table basis so there is no consistency across tables.

FIG. 57 is an application consistency view 5750 illustrating the application consistency guaranteed by a source clock, according to one embodiment.

APPLICATION CONSISTENCY: When sources are databases, consistency of the events may be guaranteed by a source clock. The source clock may be a transaction-id and/or a timestamp. The timestamp may be a coordinating vector to create consistent cross-database snapshots to coordinate and create consistent snapshot across systems. To achieve a cross-database consistency, a two phase commit-based distributed transaction management mechanism may be used. Two phase commit may require all of the participating services to be available to complete the transaction.

An application system presenting an API may be a source, instead of a database. The notion of a source clock may be absent in the application system. The application state may only be queried using REST APIs. The REST APIs may not be able to present a source clock (e.g., transaction-id and/or timestamp). The state of an application may represent multiple entities, getting a consistent view of all changes made to all entities for a customer.

The state of an application representing multiple entities may need the same transaction-id to be preserved for all queries. In the application state, there may not be a notion of cursor stability when updated, introducing an old-value and do the update (if it matched) may ensure that a value did not get modified before an update is made.

It may be important to have the source clock for the data integration projects to send the application data to a data lake. Further, it may be also important to have a notion of cursor stability for multi-master databases, where both databases can be updated.

In the application consistency, an application state may be kept consistent across the whole data pipeline. An application state may be kept consistent from the API system to the Hive/HDFS system and beyond. If there is a materialized view presented from the Hive/HDFS system, that may also be kept consistent.

The application consistent fetch may be a mechanism to fetch a transactionally consistent state from an application into the relay. The application consistent fetch may include the application to present CDC (e.g., change data) with a timestamp and/or transaction-id (e.g., Salesforce CDC). The application consistent fetch may include the application to load directly to a transactional database. Further, the application consistent fetch may use a poller to allow an application source endpoint to be frequently queried based on a time interval. The poller may also be provided a watermark feature to allow poll for new resources instead of the same resource. The watermark may assume that there is an ordered id (e.g., sequence numbers, timestamps). The watermark may store the current/last record-id.

Once the application consistent fetch is completed, it may be sent to the snapshot materialization system. The view materialization (e.g., the Hive View materialization, the Oracle materialized views, and SQLServer indexed views) and the object materialization may be used to de-normalize the data from the snapshot materialization system.

The object materialization may be merged into the last phase of snapshot materialization and/or done after snapshot materialization.

FIG. 58 is a flow diagram 5850 illustrating a flow diagram illustrating snapshot materialization and application consistency, according to one embodiment.

A number of embodiments have been described. Nevertheless, it may be understood that various modifications may be made without departing from the spirit and scope of the claimed disclosure. In addition, the logic flows depicted in the figures do not require the particular order shown, and/or sequential order, to achieve desirable results. In addition, other steps, data points and factors may be provided, and/or steps, data points and factors may be eliminated, from the described flows, and other components may be added to, and/or removed from, the described systems. Accordingly, other embodiments may within the scope of the following disclosure and/or claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. (canceled)

2. (canceled)

3. A system for object materialization and replication policies, the system comprising:
one or more processors; and
a non-transitory computer readable medium storing a plurality of instructions, which when executed, cause the one or more processors to:
identify a plurality of data objects in a plurality of tables in a source database by applying a data object replication policy to a superset of the plurality of data objects in the plurality of tables in the source database,
output the plurality of data objects to a plurality of tables in a target database in response to an input of the plurality of data objects from the plurality of tables in the source database;
construct, by a materializer, an application object based on applying an application object materialization policy associated with the plurality of tables in the source database to the plurality of data objects in the plurality of tables in the target database; and
output the application object, in response to receiving an application object request from an application associated with the target database.

4. The system of claim 3, wherein applying the data object replication policy comprises at least one of transforming a format of, filtering, masking, and modifying the superset of the plurality of data objects in the plurality of tables in the source data for use by the target database.

5. The system of claim 3, wherein a scope of the data object replication policy comprises at least one of an instance, a database schema, a table, a column, and a row associated with the superset of the plurality of data objects in the plurality of tables in the source data

6. The system of claim 3, wherein inputting the plurality of data objects from the plurality of tables in the source database comprises a plurality of threads inputting the plurality of data objects in parallel, and outputting the plurality of data objects to the plurality of tables in the target database comprises the plurality of threads outputting the plurality of data objects in parallel.

7. The system of claim 3, wherein the application object materialization policy comprises relationships between the plurality of tables in the source database, the relationships being based on at least one of a deconstruction of an application object that is associated with an application associated with the source database into data objects normalized in the plurality of tables in the source database, and a link between a first data object in a first table, of the plurality of data objects in the plurality of tables in the source database, and a second data object in a second table, of the plurality of data objects in the plurality of tables in the source database.

8. The system of claim 3, wherein creating the application object is further based on at least one of dimension data that enriches the application object and an aggregation of data from children objects of the application object.

9. The system of claim 3, wherein at least one of the data object replication policy and the application object materialization policy is at least one of created, audited, and evaluated by a policy engine.

10. A computer program product comprising computer-readable program code to be executed by one or more processors when retrieved from a non-transitory computer-readable medium, the program code including instructions to:
identify a plurality of data objects in a plurality of tables in a source database by applying a data object replication policy to a superset of the plurality of data objects in the plurality of tables in the source database,
output the plurality of data objects to a plurality of tables in a target database in response to an input of the plurality of data objects from the plurality of tables in the source database;
construct, by a materializer, an application object based on applying an application object materialization policy associated with the plurality of tables in the source database to the plurality of data objects in the plurality of tables in the target database; and
output the application object, in response to receiving an application object request from an application associated with the target database.

11. The computer program product of claim 10, wherein applying the data object replication policy comprises at least one of transforming a format of, filtering, masking, and modifying the superset of the plurality of data objects in the plurality of tables in the source data for use by the target database.

12. The computer program product of claim 10, wherein a scope of the data object replication policy comprises at least one of an instance, a database schema, a table, a column, and a row associated with the superset of the plurality of data objects in the plurality of tables in the source data

13. The computer program product of claim 10, wherein inputting the plurality of data objects from the plurality of tables in the source database comprises a plurality of threads inputting the plurality of data objects in parallel, and outputting the plurality of data objects to the plurality of tables in the target database comprises the plurality of threads outputting the plurality of data objects in parallel.

14. The computer program product of claim 10, wherein the application object materialization policy comprises relationships between the plurality of tables in the source database, the relationships being based on at least one of a deconstruction of an application object that is associated with an application associated with the source database into data objects normalized in the plurality of tables in the source database, and a link between a first data object in a first table, of the plurality of data objects in the plurality of tables in the source database, and a second data object in a second table, of the plurality of data objects in the plurality of tables in the source database.

15. The computer program product of claim 10, wherein creating the application object is further based on at least one of dimension data that enriches the application object and an aggregation of data from children objects of the application object.

16. The computer program product of claim 10, wherein at least one of the data object replication policy and the application object materialization policy is at least one of created, audited, and evaluated by a policy engine.

17. A computer-implemented method for object materialization and replication policies, the method comprising:
identifying a plurality of data objects in a plurality of tables in a source database by applying a data object replication policy to a superset of the plurality of data objects in the plurality of tables in the source database,
outputting the plurality of data objects to a plurality of tables in a target database in response to an input of the plurality of data objects from the plurality of tables in the source database;
constructing, by a materializer, an application object based on applying an application object materialization policy associated with the plurality of tables in the source database to the plurality of data objects in the plurality of tables in the target database; and
outputting the application object, in response to receiving an application object request from an application associated with the target database.

18. The computer-implemented method of claim 17, wherein applying the data object replication policy comprises at least one of transforming a format of, filtering, masking, and modifying the superset of the plurality of data objects in the plurality of tables in the source data for use by the target database, and a scope of the data object replication policy comprises at least one of an instance, a database schema, a table, a column, and a row associated with the superset of the plurality of data objects in the plurality of table in the source data.

19. The computer-implemented method of claim 17, wherein inputting the plurality of data objects from the plurality of tables in the source database comprises a plurality of threads inputting the plurality of data objects in parallel, and outputting the plurality of data objects to the plurality of tables in the target database comprises the plurality of threads outputting the plurality of data objects in parallel.

20. The computer-implemented method of claim 17, wherein the application object materialization policy comprises relationships between the plurality of tables in the source database, the relationships being based on at least one of a deconstruction of an application object that is associated with an application associated with the source database into data objects normalized in the plurality of tables in the source database, and a link between a first data object in a first table, of the plurality of data objects in the plurality of tables in the source database, and a second data object in a second table, of the plurality of data objects in the plurality of tables in the source database.

21. The computer-implemented method of claim 17, wherein creating the application object is further based on at least one of dimension data that enriches the application object and an aggregation of data from children objects of the application object.

22. The computer-implemented method of claim 17, wherein at least one of the data object replication policy and the application object materialization policy is at least one of created, audited, and evaluated by a policy engine.
